(19) United States
(12) Patent Application Publication
(10) Pub. No.: US 2025/0128188 A1
(43) Pub. Date: Apr. 24, 2025

(54) BORONIC ACID CONTAINING AFFINITY MEMBRANES

(71) Applicant: Donaldson Company, Inc., Bloomington, MN (US)

(72) Inventor: Graham Temples, Greenville, SC (US)

(21) Appl. No.: 18/925,828

(22) Filed: Oct. 24, 2024

Related U.S. Application Data
(60) Provisional application No. 63/545,513, filed on Oct. 24, 2023.

(51) Int. Cl. B01D 15/38; B01D 15/42; B01J 20/28; B01J 20/289; B01J 20/32

(52) U.S. Cl. CPC B01D 15/3828; B01D 15/424; B01J 20/28033; B01J 20/289; B01J 20/3208; B01J 20/3219; B01J 20/3248

(57) ABSTRACT

Separation media that includes a support substrate and a plurality of separation ligands immobilized on the support substrate. The plurality of separation ligands include an affinity capable of binding to a diol of a target molecule. The affinity group includes a boronic acid or a benzoxaborole. Methods of making the separation media and methods of using the separation media.

### CROSS-REFERENCE TO RELATED APPLICATION

This application claims the benefit of U.S. Provisional Patent Application No. 63/545,513, filed Oct. 24, 2023, which is incorporated herein by reference in its entirety.

### FIELD

The present disclosure relates to separation media and separation devices containing the same. The separation media of the present disclosure may be useful for isolation and/or concentration of molecules that include a diol. The separation media of the present disclosure may be used for separations in membrane chromatography. The present disclosure further relates to methods of making and using the separation media.

### BACKGROUND

Prior to downstream use, most molecules are isolated, purified, and/or concentrated. For example, intermediates and/or the final product of a small molecule pharmaceuticals are often isolated from the byproducts of the synthetic reactions used to make them. Additionally, antibody based therapeutics are often isolated from impurities of the expression system they were produced in or the sample they were extracted from. Traditional purification methods are often slow and costly. For example, some traditional purification methods use columns packed with expensive specialized resin. Additionally, some traditional purification methods require slow flow rates. Due at least in part to the specialized resin and/or slow flow rate, some traditional purification methods are difficult to scale.

### SUMMARY

In one aspect, the present disclosure describes a separation media that includes a support substrate and a plurality of separation ligands immobilized on the support substrate The plurality of separation ligands are of formula (SL)

-L-Z (SL)
where L is a linker and Z is a separation group. The separation group includes an affinity group capable of binding a diol group. In some embodiments, the formula SL is of formula SL1 or SL2

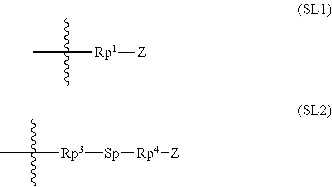

In formula SL1 and SL2 Rp¹, Rp³, and Rp⁴ each independently comprise the reaction product of any one of Rp^{A}, Rp^{B}, Rp^{C}, Rp^{D}, Rp^{E}, Rp^{F}, Rp^{G}, Rp^{H}, Rp^{I}, Rp^{J}, Rp^{K}, Rp^{L}, Rp^{M}, or an isomer thereof

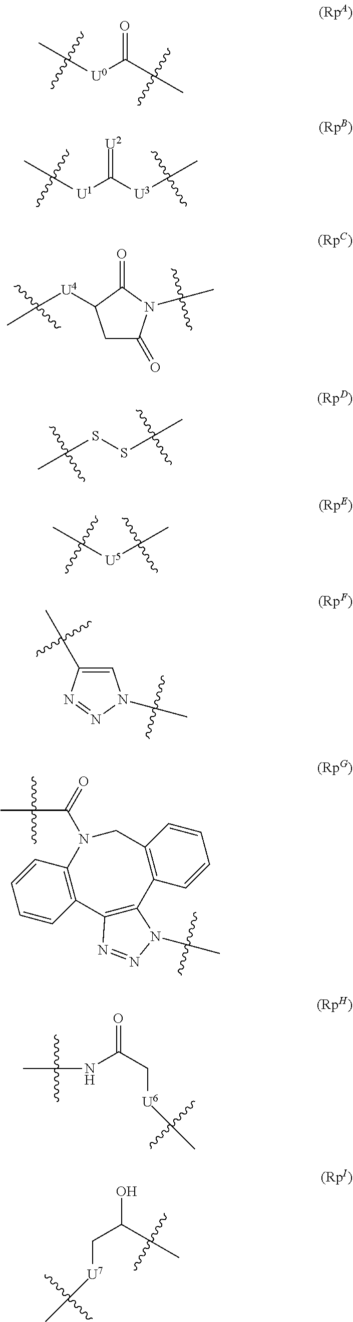

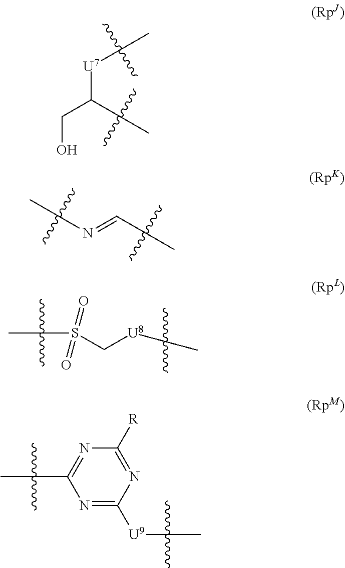

where U⁰, U¹, U², U³, U⁴, U⁵, U⁶, U⁷, U⁸, and U⁹ are each independently NH, N, O, or S and Sp is a spacer.

In some embodiments, the affinity group is capable of forming a reversible covalent bond with the diol group. In some embodiments, the diol is a 1,2-diol; a 1,3-diol; a cis 1,2-diol; or a cis 1,3-diol. In some embodiments, an oligosaccharide, a protein, a nucleoside, a nucleotide, or an oligonucleotide includes the diol.

In some embodiments, the affinity group comprises a boronic acid, a benzoxaborole, or both. In some such embodiments, the affinity group includes B(i) or B(ii)

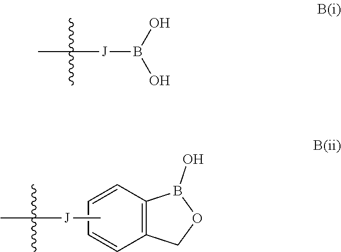

where J is an intermediate group including an alkyl, an aromatic group, or both. In some embodiments, J is J(i), J(ii), J(iii), J(iv), (v), or J(vi)

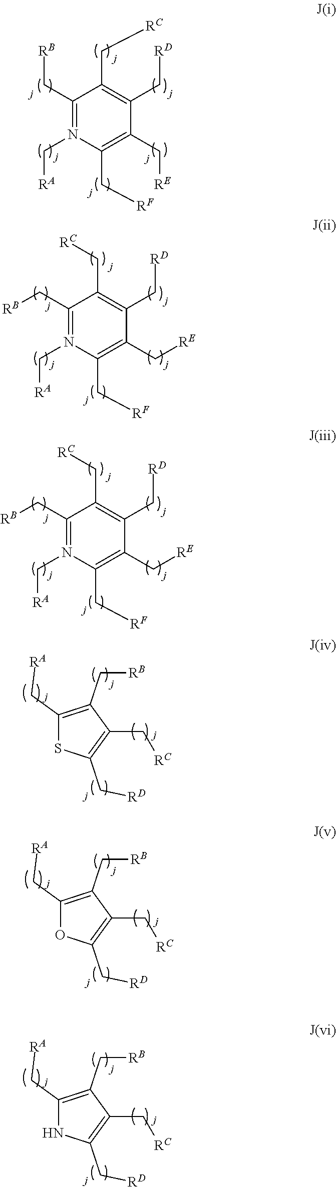

where each n is independently 0, 1, 3, 4, or 5; at least one R^{A}, R^{B}, R^{C}, R^{D}, R^{E}, and R^{F} is a connection point shown in B(i) or B(ii); at least one of R^{A}, R^{B}, R^{C}, R^{D}, R^{E}, and R^{F} is the boronic acid; and the remaining R^{A}, R^{B}, R^{C}, R^{D}, R^{E}, and R^{F} are each independently H, a halogen, an amine, a thiol, an aldehyde, a vinyl group, an ester, an ether, an alcohol, a urea, a guanidine, a carbonate, a carbamate, or a sulfone.

The present disclosure also describes methods of making the separation membranes of the present disclosure and methods of using the separation media of the present disclosure.

### BRIEF DESCRIPTION OF THE DRAWINGS

The following detailed description of illustrative embodiments of the present disclosure may be best understood when read in conjunction with the following drawings.

FIG. 1 is a theoretical representation of the formation of borate esters (charged and neutral) from boronic acids.

FIG. 2A is a flow diagram of a first method for making the separation media of the present disclosure.

FIG. 2B is a flow diagram of a second method for making the separation media of the present disclosure.

FIG. 3A is a flow diagram of a third method for making the separation media of the present disclosure.

FIG. 3B is a flow diagram of a fourth method for making the separation media of the present disclosure.

FIG. 4A is a flow diagram of a fifth method for making the separation media of the present disclosure.

FIG. 4B is a flow diagram of a sixth method for making the separation media of the present disclosure.

FIG. 5A is a schematic of a separation media consistent with embodiments of the present disclosure.

FIG. 5B is a schematic representation of a separation device consistent with embodiments of the present disclosure.

FIG. 6 is a flow diagram of a method of using the separation media and/or separation devices of the present disclosure.

FIG. 7 is a first schematic synthetic strategy for the making of separation media consistent with the present disclosure. This strategy includes the deposition of a polymer onto the support substrate through the grafting on technique. This strategy also includes indirect immobilization of the separation ligands onto the support substrate and an amine assisted coupling method.

FIG. 8 is a second schematic synthetic strategy for the making of separation media consistent with the present disclosure. This strategy includes the deposition of a polymer onto the support substrate through the grafting from technique. This strategy also includes indirect immobilization of the separation ligands onto the support substrate and an amine assisted coupling method.

FIG. 9 is a third schematic synthetic strategy for the making of separation media consistent with the present disclosure. This strategy includes direct immobilization of the separation ligands onto the support substrate and an amine assisted conjugation method.

FIG. 10 is a fourth schematic synthetic strategy for the making of separation media consistent with the present disclosure. This strategy includes direct immobilization of the separation ligands onto the support substrate and an organic solvent assistance conjugation method.

### DEFINITIONS

All scientific and technical terms used herein have meanings commonly used in the art unless otherwise specified. The definitions provided are to facilitate understanding of certain terms used frequently in the present disclosure and are not meant to limit the scope of the present disclosure.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

The terms, “have,” “having,” “include,” “including,” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

As used herein, the symbol “ [symbol] ” (hereinafter can be referred to as “a point of attachment bond”) denotes a bond that is a point of attachment between two chemical entities, or a chemical entity and a support substrate, one of which is depicted as being attached to the point of attachment bond and the other of which is not depicted as being attached to the point of attachment bond. For example, “

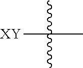

” indicates that the chemical entity “XY” is bonded to another chemical entity or a support substrate via the point of attachment bond. A point of attachment bond may also be described as a “—X” where X is any group that is being described.

The term “organic group” refers to a group that has carbon-hydrogen bonds. The group may also include heteroatoms such as O, S, N, or P. One or more heteroatoms may be catenated at any location in the organic group (e.g., ether, thioether, or amine). A heteroatom may be covalently bonded to a carbon atom through a double bond (e.g., ketone, imine). A heteroatom covalently bonded to a carbon atom may also be covalently bonded to another heteroatom (e.g., phosphodiester, sulfone). One or more functional groups may be included in an organic group, for example, alkane (branched, linear, or cyclic), alkene (branched or linear), alkyne (branched or linear), aromatic, amine (primary, secondary, tertiary, or quaternary), amino, amide, alcohol (primary, secondary, or tertiary), alkoxy, aldehyde, carboxylic acid, ether, ester, imine, phosphoester, phosphodiester, sulfone, sulfonamide, urea, thiourea, thioether, or any combination thereof, and ionized versions thereof. Generally, the organic group may be covalently bonded to a compound. The point of attachment of the organic group to the compound may be described in several ways. For example, in some embodiments, the organic group may be described as the monovalent or radical of the respective functional group (e.g., alkyl for alkane, aryl for aromatic ring, aminyl for a primary or secondary amine). In some embodiments, where a general formula is shown with a covalent bond connecting the organic group to a compound, the organic group may be described as the common functional group. For example, if the organic group R is described relative to the formula CH₃CH₂CH₂—R, the organic group may be described, for example, as an aromatic ring.

The term “alkanediyl” refers to a divalent radical of an alkane and includes groups that are linear, branched, cyclic, bicyclic, or a combination thereof, including both unsubstituted and substituted alkanediyl groups.

The terms “alkenyl” or “alkenyl group” refers to a univalent group that is a radical of an alkene and includes groups that are linear, branched, cyclic, or any combination thereof. An alkenyl group has one or more double bonds. The location of the double bond may be anywhere along the alkenyl. The radical may be a part of the double bond (e.g., ·CHCH—R). The radical may be a part of a single bond (e.g., ·CH₂—R).

The term “backbone” refers to the longest contiguous chain. One or more branches may be covalently bonded to the backbone.

The term “aromatic” refers to a cyclic, fully conjugated planar structure (e.g., a compound or a portion of a compound) that obeys Hückel's rules, that is the compound has 4n+2 pi electrons where n is a positive integer or zero. For example, benzene has 6 pi electrons. Thus, 6=4n+2pi. Solving for n gives 1. Therefore, benzene is an aromatic compound.

The term “kosmotrope” is generally used to denote a solute that increases the degree of ordered-ness of water by stabilizing water-water interactions. Kosmotropes may be ionic or non-ionic. In contrast, the term “chaotrope” is generally used to denote a solute that decreases the degree of ordered-ness of water by destabilizing water-water interactions. Chaotropes may be ionic or non-ionic.

The term “catenated” in the context of heteroatoms refers to a heteroatom (e.g., O, S, N, P) that replaces at least one carbon atom in a carbon chain. For example, ether groups contain one catenary oxygen atom with at least one carbon atom on each side of the catenary oxygen atom and polyether groups contain more than one catenary oxygen atom with carbon atoms on each side of the more than one catenary oxygen atoms.

The term “peptide” refers to a sequence of amino acid residues without regard to the length of the sequence. Therefore, the term “peptide” refers to any amino acid sequence having at least two amino acids and includes full-length proteins and, as the case may be, polyproteins.

The term “polypeptide” refers to a sequence of amino acid residues without regard to the length of the sequence. Therefore, the term “polypeptide” refers to any amino acid sequence having at least two amino acids and includes full-length proteins, fragments thereof, and/or, as the case may be, polyproteins.

The term “protein” refers to any sequence of two or more amino acid residues without regard to the length of the sequence, as well as any complex of two or more separately translated amino acid sequences. Protein also refers to amino acid sequences chemically modified to include a carbohydrate, a lipid, a nucleotide sequence, or any combination of carbohydrates, lipids, and/or nucleotide sequences. As used herein, “protein,” “peptide,” and “polypeptide” are used interchangeably.

In the description, particular embodiments may be described in isolation for clarity. Reference throughout this specification to “one embodiment,” “an embodiment,” “certain embodiments,” “one or more embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments. Thus, features described in the context of one embodiment may be combined with features described in the context of a different embodiment except where the features are necessarily mutually exclusive.

For any method disclosed herein that includes discrete steps, the steps may be performed in any feasible order. And, as appropriate, any combination of two or more steps may be performed simultaneously.

### DETAILED DESCRIPTION

The present disclosure provides separation media and separation devices containing the same. Specifically, the present disclosure provides separation media that may be used to isolate diol containing compounds. To that end, the separation media of the present disclosure includes separation ligands. The separation ligands include a separating group that can be an affinity group, an assistance group, or a capping group. The affinity group includes a moiety that can bind to a diol of a target molecule. In some embodiments, the affinity group includes a boronic acid. Multiple layers of separation media of the present disclosure may be arranged in a stacked configuration to separate more than one target molecule, increase separation specificity, and/or increase efficiency. The separation media of the present disclosure may be used for separations in membrane chromatography.

The terms “separation” and “isolation” and their grammatical counterparts are used interchangeably to refer to the temporary immobilization of a target molecule on a separation media. Such terms may refer to variety of actions that the separation media and/or methods of the present disclosure can be used to accomplish. For example, a separation or isolation may refer to the purification of a target molecule from a mixture that includes impurities (i.e., molecules that are not the target molecule), concentration of the target molecule, and solvent exchange of a target molecule from a first solvent into a second solvent.

Molecules that include a diol functionality are ubiquitous in nature and are present in many synthetic small molecules. For example, various natural products including some alkaloids, some terpenes, and some flavonoids include one or more diols. Additionally, many biomolecules include one or more diols, including, for example, RNA nucleotides, RNA nucleosides, carbohydrates, glycoproteins, glycolipids, and metabolites. The ability to rapidly and/or selectively isolate molecules that include diols may be useful during synthetic workflows, diagnostic workflows, natural product extraction workflows, biomolecule production workflows, and many other workflows.

Various pharmaceutically relevant small molecules or intermediates of pharmaceutically relevant small molecules include diol functionalities. The ability to rapidly isolate the desired diol final product or diol containing intermediate from the byproducts of synthetic reactions may increase the efficiency of the production workflow. Alternatively, if a byproduct of a synthetic reaction includes a diol, rapid removal of such byproduct may increase the efficiency of the production workflow.

Many biomolecules (i.e., molecules that are naturally produced within a host such as a human) include one or more diols. For example, some antibodies are known to include various monosaccharides, disaccharides, and/or glycans that include one or more diols. The ability to isolate such antibodies may allow for facile purification and/or buffer exchange of antibodies. Additionally, RNA oligonucleotides, RNA nucleosides, and RNA nucleotides include at least one diol as a part of the ribose sugar. Isolation of RNA oligonucleotides, RNA nucleosides, and/or RNA nucleotides may increase the efficiency of oligonucleotide synthesis workflows, for example, for mRNA vaccine production. Furthermore, some metabolites include a diol functionality. Metabolite isolation may be used during diagnostic workflows.

Traditionally, downstream separations of small molecules and biomolecules has been expensive, slow and difficult to scale. Typical biomolecule separation trains include various steps such as centrifugation, filtering, and one or more chromatography separations using one or more types of chromatography columns (e.g., size exclusion columns and affinity chromatography columns). Typical small molecule separation trains include various steps such as a work-up (e.g., an extraction and/or washing), removing water (e.g., through a brine wash or exposure to a drying salt), removing solvent (e.g., through evaporation), and one or more chromatography separations using one or more types of chromatography columns (e.g., affinity columns and size exclusion columns). A typical chromatography column used in biomolecule and small molecule purification may include a packed bed column with resin configured for size exclusion chromatography or affinity chromatography (e.g., reverse phase chromatography, normal phase chromatography, metal ion affinity chromatography, ion exchange chromatography). Resin based chromatography columns have been the gold standard employed to purify small molecules and biomolecules for decades. However, column chromatography in large volumes may be very slow. Additionally, resin columns are known to require long residence times to perform adequately.

The present disclosure describes separation media that may be used for separation in membrane chromatography. In contrast to resin columns, membrane adsorbers perform well at short column residence times, potentially providing rapid isolation for various molecules. The present disclosure provides separation media that are suitable separation of target molecules.

Molecules of interest that may be separated using the separation media of the present disclosure are collectively referred to as target molecules or as targets. The target molecules of the present disclosure are molecules that include a diol. The target molecules may be present in a solution, suspension, or dispersion. For simplicity, the liquid containing the target molecule is referred to here as an isolation solution. Also, for simplicity, a target may be referred to in the singular, but it is understood that an isolation solution may include a plurality of target molecules of the same identity. An isolation solution may also include two or more targets of different identity. The isolation solution may be or include various other molecules that include a diol or do not include a diol. All other molecules included in the isolation solution that are not purposefully added (e.g., buffer components), are considered impurities.

In some embodiments, the separation media may be configured for use with solutions (e.g., isolation solution, washing solution, elution solution) that includes an organic solvent. In some embodiments, the separation media may be configured for use with solutions (e.g., isolation solution, washing solution, elution solution) that includes water. In some embodiments, the separation media may be configured for use with solutions (e.g., isolation solution, washing solution, elution solution) that includes water and one or more organic solvents.

A support substrate is the base material for the separation media. The support substrate provides a platform for which the separation ligands are immobilized. The support substrate includes at least one membrane. In some embodiments, the support substrate is the at least one membrane. In some embodiments, the support substrate includes two or more membranes arranged in a stacked configuration. In addition to the at least one membrane, the support substrate may include additional layers such as hydrogels, woven fibrous materials (i.e., a material made by the interlacing of multiple fibers), nonwoven fibrous materials (i.e., a material made from one or more fibers that are bound together through chemical, physical, heat, or mechanical treatment); or any combination thereof. Such additional layers may impart rigidity and structure to the membrane of the support substrate. In some embodiments, the support substrate includes a functionalized material that is deposited on the surface of the at least one membrane. The functionalized material may provide reactive handles to which the separation ligands may be reacted with to be immobilized to the support substrate. In embodiments where the separation media includes multiple layers, the layers may be laminated.

Any layer of the support substrate may be made of any suitable material. A suitable support substrate material is a material that is porous so as to allow the isolation solution to pass through the support substrate. In some embodiments, a suitable support substrate material is a material that does not chemically alter the target molecule; that is, does not react with the target molecule to add, remove, or transform chemical groups on the target molecule. Additionally, in some embodiments, a suitable support substrate is a material that does not react with the target molecule, or other molecules in the isolation solution, to form a non-reversible covalent bond which would permanently immobilize said molecule to the support substrate.

The support substrate includes at least one membrane. A membrane is understood as a sheet of material with a continuous pathway of polymeric material in all dimensions. The membrane may be made of any suitable support substrate material. Examples of suitable support substrate membrane materials include polyolefins; polyethersulfone; poly(tetrafluoroethylene); nylon; fiberglass; hydrogels; polyvinyl alcohol; natural polymers such as cellulose, cellulose ester, cellulose acetate, regenerated cellulose, cellulosic nanofiber, cellulose derivatives, agarose, chitosan; polyethylene; polyester; polysulfone; expanded polytetrafluoroethylene (ePTFE); polyvinylidene fluoride; polyamide (Nylon); polyacrylonitrile; polycarbonate; and any combination thereof.

In some embodiments, the membrane includes polypropylene. In some embodiments, the polypropylene is microporous polypropylene that has an average pore diameter of 3.0 micrometers.

In some embodiments, the membrane itself is functionalized prior to immobilizing the separation ligands. Functionalization of the membrane may be done to install reactive handles (e.g., a support substrate reactive handle as discussed herein) on the membrane. The reactive handles react with cooperative reactive handles on the separation ligands to form a covalent bond thereby immobilizing the separation ligands on the support substrate (as discussed herein). Functionalization may be accomplished by plasma treatment, corona treatment, and the like.

In some embodiments, the support substrate includes a functionalized layer. In some embodiments, the functionalized layer is a membrane. A functionalized layer is a material disposed on the surface of a support substrate layer (e.g., disposed on the surface of the at least one membrane) and includes the support substrate reactive handles that may be used for separation ligand immobilization. A functionalized layer may be covalently attached to the support substrate; adhered to the support substrate through electrostatic forces, hydrogen-bonding, and/or Van der Waals forces; laminated to the support substrate; or simply contacting the support substrate. A functionalized layer may be deposited on the surface of a support substrate (e.g., on the surface of the at least one membrane) using a variety of deposition techniques such as chemical vapor deposition, dip coating, spray coating, electrospinning, and the like.

In some embodiments, the functionalized layer is a polymer that is disposed onto the support surface using a grafting on or grafting from polymerization technique. Without wishing to be bound by theory, it is thought that disposing a polymer on the support substrate may increase the surface area and number of available support substrate reactive handles that can be used to immobilize the separation ligands and therefore result in high binding capacity of the separation media. The terms “grafting on,” “grafting onto,” and “grafted onto” refer to already formed polymer chains that adsorb or covalently attach to a surface (e.g., a support substrate surface). The terms “grafting from” or “grafted from” refer to a polymer chain that is initiated and grown from a surface (e.g., a support substrate surface). Any suitable polymer may be grafted on or grafted from a support substrate to form a functionalized layer. Suitable polymers are those that include a functional group that includes a reactive handle that allows for attachment of separation ligands to the support substrate. The reactive handle is not the polymerizable group, but instead is a group that remains intact following polymerization. Example polymers that include a reactive handle or a functional group that can be converted to a reactive handle (i.e., support substrate reactive handle) include carboxylic acids, amines, alcohols, epoxides, amides, azide, alkynes, and the like. Examples of monomers that can be used to form such polymers include vinyl alcohol, hydroxy functional acrylates (e.g., 2-hydroxyehtyl acrylate and 4-hydroxybutyl acrylate), hydroxy functional methacrylate (e.g., hydroxyethyl methacrylate), epoxy containing monomers, and hydroxy functional acrylamides (e.g., N-hydroxyethyl acrylamide). Examples of specific polymers that may be grafted on or grafted from a support substrate include polydopamine, poly(vinyl alcohol), poly(acrylic acid), poly(glycidyl methacrylate, and poly 2-hydroxyethyl acrylate (formed from 2-hydroxyethyl acrylate monomers). Graft on and graft from polymerization may be accomplished using a suitable technique such as addition polymerization (e.g., free radical polymerization such as atom transfer radical polymerization (ATRP) and reversible addition fragmentation chain transfer (RAFT) polymerization; anionic polymerization; and cationic polymerization), or condensation polymerization. In some embodiments, where the polymer is grafted from the support substrate, an initiator is first coupled to the support substrate (e.g., through an OH group on the support substrate). Any suitable initiator may be used, for example, 2-bromo-2-methylpropionyl bromide (BiBB).

The membranes of the support substrate are porous and can have an average pore size, as measure by a capillary flow porometer, of 10 micrometer or less, 5 micrometers or less, 2 micrometers or less, 1 micrometers or less, 0.6 micrometers or less, 0.5 micrometers or less, 0.45 micrometers or less, or 0.2 micrometers or less. The membrane may have an average pore size of 0.1 micrometers or greater, 0.2 micrometers or greater, 0.45 micrometers or greater, 0.5 micrometers or greater, 0.6 micrometers or greater, 0.7 micrometers or greater, or 1 micrometers or greater. The membrane may have an average pore size ranging from about 0.1 micrometers to 10.0 micrometers, 0.1 micrometers to 0.2 micrometers, 0.1 micrometers to 0.45 micrometers, 0.1 micrometers to 0.5 micrometers, 0.1 micrometers to 1 micrometers, 0.2 micrometers to 0.45, 0.2 micrometers to 0.50, 0.2 micrometers to 1 micrometers, 0.2 micrometers to 2 micrometers, 0.2 micrometers to 10 micrometers, 0.45 micrometers to 1 micrometers, 0.45 micrometers to 2 micrometers, 0.45 micrometers to 10 micrometers, 1 micrometers to 2 micrometers, or 1 micrometers to 5 micrometers. In some embodiments, the support substrate has an average pore size of 0.1 micrometers to 0.5 micrometers, 0.1 micrometers to 0.6 micrometers, 0.1 micrometers to 0.3 micrometers, or 0.4 micrometers to 0.6 micrometers.

In some embodiments, the support membrane includes cellulose such as regenerated cellulose, cellulose acetate, or cellulose ester. In some such embodiments, the support membrane has an average pore size 0.1 micrometers to 0.5 micrometers, 0.1 micrometers to 0.6 micrometers, 0.1 micrometers to 0.3 micrometers, or 0.4 micrometers to 0.6 micrometers.

The membranes of the support substrate may have a variety of thicknesses. In some embodiments, the membrane may have a thickness of 500 micrometers or greater, 250 micrometers or greater, 100 micrometers or greater, 80 micrometers or greater, 50 micrometers or greater, or 30 micrometers or greater. In some embodiments, the membrane may have a thickness of 2500 micrometers or less, 1000 micrometers or less, 500 micrometers or less, 250 micrometers or less, or 100 micrometers or less. In some embodiments, the thickness of the membrane may be in a range of 30 micrometers to 500 micrometers, 50 micrometers to 500 micrometers, 80 micrometers to 500 micrometers, 100 micrometers to 500 micrometers, 250 micrometers to 500 micrometers, 30 micrometers to 250 micrometers, 50 micrometers to 250 micrometers, 80 micrometers to 250 micrometers, 100 micrometers to 2500 micrometers, 30 micrometers to 100 micrometers, 50 micrometers to 100 micrometers, or 80 micrometers to 100 micrometers.

In some embodiments, the support substrate includes multiple membranes stacked in a multilayer arrangement. In some embodiments, the multilayer arrangement may function to increase capacity and/or selectivity of the separation media for a given application. In some embodiments, the multilayer membrane configuration (i.e., only considering the membrane layers of a support substrate) may have a thickness of 10,000 micrometers or less, 7,500 micrometers or less, 5,000 micrometers or less, 4,000 micrometers or less, 3,000 micrometers or less, 2,500 micrometers or less, 2,000 micrometers or less, 1,000 micrometers or less, 750 micrometers or less, 500 micrometers or less, 400 micrometers or less, or 300 micrometers or less. In some embodiments, the multilayer membrane configuration may have a thickness ranging from 70 micrometers to 10,000 micrometers, 70 micrometers to 100 micrometers, 70 micrometers to 200 micrometers, 70 micrometers to 300 micrometers, 70 micrometers to 400 micrometers, 70 micrometers to 500 micrometers, 70 micrometers to 750 micrometers, 70 micrometers to 1,000 micrometers, 70 micrometers to 2,000 micrometers, 70 micrometers to 3,000 micrometers, 70 micrometers to 4,000 micrometers, 70 micrometers to 5,000 micrometers, 250 micrometers to 300 micrometers, 250 micrometers to 400 micrometers, 250 micrometers to 500 micrometers, 250 micrometers to 750 micrometers, 250 micrometers to 1,000 micrometers, 250 to 2,000 micrometers, 250 to 3,000 micrometers, 250 to 4,000 micrometers, 250 to 5,000 micrometers, 500 micrometers to 1,000 micrometers, 500 micrometers to 2,000 micrometers, 500 micrometers to 3,000 micrometers, 500 micrometers to 4,000 micrometers, or 500 micrometers to 5,000 micrometers.

In some embodiments, the membrane is a regenerated cellulose membrane. In some embodiments, the membrane is a regenerated cellulose membrane having a pore size of 0.2 micrometers and 5.0 micrometers. In some embodiments, the membrane is a regenerated cellulose membrane having a thickness of 70 micrometers and 2,000 micrometers. In some embodiments, the membrane is a regenerated cellulose membrane having a pore size of 0.2 micrometers and 5.0 micrometers and thickness of 70 micrometers and 2,000 micrometers. In some embodiments, regenerated cellulose membranes, such as those disclosed herein, may be in a stacked arrangement approximately 70 micrometers to 10,000 micrometers in thickness.

The support substrate may include or be a microfiltration membrane. Microfiltration membranes are typically created through a phase inversion process or an expansion process. Typical materials used to prepare membranes include polyethersulfone (PES), nylon, polyvinylidene fluoride (PVDF), cellulose acetate, regenerated cellulose, polypropylene, and expanded polytetrafluoroethylene (ePTFE).

The separation media includes a plurality of separation ligands that include an affinity group. In addition to the plurality of separation ligands that include an affinity group, the separation media may include a plurality of separation ligands that include an assistance group; a plurality of ligands that include a capping group; or both.

An affinity group is a chemical group that is bound by the target molecule. Stated differently, an affinity group is a chemical group that binds the target molecule. As such, the affinity group is able to isolate the target molecule to the separation media. The affinity group includes a moiety capable of binding to target molecule that includes a diol. The term “diol” refers to a molecule that includes two hydroxyl groups (i.e., two —OH groups). In some embodiments, the affinity group includes a moiety that is capable of binding a diol in which the atoms that the hydroxyl groups are covalently bound to are separated by zero or one atom (e.g., carbon atoms). Diol functionalities where the hydroxyl groups are separated by a single atom may be referred as 1,3-diols. Diol functionalities where the hydroxyl groups are located on adjacent atoms (i.e., the atoms that the hydroxyl groups are bound to are covalently bound to each other; e.g., —CH(OH)—CH(OH)—) may be referred to as a vicinal diol or a 1,2-diol. For example, in some embodiments, the affinity group includes a moiety that is capable of binding to a vicinal diol. In some embodiments, the affinity group includes a moiety capable of binding to a cis diol; that is, the hydroxyl groups are oriented in the same direction (e.g., including planar diols). In some embodiments, the affinity group includes a moiety that is capable of binding to a 1,3-cis diol, a 1,2-cis diol, or both.

Molecules that include a diol functionality are found in natural molecules and in synthetic compounds. For example, monosaccharides (also called sugars) often include one or more diol functionalities such as a 1,3-diol; a vicinal diol; or both. Some sugars include a cis 1,3-diol; a cis vicinal diol; or both. The 1,3-diol; vicinal diol; cis 1,3-diol; or cis vicinal diol may exist when a given monosaccharide adopts (if possible) a furanose (i.e., five membered ring) and/or pyranose (i.e., six membered ring) constitutional isomer. Additionally, the 1,3-diol, vicinal diol, cis 1,3-diol, or cis vicinal diol may exist when the monosaccharide adopts one or more stereoisomer configurations. For example, the 1,3-diol; vicinal diol; cis 1,3-diol; or cis vicinal diol may exist when a given monosaccharide is in the L and/or D configuration. The classifications of D and L refer to the stereochemistry of the stereocenter that is the farthest away from the anomeric carbon. Additionally, the 1,3-diol; vicinal diol; cis 1,3-diol; or cis vicinal diol may exist when a given monosaccharide is in the α-anomer or a β-anomer configuration. Examples of monosaccharides that have at least one of 1,3-diol; a cis 1,3-diol; a vicinal diol; or a cis vicinal diol when adopting one or more constitutional isomers and/or stereoisomers include fructose, glucose, galactose, mannose, fucose, N-acetyl-galactosamine, N-acetyl-glucosamine, ribose, allose, altrose, iodose, talose, threose, erythrose, xylose, arabinose, N-acetylneuraminic acid (Neu5Ac) and other sialic acids, sorbose, and mannoheptulose, amongst others.

Monosaccharides may include one or more substituents or modifications. Example substituent groups and modifications include acetyl (Ac); D-alanyl (Ala), N-acetyl-D-alanyl (Ala2Ac); N-acetimidoyl (Am); N—(N-methyl-acetimidoyl) (AmMe); N—(N,N-dimethyl-acetimidoyl) (AmMe₂); formyl (Fo); glycolyl (Gc); N-acetyl-glutaminyl (Gln2Ac); N-methyl-5-glutamyl (5Glu2Me); glycyl (Gly); glyceryl (Gr); 2,3-di-O-methyl-glyceryl (Gr2,3Me₂); 4-hydroxybutyryl (4Hb); 3,4-dihydroxybutyryl (3,4Hb); (R)-3-hydroxybutyryl (3_{R}Hb); (S)-3-hydroxybutyryl (3_{S}Hb); lactyl (Lt); methyl (Me); amino (N); N-acetyl (NAc); phosphate (P); pyruvyl (Py); 1-carboxyethylidene (Pyr); sulfate (S); and tauryl (Tau). When used in the context of being a target molecule or being a part of a target molecule, recitation of “monosaccharide” or a given monosaccharide includes any constitutional isomer and stereoisomers that includes at least one of a 1,3-diol, cis 1,3-diol, 1,2 diol, or cis 1,2-diol, including any possible substituents and modifications.

In some embodiments, the target molecule includes a monosaccharide. In some such embodiments, the target molecule includes a monosaccharide that has at least one of a 1,3-diol or a vicinal diol. In some embodiments, the target molecule includes a monosaccharide that has a cis 1,3-diol and/or a cis vicinal diol. In some embodiments, the target molecule includes a ribose. In some embodiments, the target molecule includes a sialic acid such as Neu5Ac.

In some embodiments, the monosaccharide is a part of an RNA nucleoside, an RNA nucleotide, or and RNA containing oligonucleotide. As such, in some embodiments, the target molecule includes an RNA nucleoside, an RNA nucleotide, or an RNA containing oligonucleotide. The monosaccharide of an RNA nucleoside, RNA nucleotide, or an RNA containing oligonucleotide may be any monosaccharide that includes a 1,3-diol or a vicinal diol. In some embodiments, the monosaccharide is ribose.

An RNA nucleoside includes a nucleobase and a monosaccharide (e.g., a ribose). An RNA nucleotide includes an RNA nucleoside and an internucleoside linkage precursor (i.e., a moiety that may be a precursor to the formation of an internucleoside linkage). An internucleoside linkage covalently links adjacent nucleosides to one another to form a linear polymeric compound. An RNA containing oligonucleotide includes at least a 3′ terminal RNA nucleoside and one or more internucleoside linkages covalently connecting two or more nucleotides. An RNA containing oligonucleotide may include one or more DNA nucleosides.

The nucleobase of an RNA nucleoside, an RNA nucleotide, or an RNA containing oligonucleotide target molecule may include a canonical RNA nucleobase (i.e., adenine, guanine, cytosine, uracil), a noncanonical nucleobase (e.g., a modified canonical nucleobase and synthetic nucleobase), or both. Example of noncanonical nucleobases include pseudouridine, dihydrouridine, 5-methyl cytosine, inosine, 7-methyylguanosine, 7-deaza purines, G-clamp nucleotides (e.g., triazole containing G-clamp nucleotides), and xanthine, amongst others.

In embodiments where the target molecule is an RNA nucleotide, the internucleoside linkage precursor of an RNA nucleotide may be any internucleoside linkage precursor that would result in a natural or unnatural internucleoside linking group. In naturally occurring RNA, the internucleoside linking group is a phosphodiester that covalently links adjacent nucleosides to one another. Examples of unnatural internucleoside linking groups include phosphotriesters, methylphosphonate, phosphoramidites, phosphorothioates, methylenemethylimino, thiodiester, thionocarbamate, siloxanes, and dimethylhydrazine.

A target molecule that is an oligonucleotide containing an RNA nucleoside may be of any length. For example, the target oligonucleotide containing an RNA nucleoside may have anywhere from 2 nucleotides to 100000 nucleotides. In some embodiments, the oligonucleotide containing an RNA nucleoside includes a terminal 3′ RNA nucleoside. A terminal 3′ RNA nucleoside includes a ribose where the 2′ and 3′ carbons of the ribose each include a hydroxyl in a configuration such that the hydroxyls are a cis vicinal diol.

In some embodiments, the target molecule is an RNA nucleoside, an RNA nucleotide, or an oligonucleotide containing an RNA nucleoside. In some such embodiments, the separation media and the methods of the present disclosure may be used to purify (e.g., isolate) and/or concentrate a nucleoside, a nucleotide, or an oligonucleotide containing an RNA nucleoside. For example, the separation media and/or methods of the present disclosure may be used to purify and/or concentrate a synthetic nucleoside, synthetic nucleotide, or synthetic oligonucleotide containing an RNA nucleoside from a reaction mixture that includes undesired synthesis byproducts. The separation media and/or methods of the present disclosure may be used to isolate mRNA molecules of genes associated with a disease.

In some embodiments where the target molecule includes a monosaccharide, the monosaccharide is a part of a disaccharide (i.e., two covalently linked saccharides) or a glycan (i.e., a polymer of three or more covalently linked saccharides). Glycans may include any glycosylation pattern; that is, any pattern of monosaccharides, each monosaccharide linked to at least one other monosaccharide through a glycosidic linkage. Glycans may be in a linear or branched configuration. A linear glycan has a straight chain of linked monosaccharides. In some embodiments, the target molecule that includes a monosaccharide having a diol that can be bound by the affinity group includes a disaccharide or a glycan.

Monosaccharides, disaccharides, and glycans can be covalently linked to other biomolecules such as proteins and lipids. A protein that includes a covalently linked monosaccharide, disaccharide, or glycan is termed a glycoprotein or a glycosylated protein. A lipid that includes a covalently linked monosaccharide, disaccharide, or glycan is termed a glycolipid. Glycolipids and glycoproteins play a role in many cellular processes including cell-cell interactions and host-pathogen interactions. For example, the ABO blood group antigens displayed on red blood cells are glycolipids. Also, viruses can bind to cell surface sialyated glycans (a glycan that includes at least one sialic acid saccharide) and achieve entry into a host cell. Additionally, the glycosylation pattern of some antibodies impacts the pharmacokinetics and safety of therapeutic antibodies.

In some embodiments, the target molecule includes a glycoprotein or a glycolipid. In some such embodiments, the glycolipid or glycoprotein includes a sialic acid moiety as a conjugated monosaccharide or as a part of a disaccharide or glycan. In some embodiments, the glycoprotein or glycolipid target molecule is displayed on the surface of a cell, such as an intact cell (e.g., a cell that has not been lysed).

In some embodiments, the target molecule is a glycosylated antibody. Some antibodies include an antigen-binding domain (i.e., Fab fragment) and a fragment crystallizable domain (i.e., Fc fragment). The Fab fragment binds with the antigen and the Fc fragment interacts with cellular receptors to modulate the immune system through activation of immune cells. Variations in the glycosylation pattern of the Fc fragment of antibodies has been shown to impact immune response. For example, sialyation of the Fc fragment (i.e., an Fc fragment that includes one or more sialic acid units) has been associated with an increase in the anti-inflammatory properties of particular sialyated antibodies. As such, for various antibody based therapeutics, increasing the inflammatory properties of particular sialyated antibodies may be beneficial. Therefore, in some embodiments, the target molecule is a sialyated antibody.

Fucosylation of the Fc fragment (i.e., a Fc region that includes one or more fucose units) has been associated with a decrease in the antibody-dependent cellular toxicity (ADCC). ADCC is an immune mechanism for destroying the cells displaying the antigen that the antibody is bound to. A decrease in ADCC may decrease the effectiveness of an antibody therapeutic. As such, for various antibody based therapeutics, increasing the ADCC by providing afucosylated antibodies (i.e., antibodies lacking fucosylation) may be beneficial. Therefore, in some embodiments, the target molecule is a fucosylated antibody and the separation media and/or methods of the present disclosure may be used to separate afucosylated and fucosylated antibodies.

In some embodiments, the separation membranes and/or the methods of the present disclosure may be used isolate and or purify a target molecule that is a glycosylated antibody. In some such embodiments, the separation membrane and/or methods of the present disclosure may be used to purify and/or concentrate sialyated antibodies. In some embodiments, the separation membranes and/or methods of the present disclosure may be used to purify and/or concentrate afucosylated antibodies through, for example, filtering out fucosylated antibodies.

In some embodiments, the target molecule is a small molecule that includes a diol. Various synthetic small molecules, natural small molecules, and small molecule pharmaceuticals include 1,3-diols and/or vicinal diols. Examples of small molecule pharmaceuticals that include at least one diol include dropropizine (a cough suppressant), entacapone (a treatment for Parkinson's disease), fenoldopam mesylate (an antihypertensive), masoprocol (an antineoplastic), opicapone (a treatment for Parkinson's disease), protokylol (used as a bronchodilator), tolcapone (a treatment for Parkinson's disease), tresulfan (used during bone marrow transplants), iopydol (a contrast agent), floctafenine (an anti-inflammatory). Examples of other small molecules that have at least one diol include various catechols, various flavinoids, various theaflavins, various terpenes, and various alkaloids.

In some embodiments the separation media and/or methods of the present disclosure may be used to purify and/or concentrate target molecules that are small molecules. For example, the separation media and/or methods of the present disclosure may be used during the extraction process of natural products. In some embodiments, the separation media and/or methods of the present disclosure may be used to purify and/or concentrate intermediates and/or final products of a synthetic scheme.

In some embodiments, the small molecule target molecule is a metabolite. A metabolite is an intermediate or end product of metabolism. Metabolism is the all encompassing term for biological chemical reactions that construct (catabolism) or destruct (anabolism) various biologically relevant molecules, including small molecules, proteins, lipids, and oligonucleotides (RNA and DNA). The identity and/or quantity of various metabolites within a cell, tissue, or organ may be used as an indicator (or biomarker) for various disorders. For example, various urinary metabolites may be used as biomarkers for various disorders.

Many metabolites have a least one diol motif (e.g., 1,2-diol; 1,3-diol; cis 1,2-diol; or cis 1,3-diol). Examples of such metabolites include ribosylated metabolites (i.e., metabolites that are conjugated to a ribose) and modified nucleosides and/or modified nucleotides. Examples of ribosylated metabolites include 3-hydrixychavicol 1-glucoside; 1-ribosyl-N-acetlyhistamine; and ((1H-imdazol-2-yl)methyl)phenol-1-glucoside. Examples of modified nucleosides that have at least one diol include 5-carbamoylmethyluridine and 6-hydroxyl-1,6-dihydropurine ribonucleoside (CAS number is 136315-04-3).

In some embodiments where the target molecule is a metabolite, the separation media and/or methods of the present disclosure may be used to isolate and/or quantify the amount of one or more metabolites present in a sample. The sample may be from a patient that has or is suspected of having a particular disorder. As such, the separation media and/or methods of the present disclosure may be used during a diagnosis workflow.

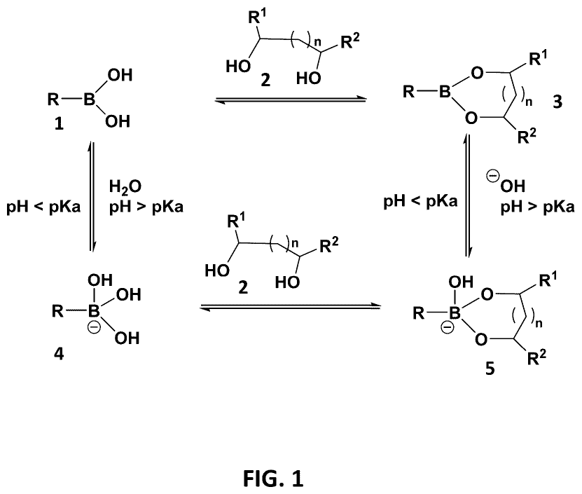

The separation media includes a plurality of separation ligands that include an affinity group that binds a diol motif in a target molecule. The affinity group includes a boronic acid (—B(OH)₂) or cyclized boronic acid (see formula B(ii)). Boronic acids are able to form reversible covalent bonds to various types of diol functionalities. FIG. 1 shows a possible equilibria between species thought to participate in the reversible covalent bond formation between a genericized diol 2 and genericized boronic acid (1). R, R¹, and R² may be any substituent and n may be 0 or 1 (i.e., a 1,2-diol or a 1,3-diol). In a first pathway, the boronic acid 1 can react with the diol 2 to form a neutral 5 or 6-member boronate ester ring 3. The neutral boronate ester may accept a hydroxyl group to form the charged boronate ester 5. In a second pathway, the boronic acid can act as a Lewis acid and accept a hydroxyl group to become the conjugate base of boronic acid 4. The conjugate base 4 can then react with the diol 2 to form the charged boronate ester 5. The charge form of the borate ester is thought to be more stable than the neutral borate ester. The terms boronate ester and boronic acid ester refer to the reaction product of a boronic acid or boronic acid conjugate base (see species 4) with a diol.

Each reaction in the formation of either the charged or neutral borate ester is reversible. The equilibria between each reaction may be impacted by the pH of the reaction solution. Generally, when the pH is greater than the pKa of the boronic acid, formation of the charged borate ester 5 is favored. For example, when the pH is greater than the pKa of the boronic acid, reaction conditions may favor the formation of boronic acid conjugate base from 4 boronic acid 1 which can then be converted to the charged boronate ester 5 through reaction with diol 2. Additionally, generally, when the pH is greater than the pKa of the boronic acid, the formation of charged borate ester 5 from the neutral borate ester 3 is favored. In practice, the pH of the reaction solution need not be greater than the pKa of the boronic acid to allow for the formation of neutral and/or charged boronate esters.

The pH dependence on borate ester formation may be used to tune binding affinity group binding specificity and affinity. Additionally, the pH dependence of borate ester formation may be used to encourage binding and unbinding of the target molecule to the separation media. For example, an isolation solution (e.g., a solution that includes a carrier and the target molecule) having a pH that is higher than the pKa of the affinity groups may contacted with a separation media to encourage binding of the target molecule to the separation media. Similarly, an elution solution (e.g., a solution used for eluting the target molecule from the separation media) have a pH less than the pKa of the boronic acid may be used to break the borate ester and free the target molecule from the separation media.

Other factors that may impact the equilibria of the scheme in FIG. 1 include, the identity of the diol and the identity of the boronic acid. Generally, it is thought that cis diols result more stable borate esters than 1,3-diols. Additionally, the molecule that includes the boronic acid may include one or more additional moieties that can increase or decrease the stability of the borate ester through interaction with the cis diol or other moieties located on the molecule that includes the cis diol.

The boronic acid containing affinity groups of the present application are of formula B(i) or B(ii) where J is an intermediate group. Formula B(i) is a boronic acid and formula B(ii) is a benzoxaborole.

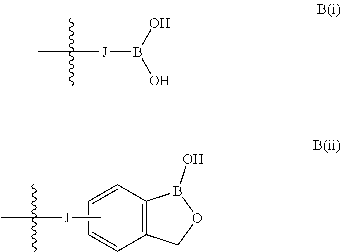

In some embodiments, the intermediate group J has properties and/or functionalities that facilitate binding of the target molecule to the separation media. For example, the intermediate group J may include functionalities that allow for the affinity group to interact with the target molecule through one or more various mechanism. Example mechanism through which the affinity molecule may interact with the target molecule include hydrogen bonding, electrostatic interactions, van der Waals forces, London dispersion forces, hydrophobic interactions, hydrophilic interactions, and pi-pi stacking. For example, an intermediate group that includes amino groups, heterocyclic rings, ureas may be able to interact with the carboxylate group of target compounds (e.g., a target molecule that includes sialic acid). Such interactions may increase the stability of the boronate ester.

Tuning the strength of the boronate ester may allow for increased specificity for the target molecule. For example, a binding mixture may include multiple compounds that have diols that can bind to the affinity group. The identity of J may allow for the target molecule to form a more stable covalent bond with the affinity group than the other diol containing compounds. A such, the undesired diol containing compound may be removed through exposure to a pH that breaks the undesired diol containing compound-boronate ester but does not break the target molecule-boronate ester. Alternatively, the identity of J may allow for the undesired compound to form a more stable covalent bond with the affinity group than the target molecule. As such, the target molecule may be eluted from the separation media while the undesired molecule remains bound through exposing the separation media to an elution solution having a pH that breaks the target compound-boronate ester but does not break the undesired compound-boronate ester.

In some embodiments, the intermediate group J includes properties and/or functionalities that enhance the specificity of the affinity ligand for a specific target molecule. For example, in some embodiments, the intermediate group includes properties and/or functionalities that discourage and/or prevent molecules that are not the target molecule from binding the separation media. The intermediate group J may include, for example, substituents that sterically prevent the undesired compound from binding. The intermediate group J may include substituents that are electrostatically or otherwise incompatible with one or more various regions of an undesired compound.

In some embodiments, the J group may impact the pKa of the boronic acid. The ability to modulate the pKa of the boronic acid may be beneficial when the stability of the target compound is pH sensitive. For example, when the target molecule includes a biomolecule (e.g., lipid, protein, or oligonucleotide), it may be beneficial for the pKa of the boronic acid to be such that the pH of the isolation solution can be at, or near, a physiological relevant pH (e.g., 4.5 to 8) while still being compatible for boronate ester formation between the target molecule and the boronic acid. Additionally, in some embodiments where the isolation solution includes a biological sample (e.g., blood, urine, saliva), it may be beneficial to not have to adjust the pH to encourage boronate ester formation. Boronic acids having intermediate groups that are electron withdrawing have increased acidity and a lower pKa values than boronic acids having intermediate groups that are electron donating groups.

The pKa value of a boronic acid may be lowered through the inclusion of a nitrogen that can coordinate with the boronic acid to form a Wulff-type or a pseudo-Wulff-type boronic acid. A Wulff type boronic acid includes an intramolecular tetracoordinated boron (i.e., through B—N and/or B—O bonds) that allows the formation of a boronic acid that has a lower pKa (see, for example, Acc. Chem. Res. 2017, 50, 2185-2193, DOI: 10.1021/acs.accounts.7b00179). In some embodiments, the intermediate group J includes a nitrogen that can coordinate with the boron of the boronic acid to form a Wulff-type boronic acid. A pseudo-Wulff-type boronic acid is a boronic acid that has an intermolecular interaction with a nitrogen (see, for example, id.). A pseudo-Wulff-type boronic acid may be formed through the interaction of a boronic acid with an amine of an assistance group on an adjacent separation ligand (assistance groups are type of separation ligand that is described in detail elsewhere herein).

Intermediate J may include any organic group. In some embodiments, intermediate J includes an aromatic ring, an alkyl, or both.

In some embodiments, intermediate J includes an aromatic ring. The aromatic group may be any aromatic group including fused ring systems. Examples of aromatic groups include benzene, thiophene, furan, pyrrole, pyridine, pyrimidine, naphthalene, imidazole, indole, or any combination thereof. The boronic acid may be a substituent of the aromatic ring. The aromatic ring may include substituents in addition to the boronic acid. Examples of such substituents include halogens, amines, alcohols, esters, acids, ethers, ureas, carbamates, carbonate, sulphone, sulfonic acid, or any combination thereof. The aromatic substituents may be directly bonded to the aromatic ring or separated from the aromatic ring by an alkanediyl (i.e., the alkanediyl is directly bonded to the aromatic ring as well as the aromatic substituent). The aromatic substituents may have any pattern around the aromatic ring.

In some embodiments when J includes a benzene ring, the boronic acid may be located ortho or meta to the point of attachment bond. In some embodiments, the boronic acid is not located para to the point of attachment bond. In some embodiments when J includes a benzene ring, the boronic acid may be at position 2, 3, 5, or 6 relative to the point of attachment bond. In some embodiments, the boronic acid is not located at position 4 relative to the point of attachment bond.

In some embodiments the formula B(i) is of formula B(i)a

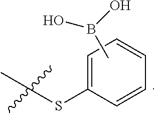

In some such embodiments, the boronic acid is ortho or meta to the point of attachment bond. In some embodiments, the boronic acid is not located at para to the point of attachment bond. In some embodiments where the affinity group includes a boronic acid of formula Bi(a), the boronic acid may be at position 2, 3, 5, or 6 relative to the point of attachment bond. In some embodiments, the boronic acid is not located at position 4 relative to the point of attachment bond.

In some embodiments, the intermediate J includes an alkyl. In embodiments, where intermediate J includes an alkyl and no aromatic ring, the boronic acid is covalently bonded to the alkyl group (i.e., the radical of the alkyl group is bonded to the boron of the boronic acid). The alkyl group may be of C1 to C10 in length. In some embodiments, the alkyl group is of length C1, C2, C3, C4, C5, C6, C7, C8, C9, or C10. The alkyl group may include various substituents. Examples of such substituents include halogens, amines, alcohols, esters, acids, ethers, ureas, carbamates, carbonate, sulphone, sulfonic acid, or any combination thereof. The alkyl may be a branched alkyl. A branched alkyl includes a backbone (i.e., the longest contiguous carbon chain) and one or more alkyl branches covalently bonded to the backbone.

In some embodiments, intermediate J is of the general formula of J(i), J(ii), or J(iii) where each n is independently 0, 1, 2, 3, 4, or 5; at least one of R^{A}, R^{B}, R^{C}, R^{D}, R^{E}, and R^{F} is the boronic acid; at least one R^{A}, R^{B}, R^{C}, R^{D}, R^{E}, and R^{F} is the connection point shown in B(i) or B(ii); and the remaining R^{A}, R^{B}, R^{C}, R^{D}, R^{E}, and R^{F} (i.e., those that are not the boronic acid or the connection point) are each independently H (hydrogen), a halogen (I, F, Br, Cl), an amine, an aldehyde, a vinyl group, an ester, an ether, an alcohol, a urea, a guanidine, a carbonate, a carbamate, or a sulfone.

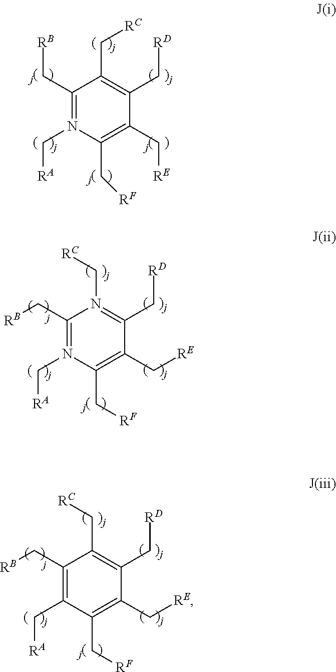

In some embodiments, one or more of R^{A}, R^{B}, R^{C}, R^{D}, R^{E}, and R^{F} is an amine. The amine may be of the formula —NR⁶⁰R⁶¹R⁶² where each one of R⁶⁰, R⁶¹, and R⁶² is H or an alkyl group. In some embodiments, the alkyl group is methyl (—CH₃), ethyl (—CH₂CH₃), propyl (—CH₂CH₂CH₃), or isopropyl (—CH(CH₃)₂).

In some embodiments, the intermediate J is of formula J(iii) where R^{A} is the connection point shown in B(i) or B(ii), all of the j are 0, and all of the substituents (R^{B}—R^{F}) are H except for the boronic acid, the boronic acid may be located at position R^{B}, R^{B}, R^{E}, or R^{F}. In some embodiments, the intermediate J is of formula J(iii) where R^{A} is the connection point shown in B(i) or B(ii), all of the j are 0, and all of the substituents (R^{B}—R^{F}) are H except for the boronic acid, the boronic acid is not at position R^{D}. In some embodiments, the intermediate J is of formula J(iii) where R^{A} is the connection point shown in B(i) or B(ii); all of the j are 0; R^{B}, R^{C}, and R^{E} are H; and R^{F} is the boronic acid. In some embodiments, the intermediate J is of formula J(iii) where R^{A} is the connection point shown in B(i) or B(ii); all of the j are 0; R^{B}, R^{C}, R^{D}, and R^{F} are H; and R^{E} is the boronic acid. In some embodiments, the intermediate J is of formula J(iii) where R^{A} is the connection point shown in B(i) or B(ii); all of the j are 0; R^{B}, R^{D}, R^{E}, and R^{F} are H; and R^{C} is the boronic acid. In some embodiments, the intermediate J is of formula J(iii) where R^{A} is the connection point shown in B(i) or B(ii); all of the j are 0; R^{C}, R^{D}, R^{E}, and R^{F} are H; and R^{B} is the boronic acid.

In some embodiments, one or more of R^{A}, R^{B}, R^{C}, R^{D}, R^{E}, and R^{F} is a vinyl group (i.e., includes a terminal alkene). In some such embodiments, the vinyl alkene is of the formula (—CHCH₂).

In some embodiments, one or more of R^{A}, R^{B}, R^{C}, R^{D}, R^{E}, and R^{F} is an ester of the formula —O(CO)—R⁷⁰ or —C(O)O—R⁷⁰. R⁷⁰ may be an alkyl group. In some embodiments, the alkyl group is methyl (—CH₃), ethyl (—CH₂CH₃), propyl (—CH₂CH₂CH₃), or isopropyl (—CH(CH₃)₂).

In some embodiments, one or more of R^{A}, R^{B}, R^{C}, R^{D}, R^{E}, and R^{F} is an ether or an alcohol of the formula —OR⁸⁰. R⁸⁰ may be H (for an alcohol) or an alkyl group (for an ether). In some embodiments, the alkyl group is methyl (—CH₃), ethyl (—CH₂CH₃), propyl (—CH₂CH₂CH₃), or isopropyl (—CH(CH₃)₂).

In some embodiments, one or more of R^{A}, R^{B}, R^{C}, R^{D}, R^{E}, and R^{F} is a urea of the formula —NH(CO)NH—R⁹⁰. R⁹⁰ may be H or an alkyl group. In some embodiments, the alkyl group is methyl (—CH₃), ethyl (—CH₂CH₃), propyl (—CH₂CH₂CH₃), or isopropyl (—CH(CH₃)₂).

In some embodiments, one or more of R^{A}, R^{B}, R^{C}, R^{D}, R^{E}, and R^{F} is a guanidine of the formula —N(R¹⁰¹)(NHR¹⁰²)NR¹⁰³R¹⁰⁴. Each one of R¹⁰¹, R¹⁰², R¹⁰³, and R¹⁰⁴ are independently H or an alkyl group. In some embodiments, the alkyl group is methyl (—CH₃), ethyl (—CH₂CH₃), propyl (—CH₂CH₂CH₃), or isopropyl (—CH(CH₃)₂). In some embodiments, each one of R¹⁰¹, R¹⁰², R¹⁰³, and R¹⁰⁴ is H.

In some embodiments, one or more of R^{A}, R^{B}, R^{C}, R^{D}, R^{E}, and R^{F} is a carbonate of the formula —O(CO)OR¹¹⁰. R¹¹⁰ may be H or an alkyl group. In some embodiments, the alkyl group is methyl (—CH₃), ethyl (—CH₂CH₃), propyl (—CH₂CH₂CH₃), or isopropyl (—CH(CH₃)₂).

In some embodiments, one or more of R^{A}, R^{B}, R^{C}, R^{D}, R^{E}, and R^{F} is a carbonate of the formula —O(CO)NHR¹²⁰ or —NH(CO)OR¹²⁰. R¹²⁰ may be H or an alkyl group. In some embodiments, the alkyl group is methyl (—CH₃), ethyl (—CH₂CH₃), propyl (—CH₂CH₂CH₃), or isopropyl (—CH(CH₃)₂).

In some embodiments one or more of R^{A}, R^{B}, R^{C}, R^{D}, R^{E}, and R^{F} is a sulfone of the formula —S(O₂)— or —S(O₂)R¹³⁰. R¹³⁰ may be an alkyl group. In some embodiments, the alkyl group is methyl (—CH₃), ethyl (—CH₂CH₃), propyl (—CH₂CH₂CH₃), or isopropyl (—CH(CH₃)₂). In some embodiments, where at least one of R^{A}, R^{B}, R^{C}, R^{D}, R^{E}, and R^{F} is a sulfone of the formula —S(O₂)—, the point of connection as shown in B(i) or B(ii) is through the sulfone.

In some embodiments, intermediate J is of the general formula of J(iv), J(v), or J(vi) where each j is independently 0, 1, 2, 3, 4, or 5; at least one of R^{A}, R^{B}, R^{C}, and R^{D} is the boronic acid; at least one R^{A}, R^{B}, R^{C}, and R^{D} is the connection point shown in B(i) or B(ii); and the remaining R^{A}, R^{B}, R^{C}, and R^{D} are each independently H (hydrogen), a halogen (I, F, Br, Cl), an amine, an aldehyde, a vinyl group, an ester, an ether, an alcohol, a urea, a guanidine, a carbonate, a carbamate, or a sulfone. The aldehyde, vinyl group, ester, ether, alcohol, urea, guanidine, carbonate, carbamate, and sulfone may be of any configuration as described elsewhere herein.

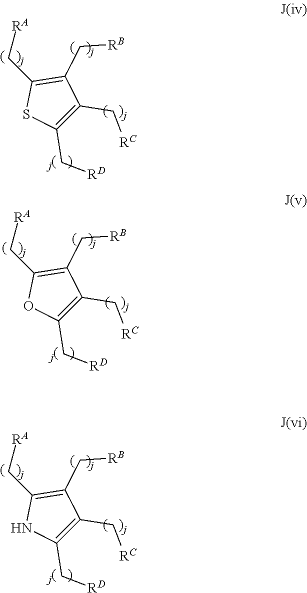

In some embodiments, the boronic acid containing affinity group includes or is derived from 4-(methyl)sulfonylbenzene-boronic acid; 2-thiopheneboronic acid; 3-thiophene boronic acid; 3-pyidinylboronic acid; 4-pyridinylboronic acid; pyrimidine-5-boronic acid, 3-aminophenylboronic acid; 4-vinylphenulboronic acid; mercaptophenyl boronic acid; 2,4-difluoro-3-formylphenyl boronic acid; or n-butyl boronic acid. In some embodiments where the affinity group is derived from such compounds, a reactive group of the compound acts as a reactive handle that reacts with a complementary reactive handle to form the linker of the affinity group (as discussed elsewhere herein). As such, the reactive group may not be considered a part of the intermediate group J of such compounds.

In some embodiments, the boronic acid containing affinity group includes or is derived from 4-mercaptopheynyl boronic acid (MPBA, structure shown below). In some embodiments, the boronic acid containing affinity group does not include or is not derived from 4-mercaptopheynyl boronic acid (MPBA, structure shown below).

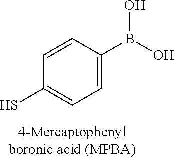

In some embodiments, the separation media includes a plurality of separation ligands that include a separation group that is an assistance group. An assistance group is a chemical moiety that facilitates the binding of the target molecule to the affinity group; binds the target molecule through electrostatic interactions and/or hydrophobic interactions; or both. In some embodiments, the assistance group may allow for a high density of target molecules to bind to separation ligands that include an affinity group. In some embodiments, the assistance group may aid in attracting the target molecule to the support substrate such as to allow for the target molecule to be in proximity to a separation group that includes an affinity group. For example, the assistance group may be ionizable or possesses a formal charge which may be opposite the charge of the target molecule. In such cases, the oppositely charged assistance group may attract the target molecule to the support substrate which may allow the target molecule to bind to the affinity group.

In some embodiments, the assistance group functions as a cation or anion exchange chromatography ligand. Anion exchange ligands have a positively charged functional groups that targets negatively charged target molecules through electrostatic interactions. The anion exchange ligand may possess a formal positive charge, or the positive charge can be induced through the pH of the solution that the anion exchange ligand is exposed to. Cation exchange ligands have a positively charged functional group that targets negatively charged target molecules through electrostatic interactions. The anion exchange ligand may possess a formal negative charge, or the negative charge can be induced through the pH of the solution that the anion exchange ligand is exposed to.

In some embodiments, the assistance group possesses a positive formal charge or is ionizable under certain pH conditions to have a positive charge. Such assistance groups may be beneficial when the target molecule has a negative formal charge. Examples of such assistance ligands include primary, secondary, tertiary, and quaternary amines. Suitable amines may be diamines, triamines, and polyamines.

Examples of primary amines include methylene diamine, ethylene diamine, propylene diamine, butylenediamine (putrescine), pentylamine, or any aliphatic diamine with 1-18 carbons between the terminal amines, covalently attached via one of the amines. Such ligands can be made from polyamines such as ethylene diamine, diethylenetriamine, triethylenetetramine covalently attached via one of the amines.

Examples of secondary amines can include any of the aforementioned primary amines immobilized to the substrate, substituted with an additional R-group as described above. In cases in which diamines are used, secondary amines may also be formed by covalent interaction with the substrate coupling both amines to the substrate. Ligands containing secondary amines with the structure of the ligand may also be immobilized such as linear polyethyleneimine, spermidine, or spermine. Furthermore, groups containing a non-terminal primary amine (e.g., 3-aminopentane) may also be conjugated to the substrate to result in a secondary amine.

Examples of suitable tertiary amines include N,N-dimethylethylenediamine; N,N-dimethylpropylenediamine; N,N-diethylpropylenediamine; or any aliphatic diamine with aliphatic carbon group substitution on one or both amines ranging from one to six carbons, with an linker having 2-18 carbons between the terminal amines.

Examples of quaternary amines include any of the aforementioned primary amines that have undergone a quaternarization reaction resulting in a permanent positive charge. Such reactions can be performed with alkyl groups such as methyl iodide or aryl groups such as benzyl iodide. Quaternary amines can further include any of the aforementioned tertiary amines that have undergone a quaternarization reaction resulting in a permanent positive charge. Such reactions can be described by the Menshutkin reaction which uses an alkyl halide to form a quaternary ammonium salt from a reaction with a tertiary amine. Such reactions can be performed with alkyl containing groups of varying length such as butyl bromide or aryl groups such as benzyl chloride or combinations therein. Additionally, compounds containing quaternary amines can be immobilized directly.

In some embodiments, the assistance group functions as a helper group to form a pseudo-Wulff-type boronic acid. An assistance group that is a helper group includes a primary amine, secondary amine, or tertiary amine that can coordinate with the boron of the boronic acid. Such coordination may facilitate the formation of the boronate ester with the target molecule. In some embodiments, the inclusion of helper groups functions to lower the pKa of the boronic acid of the affinity group compared to the affinity group without the helper group. The primary amine, secondary amine, or tertiary amine may be any primary amine, secondary amine, or tertiary amine such as those described elsewhere herein.

In other embodiments, the assistance group possesses a negative formal charge or is ionizable under certain pH conditions to have a negative charge. Such assistance group may be beneficial when the target molecule has a positive formal charge. The difference in charge of target molecule and the assistance molecule may allow for an electrostatic interaction between the target molecule and the assistance group thereby allowing the target molecule to be proximate to the support surface and the affinity groups which may increase the probability of the target molecule of binding to an affinity group.

In some embodiments, the assistance group is such that it is able to induce hydrophobic interactions with the target molecules. Hydrophobic interactions exploit the differences in hydrophobicity between the target molecules and possible impurities. In one embodiment, such ligands include aliphatic chains with three carbons or longer (common used lengths include butyl, pentyl, hexyl, heptyl, octyl, nonyl, decyl, undecyl, and dodecyl), benzyl, phenyl, phenol, pyridine, branched polymers such as polypropylene glycol, and sulfur-containing thiophilic ligands such as propanethiol, 2-butanethiol, 3,6-dioxa-1,8-octanedithiol, octanethiol, benzyl mercaptan, 2-mercaptopyridine, thiophenol, 1,2-ethanedithiol, 1,4-benzenedimethanethiol, 2-phenylethanethiol, and the like, and any combination thereof.

In some embodiments, separation ligands that include an assistance group can be directly incorporated into a functionalized layer of a support substrate through polymerization of a monomer that includes an assistance group.

In some embodiments, the separation media includes a plurality of separation ligands that includes a separation group that is a capping group. A capping group is a chemical moiety that prevents reactive groups of the support membrane from reacting with the target molecule or any other molecule in the isolation solution. A capping group may be employed to block support substrate reactive handles that have not reacted with other separation ligands. A capping group may be used to cap the end of a polymer chain. Capping groups may be any chemical group that is non-reactive towards the target molecule or other molecules the isolation solution.

In some embodiments, a separation ligand immobilized on a support substrate has the formula (SLim)

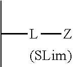

where L is a linker, Z is a separation group, and the vertical black line is the support substrate.

Each separation ligand of the plurality of separation ligands has the formula SL

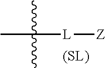

where L is a linker and Z is a separation group. L separates the support substrate from Z. The separation group may include an affinity group, an assistance group, capping group, or assistance group. The affinity group may be any affinity group as disclosed herein. The assistance group may be any assistance group disclosed herein. The capping group may be any capping group as disclosed herein. The assistance group may be any capping group as disclosed herein. For example, in the context of the affinity group, the separation ligand of formula SL may be of the formula -L-J-B where L is the linker, J is the intermediate group, and B is the boronic acid of formula B(i) or B(ii).

Separation ligands of multiple chemical compositions may be immobilized to a single support substrate. For example, a support substrate may include a first portion of a separation ligands of formula SL and a second portion of separation ligands of formula SL. In some embodiments, the first portion and the second portion of separation ligands include the same affinity group but have different linkers (L). In other embodiments, the first portion and the second portion of the separation ligands may have the same linker but have different separation groups. In some embodiments, L is of formula L1 such that the separation ligand of formula SL is of formula SL1.

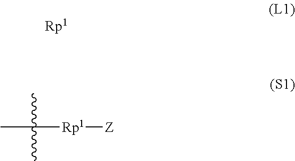

Rp¹ is a reaction product, and Z is the separation group. A reaction product is the chemical group resulting from the reaction of two cooperative functional handles (as discussed herein). In a separation ligand of formula SL1, the linker is the reaction product. The reaction product Rp¹ links the support substrate (not shown) and the separation group (Z). A covalent bond from Rp¹ to the support substrate is the point of covalent attachment of the linker (L1) to the support substrate. A covalent bond from Rp¹ to the separation group (Z) is the point of covalent attachment of the linker (L1) to the separation group (Z). Rp¹ may be any reaction product as disclosed herein.

The reaction product (Rp¹) may be the reaction product between any two cooperative reactive handles (as described herein). Examples of reaction products include amides, ureas, thioureas, carbamates, carbonates, esters, thioethers, ethers, imines, and triazoles. In some embodiments, a reaction product (e.g., such as Rp¹) is Rp^{A}, Rp^{B}, Rp^{C}, Rp^{D}, Rp^{E}, Rp^{F}, Rp^{G}, Rp^{H}, Rp^{I}, Rp^{J}, Rp^{K}, Rp^{L}, Rp^{M}, or an isomer thereof. Chemical structures of Rp^{A}-Rp^{M} are depicted below.

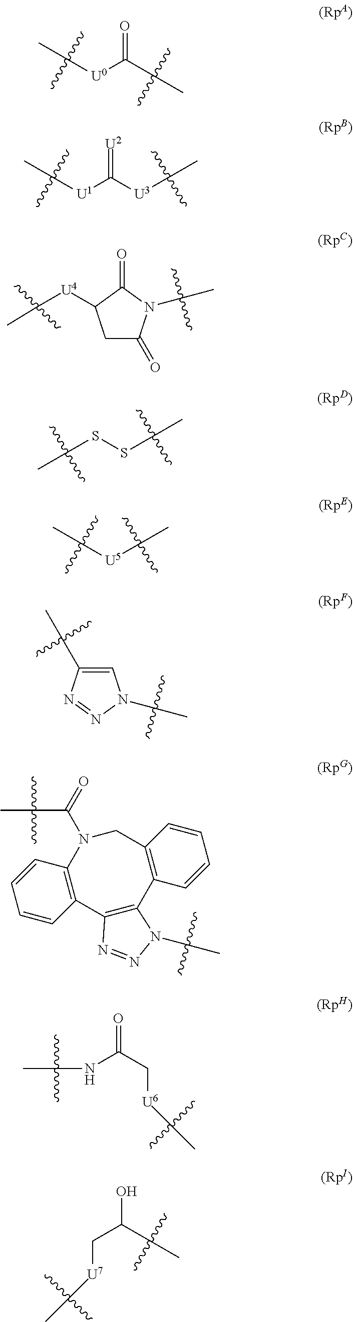

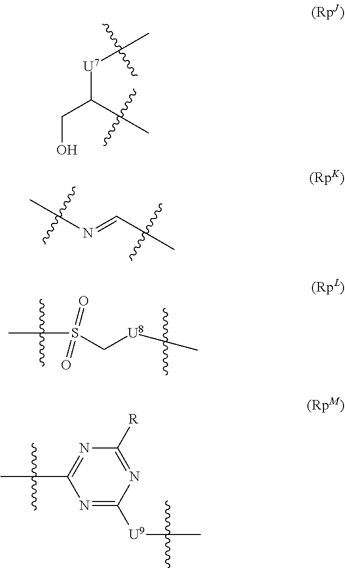

where U⁰, U⁴, U⁵, U⁶, U⁷, U⁸ and U⁹ are independently NH, N, O, or S. For Rp^{B} each of U¹, U², and U³ are independently NH, N, O, or S. R in Rp^{M} may be H, an organic group, or a halogen. For Rp^{B}, each of U¹, U², and U³ are independently NH, N, O, or S. The reaction products have two connection points, each of which may be covalently linked to the support substrate or any component of a separation ligand. For separation ligands of formula SL1, one connection point the reaction product Rp¹ is linked to the separation group while the other connection point of the reaction product Rp¹ is linked to the support substrate. In the context of an affinity ligand of the formula SL1, one connection point of the reaction product Rp¹ is linked to the support substrate and the other connection point of the reaction product Rp¹ is linked to intermediate J of the affinity ligand (i.e., -Rp1-J-B where B is of B(i) or B(ii)).

In some embodiments where the separation ligand is of formula SL1, Rp¹ is Rp^{A} where U⁰ is NH. In some such embodiments, the amide nitrogen (U⁰) of Rp^{A} is covalently linked to the separation group. In other such embodiments, the amide nitrogen of Rp^{A} is covalently linked to the support substrate.

In some embodiments where the separation ligand is of formula SL1, Rp¹ is Rp^{A} where U⁰ is O. In some such embodiments, the ester oxygen (U⁰) of Rp^{A} is covalently linked to the separation group. In other such embodiments, the ester oxygen of Rp^{A} is covalently linked to the support substrate.

In some embodiments where the separation ligand is of formula SLI, Rp¹ is Rp^{I}, the N of Rp^{I} may be covalently linked to the separation group. In other such embodiments, the N of Rp^{I} may be covalently linked to the support substrate.

The identity of a reaction product (e.g., Rp¹) depends at least in part on the type of conjugation chemistry used to form the reaction product. In a conjugation reaction, each component being linked together includes a reactive handle, such that the reactive handles are cooperative reactive handles. Components that include a reactive handle for conjugation reactions are termed precursor compounds or precursors. A precursor compound includes the component and a reactive handle covalently linked to the component. Cooperative handles or cooperative reactive handles are two or more reactive handles that when exposed to each other under favorable reaction conditions a conjugation reaction occurs to form a reaction product between the reactive handles. Components that have been conjugated through a conjugation reaction may be referred to as a conjugate. For example, component A and component B are to be conjugated through a conjugation reaction. The component A precursor includes a reactive handle X. The component B precursor includes a reactive handle Y. X and Y are cooperative. A conjugation reaction between the component A precursor and the component B precursor results in the formation of an A-B conjugate that includes the reaction product between X and Y. It is understood that the notation of a conjugate is from the perspective of the conjugated components, not the precursors of those components (i.e., A-B conjugate not A precursor-B precursor conjugate). This is because upon completion of the conjugation reaction, the precursor components are no longer precursors. In the case of a component precursor that includes two independently reactive handles, one of which has been reacted with a different component precursor to form a conjugate, the conjugate notation is still from the perspective of the conjugated components, not the precursor components, with the understanding that the conjugate includes the unreacted second reactive handle. For example, a component D precursor includes a first reactive handle J and a second reactive handle Z. The component B precursor has the reactive handle Y. J and Y are cooperative handles. A conjugation reaction between the component A precursor and the component B precursor results in the formation of an A-B conjugate that includes the reaction product between J and Y. The A-B conjugate also includes the unreacted second reactive handle Z.

Any pair of cooperative reactive handles may be used to form a reaction product of the present disclosure. Examples of cooperative handles include an activated ester and an amine; an amine and an NHS-ester; a hydroxyl and an NHS-ester; a hydroxyl and an epoxide; an acyl chloride and an amine; an acyl chloride and an alcohol; an amine and an epoxide; a thiol and an epoxide; a thiol and a maleimide; a disulfide and a thiol; an azide and an alkyne (azide and a linear alkyne in the presence of Cu(I); an azide and a cyclic alkyne such as cyclooctyne, difluorinated cyclooctyne, dibenzocyclooctyne, TMTH-Sulfoxlmine, biarylazacyclooctynone, or bicyclo[6.1.0]nonyne); an amine and an isocyanate; an amine and an isothiocyanate, a amine and a benzoyl fluoride; a thiol and a Iodoacetamide; a thiol and a bromoacetamide; a disulfide and 2-thiopyridine; a thiol and 3-arylpropiolonitirle; a phenol and a diazonium salt; a phenol and 4-phenyl-1,2,4-triazoline-3,5-dione; a phenol and aldehyde, and a aniline; a hydroxyl and sodium periodate; a thiol and an iodoacetamide; an amine and a pyridoxal phosphate; an azide and a functionalized triphenyl phosphine; a tetrazine and a strained alkene; and the like.

Examples of individual reactive handles that may be used to form the separation media of the present disclosure include Rh^{A} (hydroxyl), Rh^{B} (thiol), Rh^{C} (amine), Rh^{D} (activated ester), Rh^{E} (azide), Rh^{F} (alkyne), Rh^{G} (NHS-ester), Rh^{H} (maleimide), Rh^{L} (where X is a Cl, Br, or I leaving group attached to carbon that can undergo nucleophilic substitution; e.g., a bromoacetamide or iodoacetamide), Rh^{J} (cyclooctyne), Rh^{K} (isocyanate), Rh^{L} (isothiocyanate), Rh^{M} (where X is a Cl, Br, or I leaving group attached to carbon that can undergo nucleophilic substitution), Rh^{N} (an epoxide), Rh^{O} (an acyl chloride), R^{Q} (halotriazine where X is Cl, I, or Br and R is an organic group, H or a halogen), Rh^{R} (vinyl sulfone), and isomers thereof. Chemical structures of Rh^{A}—Rh^{R} are depicted below.

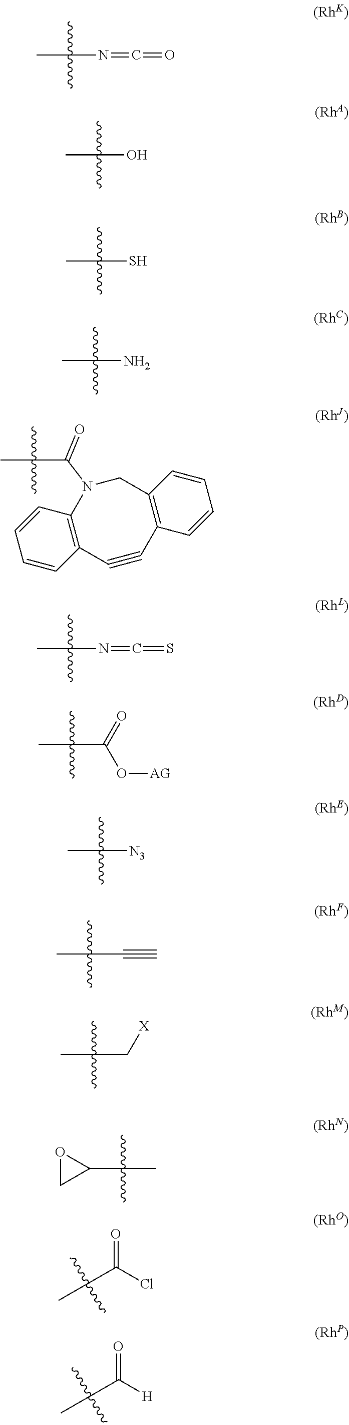

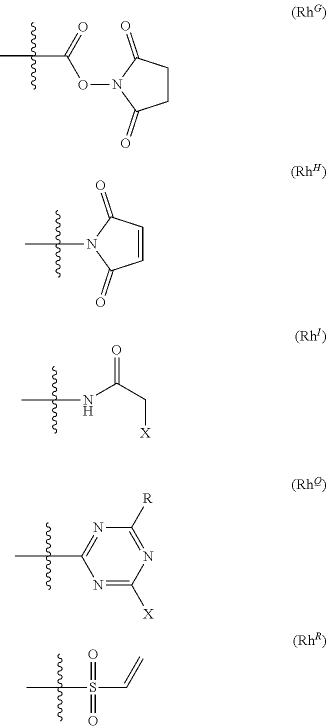

X in RhM and RhI may be -chloro, -bromo, or -iodo.

Rh^{D} is an activated ester where AG is an activating group. An activated ester is an ester that is reactive with an activated ester cooperative reaction handle (e.g., an amine) in a conjugation reaction. Activated esters may be denoted as the type of activated ester or by the activating group. Examples of activating groups include O-acylisoureas, benzotriazoles (with a bond between the ester oxygen and one nitrogen of the triazole), and pentafluorophenyl. In some embodiments, Rh^{D} may be an activated ester of a carboxylic acid. In such embodiments, the activated ester is formed through the reaction of a carboxylic acid with one or more reagents that install the activating group. For example, a carboxylic acid may be converted into an activated ester having a O-acylisoureas activating group by treating the carboxylic acid with various carbodiimide reagents (e.g., N,N′-Dicyclohexylcarbodiimide, I-ethyl-3-(3 dimethylaminopropyl)carbodiimide, diisopropylcarbodiimide (DIC)) under favorable reaction conditions. A carboxylic acid may be converted into an activated ester having a benzotriazole activating group by treating the carboxylic acid with various carbodiimide reagents followed by treatment with hydroxybenzotriazole (HOBT) or by treating the carboxylic acid with various benzotriazole containing compounds (e.g., 0-(benzotriazol-1-yl)-N,N,N′,N′-tetramethyluronium hexafluorophosphate (HBTU); O-(benzotriazol-1-yl)-N,N,N′,N′-tetramethyluronium tetrafluoroborate (TBTU); 2-(1H-benzotriazol-1-yl)-1,1,3,3-tetamethyluronium hexafluorophosphate (HBTU); beniotriazol-1-yloxy)tris(dimethylamino)phosphonium hexafluorophosphate (BOP); (benzotriazol-1-yloxy)tripyrrolidinophosphonium hexafluorophosphate (PyBOP); and O-(7-azabenzotriazol-1-yl)-N,N,N′,N′-tetramethyluronium tetrafluoroborate (TATLU) under favorable reaction conditions. Other reagents are available for making activated esters from carboxylic acids including bromotripyrrolidinophosphonium hexafluorophosphate (PyBrOP); O—(N-succinirnidyl)-1,1,3,3-tetramethyl-uronium tetrafluoroborate (TSTU); O-(5-Norbornene-2,3-dicarboximido)-N,N,N′,N′-tetramethyluronium tetrafluoroborate (TNTU); O-(1,2-Dihydro-2-oxo-1-pyridyl-N,N,N′,N′-tetramethyluronium tetrafluoroborate (TPTU); and 3-(diethylphosphoryloxy)-1,2,3-benzotriazin-4(3H)-one (DEPBT); carbonyldiimidazole. In some embodiments, the activated ester may be created in situ from a carboxylic acid and not isolated prior to a conjugation reaction.

Rh^{O} is an acyl chloride. Acyl chlorides may be prepared from carboxylic acids, for example, using thionyl chloride. Acyl chlorides may not be stable and as such, may be prepared in situ and not isolated prior to a conjugation reaction.

Reactive handles Rh^{A}, Rh^{B}, Rh^{C}, Rh^{D}, Rh^{E}, Rh^{F}, Rh^{G}, Rh^{H}, Rh^{I}, Rh^{J}, Rh^{K}, Rh^{L}, Rh^{M}, Rh^{N}, Rh^{O}, Rh^{P}, Rh^{Q}, Rh^{R} include various pairs of cooperative handles that can from the reaction products of Rp^{A}, Rp^{B}, Rp^{C}, Rp^{D}, Rp^{E}, Rp^{F}, Rp^{G}, Rp^{H}, Rp^{I}, Rp^{J}, Rp^{K}, Rp^{L} and Rp^{M}. For example, under favorable reaction conditions, a conjugation reaction between Rh^{A} and Rh^{D} forms Rp^{A} where U⁰ is O. Under favorable reaction conditions, a conjugation reaction between Rh^{D} and Rh^{C} forms Rp^{A} where U⁰ is NH. Under favorable reaction conditions, a conjugation reaction between Rh^{C} and Rh^{G} forms Rp^{A} where U⁰ is NH. Under favorable reaction conditions, a conjugation reaction between Rh^{B} and Rh^{H} forms Rp^{C} where U⁴ is S. Under favorable reaction conditions, a conjugation reaction between two Rh^{B} forms Rp^{D}. Under favorable reaction conditions, a conjugation reaction between Rh^{C} and Rh^{I} forms Rp^{H} where U⁶ is NH. Under favorable reaction conditions, a conjugation reaction between Rh^{B} and Rh^{I} forms Rp^{H} where U⁶ is S. Under favorable reaction conditions, a conjugation reaction between Rh^{M} and Rh^{B} forms Rp^{E} where U⁵ is S. Under favorable reaction conditions, a conjugation reaction between Rh^{M} and Rh^{C} forms Rp^{E} where U⁵ is NH. Under favorable reaction conditions, a conjugation reaction between Rh^{K} and Rh^{C} forms Rp^{B} where U¹ and U³ are NH and U² is O. Under favorable reaction conditions, a conjugation reaction between Rh^{L} and Rh^{C} forms Rp^{B} where U¹ and U³ are NH and U² is S. Under favorable reaction conditions, a conjugation reaction between Rh^{F} and Rh^{E} forms Rp^{F}. Under favorable reaction conditions, a conjugation reaction between Rh^{J} and Rh^{E} forms Rp^{G}. Under favorable reaction conditions, a conjugation reaction between Rh^{N} and Rh^{A} forms Rp¹ or Rp^{J} where U⁷ is O. Under favorable reaction conditions, a conjugation reaction between Rh^{N} and Rh^{B} forms Rp^{I} or Rp^{J} where U⁷ is S. Under favorable reaction conditions, a conjugation reaction between Rh^{N} and Rh^{C} forms Rp^{I} or Rp^{J} where U⁷ is N. Under favorable reaction conditions, a conjugation reaction between Rh^{O} and Rh^{A} forms Rp^{A} where U⁰ is O. Under favorable reaction conditions, a conjugation reaction between Rh^{O} and Rh^{B} forms Rp^{A} where U⁰ is NH. Under favorable reaction conditions, a conjugation reaction between Rh^{P} and Rh^{C} forms Rp^{I}. Under favorable reaction conditions, a conjugation reaction between Rh^{A} and Rh^{Q} forms Rp^{M} where U⁹ is O. Under favorable reaction conditions, a conjugation reaction between Rh^{A} and Rh^{R} forms Rp^{L} where U⁹ is O.

Conjugation reactions between cooperative handles may be done under favorable reaction conditions. Favorable reaction conditions are conditions that facilitate a reaction, increase the yield of a reaction, minimize unwanted biproducts of a reaction, and/or increase the rate of a reaction. Example reaction conditions include reaction temperature, reaction atmosphere composition, reaction solvent, the presence of a catalyst, the presence of a base, the presence of an acid, and any combination thereof. Favorable reaction conditions for conjugation reactions are known.

Cooperative handles may be chosen such that the conjugation reaction is an orthogonal conjugation reaction. Orthogonal conjugation reactions are reactions where the chemistry is selective such that only two cooperative handles react to form a reaction product even when additional reactive handles or pairs of cooperative reactive handles may be present. Orthogonal conjugation reactions may be useful because they allow for multiple selective conjugation reactions to take place in series or in parallel. Orthogonality of two or more conjugation reactions may be achieved by choosing reactive handles that are only reactive with their cooperative counterpart in the presence of other cooperative reactive handle pairs. Orthogonality of two or more conjugation reactions may also be achieved by using reactive handles that are reactive with multiple cooperative counterparts, but the reactivity can be influenced through the reaction conditions such that only a specific pair of cooperative handles will react in the given set of reaction conditions.

To form a separation ligand of formula SL1, conjugation reaction precursor compounds are employed, each precursor compound having a reactive handle that is cooperative with the reactive handle of a different precursor compound. In some embodiments, a separation ligand of formula SL1 is formed through the conjugation of a separation group precursor of formula Pre-Z(1) and a support substrate precursor of formula Pre-M(1) by way of synthetic scheme S1. The support substrate precursor includes a reactive handle Rh¹ that is covalently attached to the support substrate (shown as a thick black vertical line). The separation group precursor includes the separation group (Z) of formula SL1 and a separation group reactive handle Rh². Rh¹ and Rh² are cooperative reactive handles and may be any pair of cooperative reactive handles as disclosed herein. In scheme S1, the support substrate reactive handle (Rh¹) is reacted with the separation group reactive handle (Rh²) to form a reaction product (Rp¹) thereby forming a separation ligand of formula SL1.

In some embodiments where the separation group precursor is of an affinity group precursor, the formula of Pre-(Z1) may be Rh²-J-B where J is the intermediate group and B is the boronic acid of formula B(i) or B(ii). As such, the reactive handle of the affinity group may be extending from the intermediate group.

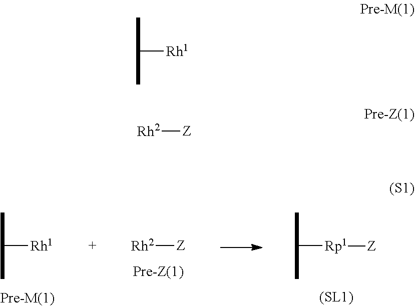

In some embodiments the material of the support substrate does not include a reactive handle that is cooperative with the separation group reactive handle (Rh²). In such embodiments, scheme S1 may further include installing the support substrate reactive handle Rh¹. The support substrate reactive handle Rh¹ may be installed through treatment of the support substrate to form Rh¹. In such embodiments, a chemical functionality already present on the support substrate is transformed into the support substrate reactive handle. For example, the support substrate may be exposed to an oxidizing or reducing reagent (or conditions). Alternatively, the support substrate reactive handle Rh¹ may be installed through the installation of a functionalized layer. In such embodiments, the functionalized layer is considered a part of the support substrate. In such embodiments, the reactive handle of functionalized layer is the support substrate reactive handle. Examples of materials suitable for a functionalized layer are discussed herein.

In some embodiments, the linker (L) is of formula L2 such that SL is of formula SL2; that is:

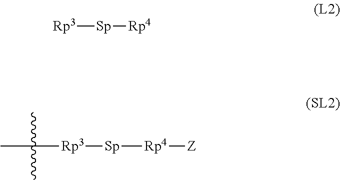

In formulas L2 and SL2, Sp is a spacer, Rp³ is a first reaction product, and Rp⁴ is a second reaction product. In formula SL2, Z is the separation group. The linker of formula L2 includes Sp, Rp³ and Rp⁴. In a separation ligand of formula SL2, a covalent bond from Rp³ to the support substrate is the point of covalent attachment of the linker (L2) to the support substrate. A covalent bond from Rp⁴ to the separation group (Z) is the point of covalent attachment of the linker (L2) to the separation group (Z). Rp³ and Rp⁴ may be any reaction product as described herein.

In the context of an affinity group that includes a boronic acid, formula SL2 may be -Rp³-Sp-Rp⁴-J-B, where J is an intermediate group and B is the boronic acid of formula B(i) or B(ii).

In some embodiments where the separation ligand is of formula SL2, Rp³, Rp⁴, or both are Rp^{A} where U⁰ is NH. In some such embodiments, the amide nitrogen (U⁰) of Rp^{A} is covalently linked to the support substrate or covalently linked to the separation group. In other such embodiments, the amide nitrogen of Rp^{A} is covalently linked to the spacer Sp.

In some embodiments where the separation ligand is of formula SL2, Rp³, Rp⁴, or both are Rp^{A} where U⁰ is O. In some such embodiments, the ester oxygen (U⁰) of Rp^{A} is covalently linked to the support substrate or covalently linked to the separation group. In other such embodiments, the ester oxygen of Rp^{A} is covalently linked to the spacer.

The spacer (Sp) of the linker (L1) may be of any length and/or chemical composition that does not completely inhibit the formation of Rp³ and Rp⁴. The spacer (Sp) may be of any length and/or chemical composition that does not completely inhibit the ability of the affinity group to bind to its intended target.

The spacer (Sp) includes a divalent organic group. The divalent organic group includes a backbone. The “backbone” is the longest contiguous chain of atoms within the spacer (Sp). In some embodiments, the backbone is a carbon-based backbone. A backbone that is carbon-based is a backbone that has a greater number of carbon atoms than heteroatoms in the backbone. The backbone may include one or more substitutions extending from the backbone and/or one or more functional groups catenated within the backbone.

In some embodiments, the backbone is an alkanediyl (divalent group that is a radical of an alkane) or an alkenediyl (divalent group that is a radical of an alkene). The alkanediyl or alkenediyl may have a backbone chain length of C1 to C18, C1 to C10, C1 to C6, C1 to C4, C1 to C3, or C2 to C4. An alkenediyl may have one or more double bonds. The one or more double bonds may be located at any point along the backbone.

In some embodiments, the backbone includes one or more catenated functional groups. Catenated functional groups have at least one atom that is a part of the backbone; that is, at least one atom of the functional group lies within the backbone chain. The at least one atom of the functional group that is a part of the backbone can be a carbon or a heteroatom. For example, in some embodiments, the backbone includes a catenated ketone where the carbon atom of the carbonyl of the ketone is a part of the backbone. In other embodiments, the backbone includes a catenated amide. In some such embodiments, the nitrogen of the catenated amide is a part of the backbone and the carbon of the carbonyl is not a part of the backbone. In other such embodiments, the nitrogen and the carbonyl carbon of the amide are both a part of the backbone. Example catenated functional groups include, ethers; thioether; esters (where the ester oxygen atom is a part of the backbone, or where the ester oxygen and the carbonyl carbon are a part of the backbone); thioesters (where the thioester sulfur atom is a part of the backbone, or where the thioester sulfur atom and the carbonyl carbon are a part of the backbone); amides (where the amide nitrogen is a part of the backbone, or where the amide nitrogen and the carbonyl carbon are a part of the backbone); ureas (where one of the urea nitrogens is a part of the backbone, or where both of the urea nitrogens and the carbonyl carbon are a part of the backbone); carbamates (where the carbamate oxygen is a part of the backbone; the carbamate nitrogen is a part of the backbone; or the carbamate oxygen, the carbamate nitrogen, and the carbonyl carbon are a part of the backbone); thioureas (where one of the urea nitrogens is a part of the backbone, or where both of the urea nitrogens and the carbonyl carbon are a part of the backbone); secondary and tertiary amines; aromatic rings (where at least two atoms of the aromatic ring are a part of the backbone); and any combination thereof.

In some embodiments the spacer includes a catenated ether (i.e., a catenated oxygen atom). In some such embodiments, the backbone includes a polyethylene glycol chain of 1, 2, 3, 4, 5, 6, 7, 8, 9, or 10 —OCH₂CH₂— repeat units. In some embodiments, the spacer includes a catenated ketone. In some such embodiments, the spacer is of the formula —(CO)— (i.e., the backbone is a C1 alkenediyl and the C1 is the carbonyl carbon of the catenated ketone).

In some embodiments where the separation ligand is of formula SL2, Rp3 and Rp4 are both RpE where each U5 is independently O, NH, or S. In some embodiments, the U5 of Rp3 is O and the U5 of Rp4 is O. In some embodiments, the U5 of Rp3 is NH and the U5 of Rp4 is NH. In some embodiments, the U5 of Rp3 is O and the U5 of Rp4 is NH. In some embodiments, the U5 of Rp3 is NH and the U5 of Rp4 are O.

In some embodiments where Rp3 and Rp4 are both RpE, Sp may be —C(O)—. In some such embodiments, L2 may be described as RpB. In some embodiments were L2 is RpB, U2 is 0. In some embodiments were L2 is RpB, U1 is O. In some embodiments were L2 is RpB, U3 is 0. In some embodiments were L2 is RpB, U1 is NH. In some embodiments were L2 is RpB, U3 is NH. In some embodiments were L2 is RpB, U1 is O, U2 is O, and U3 is NH. In some embodiments were L2 is RpB, U1 is NH, U2 is O, and U3 is O.

In some embodiments where the separation ligand is of formula SL2, Rp3 is RpE and Rp4 is RpI or RpJ where U5 and U7 are each independently O, NH, or S. In some embodiments U5 is NH and U7 is NH. In some embodiments U5 is O and U7 is O. In some embodiments U5 is NH and U7 is O. In some embodiments U5 is O and U7 is NH.

In some embodiments where Rp3 and Rp4 are both RpE, Sp may be —(CH2)n- where n is 0, 1, 2, 3, 4, 5, 6, 7, 8, 9, or 10. In some such embodiments, L2 is of the formula

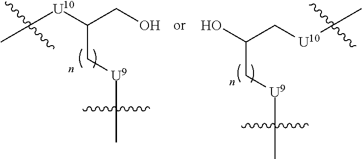

where U⁹ and U¹⁰ are each independently O, NH, or S and n is 0, 1, 2, 3, 4, 5, 6, 7, 8, 9, or 10. U9 may be U5 from RpI and U10 may be U7 from RpJ. In some embodiments U9 is NH and U10 is NH. In some embodiments U9 is O and U10 is 0. In some embodiments U9 is NH and U10 is O. In some embodiments U9 is O and U10 is NH.

In some embodiments, a separation ligand of formula SL is of formula

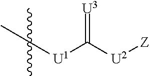

where U¹, U², and U³ are each independently O, NH, or S and Z is a separation group. For example, in some embodiments, a separation ligand of formula SL is

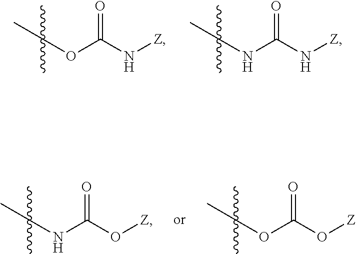

where Z is a separation group. In some embodiments, Z is an affinity group.

In some embodiments, a separation ligand of formula SL is of formula

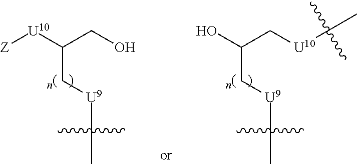

U⁹ and U¹⁰ are each independently O, NH, or S where Z is a separation group. In some embodiments, SL is

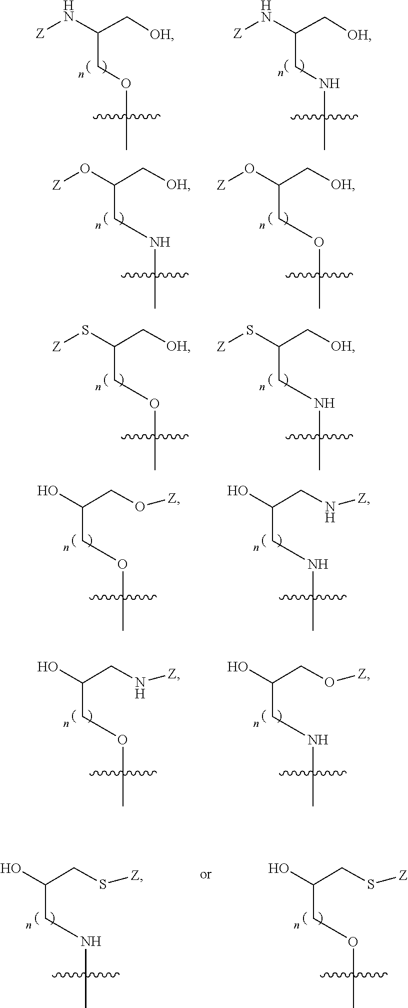

where Z is a separation group and n is 0, 1, 2, 3, 4, 5, 6, 7, 8, 9, or 10. In some embodiments Z is an affinity group.

To form a separation ligand of formula SL2, a series of conjugation reaction precursor compounds are employed, each precursor compound having a reactive handle that is cooperative with the reactive handle of a different precursor compound. In some embodiments, a separation media of formula SL2 is formed through the conjugation of a linker precursor of formula Pre-L, an affinity group precursor of formula Pre-Z(2), and a support substrate precursor of formula Pre-M(2). The linker precursor (Pre-L) includes the spacer Sp of the separation media of formula SL2, a first linker reactive handle Rh³, and a second linker reactive handle Rh⁴. The support substrate precursor (Pre-M(2)) includes a support substrate (vertical black line) and a support substrate reactive handle Rh⁵. The separation group precursor (Pre-Z(2)) includes the separation group Z of formula SL2 and a separation group reactive handle Rh⁶.

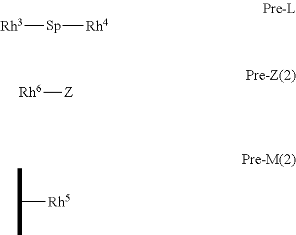

Rh³ and Rh⁵ are a pair of cooperative reactive handles. Rh⁴ and Rh⁶ are a pair of cooperative reactive handles. Rh³ of the linker precursor reacts with Rh⁵ of the support substrate precursor in a conjugation reaction to from a reaction product (i.e., Rp³ of formula SL2). Rh⁴ of the linker precursor reacts with Rh⁶ of the separation group precursor in a conjugation reaction to from a reaction product (i.e., Rp⁴ of formula SL2).

Because the linker precursor includes two reactive handles, the linker precursor is a bifunctional precursor linker. In some embodiments, the linker precursor may be a multifunctional linker precursor that has three or more reactive handles. At least one of the reactive handles is configured to react with the support substrate precursor. The additional reactive handles may be configured to react with a cooperative reactive handle on one or more separation groups. Examples, of bifunctional and multifunctional linker precursors include, epichlorohydrin, diglycidyl ether, triglycidyl ether, tetraglycidyl ether, triazine, poly triazine, poly acrylic (e.g., the COOH groups can be made into activated ester reactive handles), succinic acid (e.g., the COOH groups can be made into activated ester reactive handles), and N′N′-disuccinimidyl carbonate (DSC).

In some embodiments, a separation ligand of formula SL2 may be formed through two conjugation reactions. The reactions may be conducted in any order or simultaneously. For example, in some embodiments, a separation ligand of formula SL2 is formed by way of synthetic scheme 2 (S2).

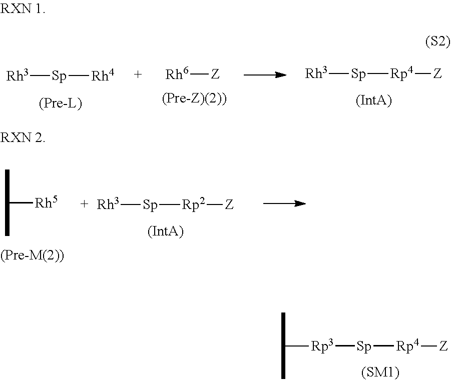

In a first conjugation reaction of scheme S2 (RXN1), the separation group reactive handle (Rh⁶) is reacted with a first linker reactive handle (Rh⁴) in a first conjugation reaction to from a first reaction product Rp⁴ thereby resulting in intermediate A (IntA). Intermediate A is a linker-separation group conjugate that includes the first reaction product (Rp⁴) and the second linker reactive handle (Rh³). IntA may be isolated or taken forward to the second conjugation reaction without isolation. In a second conjugation reaction of S2 (RXN 2) the second linker reactive handle (Rh³) of IntA is reacted with the support substrate reactive handle (Rh⁵) to form a second reaction product (Rp³), thereby forming a separation ligand of formula SL2.

In some embodiments, a separation ligand of formula SL2 is formed by way of synthetic scheme 3 (S3).

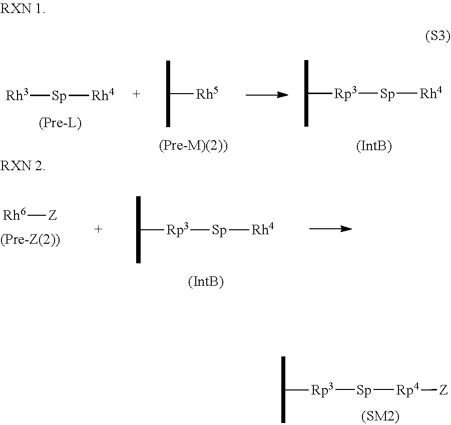

In a first conjugation reaction of scheme S3 (RXN1), the support substrate reactive handle (Rh⁵) is reacted with a first linker reactive handle (Rh³) in a first conjugation reaction to from a first reaction product (Rp³) thereby resulting in intermediate B (IntB). Intermediate B is a linker-support substrate conjugate that includes the first reaction product (Rp³) and the second linker reactive handle (Rh⁴). IntB may be isolated or taken forward to the second conjugation reaction without isolation. In a second conjugation reaction of S3 (RXN 2) the second linker reactive handle (Rh⁴) of IntB is reacted with the separation group reactive handle (Rh⁶) to form a second reaction product (Rp⁴), thereby forming a separation ligand of formula SL2.

Synthetic scheme S4 and synthetic scheme S5 are examples of forming a separation ligand of formula SL2 through scheme S3 using the bifunctional linker (Pre-L) N,N′-disuccinimidyl carbonate (S3) or epichlorohydrin (S4). In both S4 and S5, R10 can be OH, NH2, or SH and R11 can be O, NH, or S depending on the identity of R10.

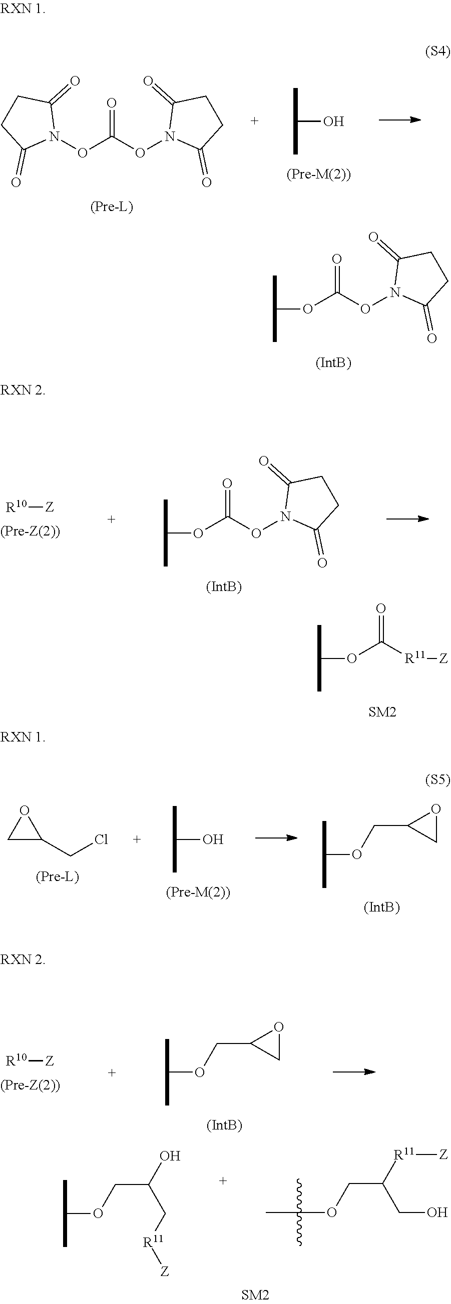

The present disclosure provides methods of making the separation media of the present disclosure. The separation media may be any separation media as disclosed herein. The separation media may be made methods described in PCT application number PCT/US2019/065805 (WO2020123714A1, Zhou), which is incorporated by reference in its entirety.

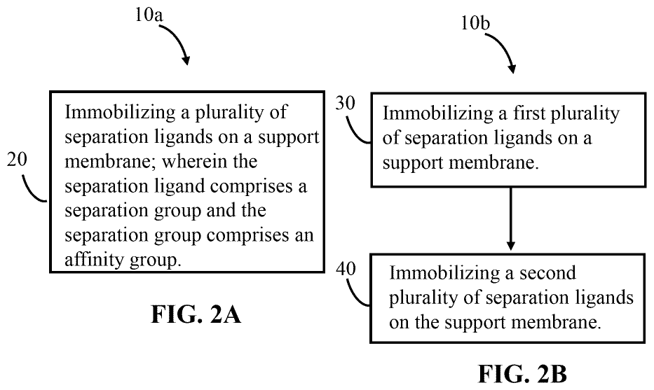

FIG. 2A is a flow diagram depicting a general method 10a for making a separation media of the present disclosure. The general method 10a includes immobilizing a plurality of separation ligands on a support substrate (step 20). Each separation ligand includes a separation group and a linker. The separation media may be of formula SLim. The separation group includes the affinity group. Each separation ligand may be of formula SM, SM1, or SM2. Each separation ligand can be immobilized according to any relevant synthetic scheme described herein (e.g., S1, S2, S3, S4, or S5).

In some embodiments, the separation media includes a first plurality of separation ligands immobilized on the support substrate and a second plurality of separation ligands immobilized on the support substrate. FIG. 2B is a flow diagram depicting a general method 10b for making a separation media of the present disclosure that includes at least two pluralities of separation ligands. Each plurality of separation ligands immobilized on a support substrate may be of formula SLim. Each separation ligand of the first plurality of separation ligands and the second plurality of separation ligands includes a separation group and a linker. Each separation ligand of the first plurality of separation ligands and the second plurality of separation ligands may be of formula SM, SM1, or SM2. Each separation ligand of the first plurality of separation ligands and the second plurality of separation ligands can be immobilized according to any relevant synthetic scheme described herein (e.g., S1, S2, S3, S4, or S5).

The method 10b includes immobilizing the first plurality of separation ligands on a support substrate (step 30). The method 10b further includes immobilizing the second plurality of separation ligands on the support substrate (step 40).

In some embodiments of method 10b, the first plurality of separation ligands includes an assistance group, and the second plurality of separation ligands includes an affinity group. Without wishing to be bound by theory, it is thought that the assistance groups of the first plurality of separation ligands can interact with (e.g., via electrostatics and/or hydrophobic or hydrophilic interactions) with the affinity group of the separation group precursor used to form the second plurality of separation ligands. Through these interactions, the second separation group precursors may concentrate on the surface of the support substrate thereby increasing conjugation reaction efficiency (e.g., speed and/or yield). An increase in reaction efficiency may allow a lower concentration of the second plurality of the second separation group precursors to be used in the reaction step than would be needed to achieve the same reaction yield and/or surface coverage without the use of assistance groups. In some embodiments, the assistance group includes an amine. In such embodiments where separation ligands that include an amine assistance group are immobilized prior to immobilization of separation ligands containing affinity groups, the method is amine assisted.

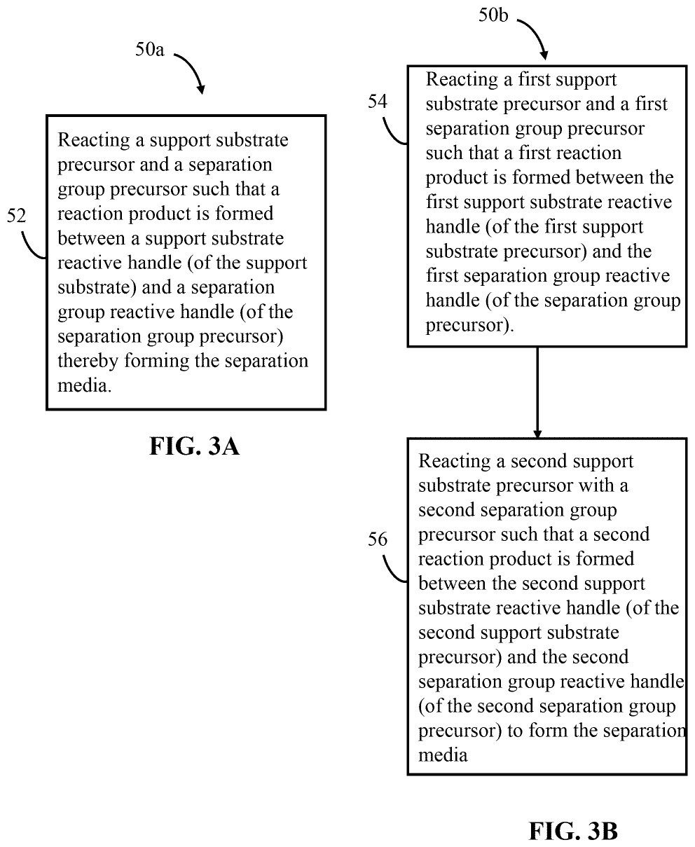

In some embodiments, method 10a or 10b may include method 50a. FIG. 3A is a flow diagram outlining method 50a for making a separation media including a separation ligand of the present disclosure. Method 50a may be understood in reference to synthetic scheme S1 as described herein; however, it is understood that method 50a is not limited to the synthetic scheme S1. The separation ligand of the separation media made from method 50a is synthesized from two components, a separation group precursor (e.g., Pre-Z(1)) and a support substrate precursor (e.g., Pre-M(1)). The separation group precursor includes the separation group (Z) and a separation group reactive handle (Rh²). The support substrate precursor includes a support substrate (thick vertical black line) and a support substrate reactive handle (Rh¹). The separation group reactive handle and the support substrate reactive handle are cooperative handles. Method 50a includes reacting a support substrate precursor and a separation group precursor such that a reaction product (e.g., Rp¹) is formed between the support substrate reactive handle (of the support substrate precursor) and the separation group reactive handle (of the separation group precursor) thereby forming the separation media (e.g., the immobilized separation ligand of Formula SLim).

In some embodiments, step 52 may be accomplished using a reaction mixture. The reaction mixture includes a solvent and the separation group precursor. The reaction mixture may be applied to the support substrate, or the support substrate may be submerged in the reaction mixture. The solvent may include an organic solvent, water, or both. In some embodiments, the solvent is an aqueous buffer that includes one or more salts and/or buffering agents as disclosed herein. The reaction mixture may include additional compounds that facilitate the reaction. For example, the reaction mixture may include an acid, a base, an initiator, a catalyst, or any combination thereof.

In some embodiments where the solvent includes an organic solvent, the reaction step is considered to be “organic assisted” or “organic solvent assisted.” In an organic assisted method, the solvent of the reaction mixture includes water and at least one water-miscible organic solvent. Examples of water-miscible organic solvents include ethanol, acetone, acetonitrile, methanol, propanol (e.g., 2-propanol, 1-propanol), 2-butanol, tetrahydrofuran, dimethylformamide, and dimethyl sulfoxide. The ratio of water to organic solvent in the reaction mixture is such that the reaction mixture is at or near the cloud point of the mixture. The cloud point is the point at which a liquid solution undergoes a liquid-liquid phase separation to from an emulsion or a liquid-solid phase transition to form a stable suspension or a precipitate. The cloud point can be visualized by observing the water-to-organic solvent ratio at which the reaction mixture becomes turbid. Without wishing to be bound by theory, it is thought that including an organic solvent in the reaction mixture such that the reaction mixture is at or near the cloud point increases the conjugation reaction efficiency. The organic solvent molecule can displace water molecules in the separation group precursor thereby increasing interactions between the separation group precursor and the support substrate.

It is possible to define a range of appropriate amounts of organic solvent in the reaction mixture in which the upper boundary is expressed by [V % cp+a(100%−V % cp)] and the lower boundary is expressed by [V % cp−bV % cp], where “V % cp” is the percent by volume of the organic solvent in the reaction mixture at the cloud point, “a” is the upper deviation from the cloud point, and “b” is the lower deviation from the cloud point. For the purpose of an example, if the percent by volume of the organic solvent in the ligand solution at the cloud point (V % cp) is 60%, and the upper and lower boundaries are defined by a=0.3 and b=0.5, then the corresponding appropriate amounts of organic solvent in the reaction mixture would range from 30% to 72% organic solvent by volume. In embodiments, the reaction mixture can include an amount of organic solvent in which “a” is about 0.01, 0.02, 0.03, 0.04, 0.05, 0.06, 0.07, 0.08, 0.09, 0.1, 0.12, 0.14, 0.16, 0.18, 0.2, 0.25, 0.3, 0.4, 0.5, 0.6, 0.7, 0.8, 0.9, 0.99 and “b” is about 0.01, 0.02, 0.03, 0.04, 0.05, 0.06, 0.07, 0.08, 0.09, 0.1, 0.12, 0.14, 0.16, 0.18, 0.2, 0.25, 0.3, 0.4, 0.5, 0.6, 0.7, 0.8, 0.9, 0.99. In some embodiments, the reaction mixture includes an amount of organic solvent ranging from 70% to 130%, 80% to 120%, 90% to 110%, or 95% to 105% of the volumetric amount of the organic solvent at the cloud point of the reaction mixture.

In some embodiments where the reaction mixture is aqueous and includes one or more salts, the reaction step may be kosmotropic salt assisted. In a kosmotropic salt assisted method, the reaction mixture includes water and at least one kosmotropic salt at a concentration such that the reaction mixture is at or near its cloud point. Examples of kosmotropic salts include sodium phosphate, sodium sulfate, and ammonium sulfate. Without wishing to be bound by theory, it is thought that including a kosmotropic salt in the reaction mixture such that the reaction mixture is at or near the cloud point increases the conjugation reaction efficiency. The salt molecules can disrupt the solvation shell of separation group precursors thereby increasing interactions between the separation group precursor and the support substrate. In some embodiments, the separation media includes a first plurality of separation ligands immobilized on the support substrate and a second plurality of separation ligands immobilized on the support substrate. In some such embodiments, method 50b may be used to prepare the separation media. FIG. 3B is a flow diagram outlining method 50b for making a separation media that includes multiple pluralities of separation ligands immobilized to the support substrate. The first plurality of separation ligands synthesized according to method 50b are made from two components a first support substrate reactive precursor and a first separation group precursor. The second plurality of separation ligands synthesized according to method 50b are made from two components a second support substrate reactive precursor and a second separation group precursor. The first support substrate precursor includes the first support substrate reactive handle. The second support substrate precursor includes a second support substrate reactive handle. The first support substrate reactive handle and the second support substrate reactive handle may be the same or different. The first separation group precursor includes a separation group and a first separation group reactive handle. The second separation group precursor includes a separation group and the second separation group reactive handle. The first support substrate reactive handle and the first separation group reactive handle are cooperative reactive handles. The second support substrate reactive handle and second separation group reactive handle are cooperative handles.

Method 50b includes reacting the first support substrate precursor and the first separation group precursor such that a first reaction product is formed between the first support substrate reactive handle (of the first support substrate precursor) and the first separation group reactive handle (of the first separation group precursor). The method further includes reacting the second support substrate precursor with the second separation group precursor such that a second reaction product is formed between the second support substrate reactive handle (of the second support substrate precursor) and the second separation group reactive handle (of the second separation group precursor).

In some embodiments, the first separation group precursor includes an amine, and the entire method (50b) is amine assisted.

In some embodiments, step 54, step 56, or both are organic solvent assisted or kosmotropic salt assisted. For example, step 54 may be accomplished with a first reaction mixture that includes the first separation group precursor, water, and an organic solvent that is miscible with water or a kosmotropic salt. Step 56 may be accomplished with a second reaction mixture. The second reaction mixture includes the second separation group precursor water and an organic solvent that is miscible with water or at least one kosmotropic salt.

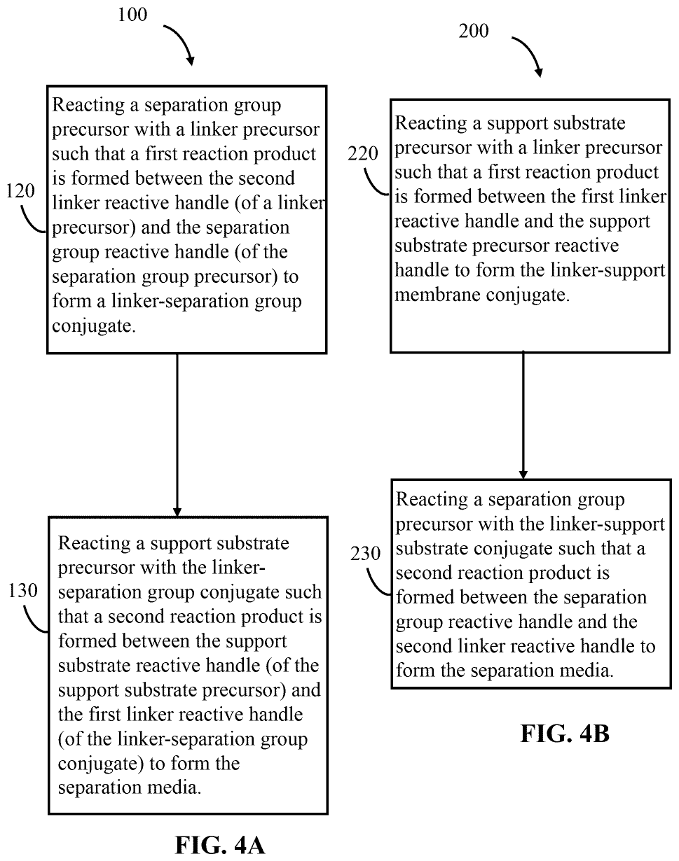

In some embodiments, method 10a, 10b, 50a, or 50b may include method 100. FIG. 4A is a flow diagram outlining method 100. Method 100 may be understood in reference to synthetic scheme S2 as described herein; however, it is understood that the method of 100 is not limited to the synthetic scheme S2. The separation ligands of the separation media made according to method 100 are synthesized from three components, a linker precursor (e.g., Pre-L), a support substrate precursor (e.g., Pre-M(2)), and a separation group precursor (e.g., Pre-Z(2)). The linker precursor includes a first linker reactive handle (Rh³), a second linker reactive handle (Rh⁴), and a spacer (Sp) that covalently links the first linker reactive handle and the second linker reactive handle. The separation group precursor includes a separation group (Z) and a separation group reactive handle (Rh⁶). The support substrate precursor includes a support substrate (thick vertical black line) and a support substrate reactive handle (Rh⁵). The second linker reactive handle (Rh⁴) and the separation group reactive handle (Rh⁶) are cooperative reactive handles. The first linker reactive handle (Rh³) and the support substrate reactive handle (Rh⁵) are cooperative reactive handles.

The method 100 includes reacting the separation group precursor with the linker precursor such that a first reaction product is formed between the second linker reactive handle (of a linker precursor) and the separation group reactive handle (of the separation group precursor) to form a linker-separation group conjugate (step 120). Method 100 further includes reacting the support substrate precursor with the linker-separation group conjugate of step 120 such that a second reaction product is formed between the support substrate reactive handle (of the support substrate precursor) and the first linker reactive handle (of the linker-separation group conjugate) to form the separation media (step 130).

In some embodiments, method 10a, 10b, 50a, or 50b may include the method 200. FIG. 4B is a flow diagram outlining method 200. The method 200 may be understood in reference to synthetic scheme S3 as described herein; however, it is understood that the method of 200 is not limited to the synthetic scheme S3. The separation ligand made according to method 200 is synthesized from three components, a linker precursor (e.g., Pre-L), a support substrate precursor (e.g., Pre-M(2)), and a separation group precursor (e.g., Pre-Z(2)). The linker precursor includes a first linker reactive handle (Rh³), a second linker reactive handle (Rh⁴), and a spacer (Sp) that covalently links the first linker reactive handle and the second linker reactive handle. The separation group precursor includes a separation group (Z) and a separation group reactive handle (Rh⁶). The support substrate precursor includes a support substrate (thick vertical black line) and a support substrate reactive handle (Rh⁵). The second linker reactive handle (Rh⁴) and the separation group reactive handle (Rh⁶) are cooperative reactive handles. The first linker reactive handle (Rh³) and the support substrate reactive handle (Rh⁵) are cooperative reactive handles.

Method 200 includes reacting a support substrate precursor with a linker precursor such that a first reaction product is formed between the first linker reactive handle and the support substrate precursor reactive handle to form the linker-support substrate conjugate. Method 200 further includes reacting a separation group precursor with the linker-support substrate conjugate such that a second reaction product is formed between the separation group reactive handle and the second linker reactive handle to form the separation media.

Any step of method 100 or method 200 may be organic solvent assisted or kosmotropic salt assisted.

In some embodiments, methods 10a, 10b, 50a, 50b, 100, and 200 further include functionalizing the support substrate to install the support substrate reactive handles. Installing the support substrate reactive handles followed by one or more conjugation reactions to immobilize the separation ligands to the reactive handles is called indirect immobilization. In such embodiments, the method may further include depositing a polymer having reactive handles onto the support substrate. In some embodiments, the polymer is deposited such that is grafted onto the support substrate. In other embodiments, the polymer is deposited such that it is grafted from the support substrate. In embodiments where the polymer is grafted from the support substrate, the method may further include coupling an initiator to the support substrate to form an immobilized initiator. In such embodiments, the method may further include polymerizing a plurality of monomers from the immobilized initiator.

In some embodiments, the support substrate reactive handle is already a part of the support substrate and not from a deposited functional layer. In such embodiments, the separation ligands are immobilized directly to the support substrate in a process called direct immobilization. Any of the methods 10a, 10b, 50a, 50b, 100, and 200 may include direct immobilization.

Direct and indirect immobilization may be accomplished using the amine assisted method, without amine assistance groups (not amine assisted), using the organic solvent assistance method, not using the organic solvent assistance method, using the kosmotropic assisted method, not using the kosmotropic salt assisted method, or any combination thereof.

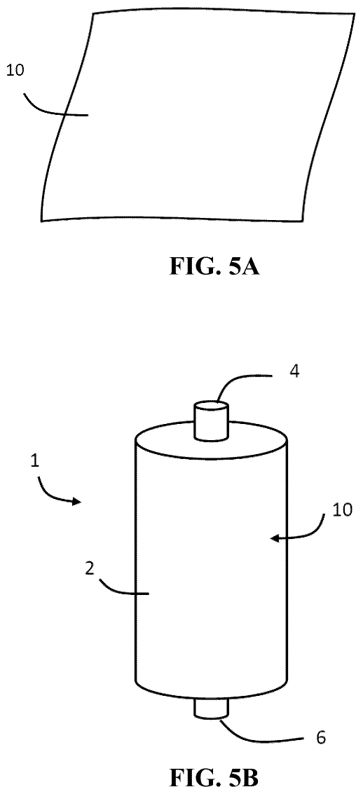

The separation media of the present disclosure may be employed in a separation device. A separation device may be a membrane chromatography column, a membrane chromatography cassette, or other membrane chromatography device that includes the separation media of the present disclosure. A separation device may be operated manually or integrated with software, pumps, detectors, and/or other accessories. The separation media 10 is schematically shown as a membrane in FIG. 5A. The separation media membrane 10 may be provided in a separation device 1 (e.g., a chromatography column), shown in FIG. 5B. The separation device 1 includes a housing 2 with an inlet 4 and an outlet 6 to facilitate flow through the device.

In some embodiments, two or more separation media of the present disclosure may be arranged in a stacked configuration. The stacked configuration may be employed in a separation device. In some embodiments, a first separation media and a second separation media are arranged in a stacked configuration. In some embodiments, the first separation media and the second separation media have the same identity; that is, the separation media have the same support substrate and the same separation ligands immobilized on the substrate. The separation ligands are immobilized at the same or similar separation ligand densities. In other embodiments, the first separation media and the second separation media have different identities. For example, the first separation media and the second separation media have a different support substrate; different separation ligands; different separation group densities; or any combination thereof.

The separation device (e.g., membrane chromatography column, membrane chromatography cassette, or other membrane chromatography device) may provide a residence time of 5 minutes or less, 2 minutes or less, 1 minute or less, 30 seconds or less, 10 seconds or less, 6 seconds or less, 5 seconds or less, 4 seconds or less, 3 seconds or less, 2 seconds or less, or 1 second or less. The separation device (e.g., membrane chromatography column, membrane chromatography cassette, or other membrane chromatography device) may provide a residence time of 0.01 seconds or greater, 0.1 seconds or greater, 1 second or greater, 5 seconds or greater, 6 seconds or greater, 10 seconds or greater, 30 seconds or greater, 1 minute or greater, or 2 minutes or greater. Residence time is the time any normalized amount of fluid takes to traverse the separation media of the separation device (a single separation media or multiple separation media). For example, residence time is the time it takes any molecule that is not the target and/or does not bind to the separation media to traverse the separation media in a separation device. Residence time is calculated as the flow rate or the solution going through the column divided by the total bed volume of all of the separation media included in the separation device. The residence times of the separation devices of the present disclosure may be lower than those of separation media made of resins. According to an embodiment, using membrane-based purification devices can significantly improve productivity.

In some embodiments, two or more separation media of the present disclosure may be arranged in a stacked configuration. The stacked configuration may be employed in a separation device. In some embodiments, a first separation media and a second separation media are arranged in a stacked configuration. In some embodiments, the first separation media and the second separation media have the same identity; that is, the separation media have the same support substrate and the same separation ligands immobilized on the substrate. The separation ligands are immobilized at the same or similar separation ligand densities. In other embodiments, the first separation media and the second separation media have different identities. For example, the first separation media and the second separation media have a different support substrate; different separation ligands; different separation group densities; or any combination thereof.

Process productivity can be defined using the equation below. In the denominator, Vₜₒₜ is the total volume of solution passing through the separation media (e.g., column or cassette) during the whole process, including load (the volume of the isolation solution discussed herein), rinse (e.g., the volume of the washing solution as discussed herein), elution (e.g., the volume of the elution solution as discussed herein), and regeneration steps (e.g., the volume of the regeneration solution as discussed herein). BV is the chromatography medium bed volume (corresponding to the volume of the separation media), and tau is residence time. Loading volume is proportional to dynamic binding capacity of the chromatography column medium. Thus, process productivity increases with increasing binding capacity and decreasing residence time.

$$Productivity = \frac{target}{Cost of time} = \frac{Loading volume \times target \times yield}{( \frac{{V}_{tot}}{B V} ) \times τ}$$

Dynamic binding capacity generally refers to the concentration of bound target on the separation media (milligram bound per unit bed volume of separation media) at breakthrough in the effluent. A dynamic binding capacity at 10% breakthrough (DBC_{10%}) can be determined via a standard chromatography method, e.g., using Cytiva AKTA pure Fast Protein Liquid chromatography (FPLC). First, the separation media is packed into a housing unit. Then, the contained separation media is connected to an FPLC system. Next, feed material (e.g., isolation solution) containing the target is passed though the separation media under certain column volumes per minute flowrate (CV/min) until the effluent concentration of the target reaches 10% of the feed concentration, as determined by a detector (e.g., a UV detector). At the end, based on the holdup volume in the FPLC system and separation media volume, the DBC_{10%} is calculated as follows ((Volume to 10% breakthrough-holdup volume)×(feed concentration))/(volume of separation media)=DBC_{10%} expressed as mg target material/unit volume separation media. The volume of the separation media is determined by the surface area of the separation media multiplied by the thickness of the separation media. The volume of the separation media can be referred to as the bed volume. In general, the volume of the separation media does not account for the void space within the separation media. The holdup volume is the total volume between the injection port (i.e., the location where a fluid enters the system) and the detector. The holdup volume includes the bed volume (e.g., the separation media volume) as well as any volume between the injection port and the bed and any volume between the bed and the detector.

In some embodiments, a separation media or separation device containing the same has a dynamic binding capacity at 10% breakthrough of 0.01 milligrams of target per 1 mL bed volume (mg/mL bed volume) or greater, 0.1 mg/mL bed volume or greater, 1 mg/mL bed volume or greater, 5 milligrams of target per 1 mL of separation media (mg/mL bed volume) or greater, 10 mg/mL bed volume or greater, 20 mg/mL bed volume or greater, 25 mg/mL bed volume or greater, 30 mg/mL bed volume or greater, 35 mg/mL bed volume or greater, 40 mg/mL bed volume or greater, 45 mg/mL bed volume or greater, 50 mg/mL bed volume or greater, 60 mg/mL bed volume or greater, 70 mg/mL bed volume or greater, 80 mg/mL bed volume or greater, 90 mg/mL bed volume or greater, 100 mg/mL bed volume or greater, or 120 mg/mL bed volume or greater. In some embodiments, a separation media has a dynamic binding capacity at 10% breakthrough of 150 mg/mL bed volume or less, 120 mg/mL bed volume or less 100 mg/mL bed volume or less, 90 mg/mL bed volume or less, 80 mg/mL bed volume or less, 70 mg/mL bed volume or less, 60 mg/mL bed volume or less, 50 mg/mL bed volume or less, 40 mg/mL bed volume or less, 35 mg/mL bed volume or less, 30 mg/mL bed volume or less, 25 mg/mL bed volume or less, 20 mg/mL bed volume or less, 10 mg/mL bed volume or less, 5 mg/mL bed volume or less, 1 mg/mL bed volume or less, or 0.1 mg/mL bed volume or less. In some embodiments, a separation media or separation device containing the same has a dynamic binding capacity at 10% breakthrough of 0.01 mg/mL bed volume to 150 mg/mL bed volume, 0.01 mg/mL bed volume to 120 mg/mL bed volume, 0.01 mg/mL bed volume to 100 mg/mL bed volume, 0.01 mg/mL bed volume to 10 mg/mL bed volume, 0.01 mg/mL bed volume to 5 mg/mL bed volume, 0.01 mg/mL bed volume to 1 mg/mL bed volume, 0.1 mg/mL bed volume to 150 mg/mL bed volume, 0.1 mg/mL bed volume to 120 mg/mL bed volume, 0.1 mg/mL bed volume to 100 mg/mL bed volume, 0.1 mg/mL bed volume to 10 mg/mL bed volume, 0.1 mg/mL bed volume to 5 mg/mL bed volume, 0.1 mg/mL bed volume to 1 mg/mL bed volume, 1 mg/mL bed volume to 150 mg/mL bed volume, 1 mg/mL bed volume to 120 mg/mL bed volume, 1 mg/mL bed volume to 100 mg/mL bed volume, 5 mg/mL bed volume to 150 mg/mL bed volume, 5 mg/mL bed volume to 120 mg/mL bed volume, 5 mg/mL bed volume to 100 mg/mL bed volume, 10 mg/mL bed volume to 150 mg/mL bed volume, 10 mg/mL bed volume to 120 mg/mL bed volume, 10 mg/mL bed volume to 100 mg/mL bed volume, 10 mg/mL bed volume to 90 mg/mL bed volume, 10 mg/mL bed volume to 80 mg/mL bed volume, 10 mg/mL bed volume to 70 mg/mL bed volume, 10 mg/mL bed volume to 60 mg/mL bed volume, 10 mg/mL bed volume to 50 mg/mL bed volume, 10 mg/mL bed volume to 40 mg/mL bed volume, 15 mg/mL bed volume to 60 mg/mL bed volume, 15 mg/mL bed volume to 50 mg/mL bed volume, 20 mg/mL bed volume to 80 mg/mL bed volume, 20 mg/mL bed volume to 70 mg/mL bed volume, 20 mg/mL bed volume to 60 mg/mL bed volume, 20 mg/mL bed volume to 50 mg/mL bed volume, 30 mg/mL bed volume to 80 mg/mL bed volume, 30 mg/mL bed volume to 70 mg/mL bed volume, 30 mg/mL bed volume to 60 mg/mL bed volume, or 30 mg/mL bed volume to 50 mg/mL bed volume. The dynamic binding capacity may depend at least in part on the target and the affinity group.

The separation media of the present disclosure may have a variety of static binding capacities (SBC). The static binding capacity is the amount of target bound to the separation media per volume of the separation media. The static binding capacity can be determined, for example, by incubating the separation media with an isolation solution containing a known amount of the target ligand for a period of time. Following incubation, the amount of the target still in the isolation solution (target not bound to the separation media) can be measured. The static binding capacity can then be calculated as the difference between the initial amount of the target in the isolation solution and the amount of target in the isolation solution following incubation with the separation media. The amount of the target in the isolation solution pre- and post-incubation with the separation media can be determined, for example, using spectroscopy and/or high performance liquid chromatography.

The static binding capacity may be higher than the dynamic binding capacity at 10% breakthrough. For example, in some embodiments, the SBC can be 10% to 40% greater than the DBC_{10%}. The pore size of the support substrate may influence the SBC and DBC_{10%}. For example, smaller pore sizes may cause a greater difference between the SBC and the DBC_{10%} as compared to relatively larger pore sizes. In some embodiments, a separation media or separation device containing the same has a static binding capacity of 0.01 milligrams of target per 1 mL of bed volume (mg/mL bed volume) or greater, 0.1 mg/mL bed volume or greater, 1 mg/mL bed volume or greater, 5 milligrams of target per 1 mL of separation media (mg/mL bed volume) or greater, 10 mg/mL bed volume or greater, 20 mg/mL bed volume or greater, 25 mg/mL bed volume or greater, 30 mg/mL bed volume or greater, 35 mg/mL bed volume or greater, 40 mg/mL bed volume or greater, 45 mg/mL bed volume or greater, 50 mg/mL bed volume or greater, 60 mg/mL bed volume or greater, 70 mg/mL bed volume or greater, 80 mg/mL bed volume or greater, 90 mg/mL bed volume or greater, 100 mg/mL bed volume or greater, or 120 mg/mL bed volume or greater. In some embodiments, a separation media or separation device containing the same has a static binding capacity of 150 mg/mL bed volume or less, 120 mg/mL bed volume or less 100 mg/mL bed volume or less, 90 mg/mL bed volume or less, 80 mg/mL bed volume or less, 70 mg/mL bed volume or less, 60 mg/mL bed volume or less, 50 mg/mL bed volume or less, 40 mg/mL bed volume or less, 35 mg/mL bed volume or less, 30 mg/mL bed volume or less, 25 mg/mL bed volume or less, 20 mg/mL bed volume or less, 10 mg/mL bed volume or less, 5 mg/mL bed volume or less, 1 mg/mL bed volume or less, or 0.1 mg/mL bed volume or less. In some embodiments, a separation media or separation device containing the same has a static binding capacity of 0.01 mg/mL bed volume to 150 mg/mL bed volume, 0.01 mg/mL bed volume to 120 mg/mL bed volume, 0.01 mg/mL bed volume to 100 mg/mL bed volume, 0.01 mg/mL bed volume to 10 mg/mL bed volume, 0.01 mg/mL bed volume to 5 mg/mL bed volume, 0.01 mg/mL bed volume to 1 mg/mL bed volume, 0.1 mg/mL bed volume to 150 mg/mL bed volume, 0.1 mg/mL bed volume to 120 mg/mL bed volume, 0.1 mg/mL bed volume to 100 mg/mL bed volume, 0.1 mg/mL bed volume to 10 mg/mL bed volume, 0.1 mg/mL bed volume to 5 mg/mL bed volume, 0.1 mg/mL bed volume to 1 mg/mL bed volume, 1 mg/mL bed volume to 150 mg/mL bed volume, 1 mg/mL bed volume to 120 mg/mL bed volume, 1 mg/mL bed volume to 100 mg/mL bed volume, 5 mg/mL bed volume to 150 mg/mL bed volume, 5 mg/mL bed volume to 120 mg/mL bed volume, 5 mg/mL bed volume to 100 mg/mL bed volume, 10 mg/mL bed volume to 150 mg/mL bed volume, 10 mg/mL bed volume to 120 mg/mL bed volume, 10 mg/mL bed volume to 100 mg/mL bed volume, 10 mg/mL bed volume to 90 mg/mL bed volume, 10 mg/mL bed volume to 80 mg/mL bed volume, 10 mg/mL bed volume to 70 mg/mL bed volume, 10 mg/mL bed volume to 60 mg/mL bed volume, 10 mg/mL bed volume to 50 mg/mL bed volume, 10 mg/mL bed volume to 40 mg/mL bed volume, 15 mg/mL bed volume to 60 mg/mL bed volume, 15 mg/mL bed volume to 50 mg/mL bed volume, 20 mg/mL bed volume to 80 mg/mL bed volume, 20 mg/mL bed volume to 70 mg/mL bed volume, 20 mg/mL bed volume to 60 mg/mL bed volume, 20 mg/mL bed volume to 50 mg/mL bed volume, 30 mg/mL bed volume to 80 mg/mL bed volume, 30 mg/mL bed volume to 70 mg/mL bed volume, 30 mg/mL bed volume to 60 mg/mL bed volume, or 30 mg/mL bed volume to 50 mg/mL bed volume. The static binding capacity may depend at least in part on the target and the affinity group.

The separation media may have a variety of separation ligand densities. Separation ligand density is the amount of separation ligands immobilized per unit volume of the separation media. In embodiments where the separation media only includes separation groups that include affinity groups, the separation group density can be a measure of affinity group density. The separation ligand density can be determined, for example, by incubating the support substrate (for example, according to S1, S2, or S3) with the reaction solution containing a known amount of the separation group precursor for immobilization for a reaction time to form the separation media. Following incubation, the amount of the separation group precursor containing still in the reaction solution (unreacted) can be measured. The density of the separation ligands can then be calculated as the difference between the initial amount of the separation group precursor in the reaction solution and the amount of separation group precursor in the reaction solution following incubation with the support substrate. The amount of the separation group precursor in the reaction solution pre- and post-incubation with the support substrate can be determined, for example, using spectroscopy and/or high performance liquid chromatography. The separation group pre-cursor can be used as a proxy for the separation ligand.

In some embodiments, the separation media has separation ligand density of 0.01 milligrams of separation ligands per 1 mL of bed volume (mg/mL bed volume) or greater, 0.1 mg/mL bed volume or greater, 1 mg/mL bed volume or greater, 5 mg/mL bed volume or greater, 10 mg/mL bed volume or greater, 20 mg/mL bed volume or greater, 30 mg/mL bed volume or greater, 40 mg/mL bed volume or greater, 50 mg/mL bed volume or greater, 60 mg/mL bed volume or greater, 70 mg/mL bed volume or greater, 80 mg/mL bed volume or greater, 90 mg/mL bed volume or greater, 100 mg/mL bed volume or greater, 110 mg/mL bed volume or greater, or 120 mg/mL bed volume or greater. In some embodiments, a separation media has a separation ligand density of 150 mg/mL bed volume or less, 120 mg/mL bed volume or less, 110 mg/mL bed volume or less, 100 mg/mL bed volume or less, 90 mg/mL bed volume or less, 80 mg/mL bed volume or less, 70 mg/mL bed volume or less, 60 mg/mL bed volume or less, 50 mg/mL bed volume or less, 40 mg/mL bed volume or less, 30 mg/mL bed volume or less, or 20 mg/mL bed volume or less, 10 mg/mL bed volume or less, 5 mg/mL bed volume or less, 1 mg/mL bed volume or less, or 0.1 mg/mL bed volume or less. In some embodiments, a separation media has a separation ligand density of 0.01 mg/mL bed volume to 150 mg/mL bed volume, 0.1 mg/mL bed volume to 150 mg/mL bed volume, 1 mg/mL bed volume to 150 mg/mL bed volume, 5 mg/mL bed volume to 150 mg/mL bed volume, 10 mg/mL bed volume to 100 mg/mL bed volume, 10 mg/mL bed volume to 90 mg/mL bed volume, 10 mg/mL bed volume to 80 mg/mL bed volume, 10 mg/mL bed volume to 70 mg/mL bed volume, 10 mg/mL bed volume to 60 mg/mL bed volume, 10 mg/mL bed volume to 50 mg/mL bed volume, 10 mg/mL bed volume to 40 mg/mL bed volume, 10 mg/mL bed volume to 20 mg/mL bed volume, 15 mg/mL bed volume to 60 mg/mL bed volume, 15 mg/mL bed volume to 50 mg/mL bed volume, 15 mg/mL bed volume to 30 mg/mL bed volume, 20 mg/mL bed volume to 80 mg/mL bed volume, 20 mg/mL bed volume to 70 mg/mL bed volume, 20 mg/mL bed volume to 60 mg/mL bed volume, 20 mg/mL bed volume to 50 mg/mL bed volume, 20 mg/mL bed volume to 30 mg/mL bed volume, 30 mg/mL bed volume to 80 mg/mL bed volume, 30 mg/mL bed volume to 70 mg/mL bed volume, 30 mg/mL bed volume to 60 mg/mL bed volume, or 30 mg/mL bed volume to 50 mg/mL bed volume, 0.01 mg/mL bed volume to 10 mg/mL bed volume, 0.01 mg/mL bed volume to 5 mg/mL bed volume, 0.01 mg/mL bed volume to 1 mg/mL bed volume, 0.1 mg/mL bed volume to 10 mg/mL bed volume, 0.1 mg/mL bed volume to 5 mg/mL bed volume, 0.1 mg/mL bed volume to 1 mg/mL bed volume, or 1 mg/mL bed volume to 10 mg/mL bed volume. Separation ligand density can also be described as the specific surface area (SSA) in square meters (m²) relative to the bed volume of the separation media. SSA can be determined, for example, using nitrogen Brunauer-Emmett-Teller (BET) analysis. Prior to immobilization of the separation ligands on the support substrate, the support substrate will have a support substrate SSA. After immobilization of the separation ligands on the support substrate to form the separation media, the separation media has a separation media SSA. The support substrate SSA and the separation media SSA may be impacted by the pore size of the support substrate, Generally, support substrates with greater pore sizes have a larger support substrate SSA. Generally, the separation media SSA will be greater than the support substrate SSA. In some embodiments the separation media SSA is 0.5 times or greater than the support substrate SSA, 1 time or greater than the support substrate SSA, 1.5 times or greater than the support substrate SSA, 2 times or greater than the support substrate SSA, 3 time or greater than the support substrate SSA, 4 time or greater than the support substrate SSA, 5 time or greater than the support substrate SSA, or 7 time or greater than the support substrate SSA. In some embodiments the separation media SSA is 10 times or less than the support substrate SSA, 7 times or less than the support substrate SSA, 5 times or less than the support substrate SSA, 4 times or less than the support substrate SSA, 3 times or less than the support substrate SSA, 2 times or less than the support substrate SSA, 1.5 times or less than the support substrate SSA, or 1 time or less than the support substrate SSA.

In some embodiments the separation media has a separation SSA of 1.5 meters squared per milliliter of bed volume (m²/mL bed volume) or greater, 2 m²/mL bed volume or greater, 3 m²/mL bed volume or greater, 4 m²/mL bed volume or greater, 5 m²/mL bed volume or greater, 8 m²/mL bed volume or greater, 9 m²/mL bed volume or greater, 10 m²/mL bed volume or greater, or 15 m²/mL bed volume when the support substrate has an average pore size of 0.1 micrometers to 10.0 micrometers, such as 0.2 micrometers to 0.5 micrometers. In some embodiments the separation media has a separation SSA of 20 m²/mL bed volume or less, 15 m²/mL bed volume or less, 10 m²/mL bed volume or less, 9 m²/mL bed volume or less, 8 m²/mL bed volume or less, 7 m²/mL bed volume or less, 6 m²/mL bed volume or less, 5 m²/mL bed volume or less, 4 m²/mL bed volume or less, or 3 m²/mL bed volume or less, 2 m²/mL bed volume or less when the support substrate has an average pore size of 0.1 micrometers to 10.0 micrometers, such as 0.2 micrometers to 0.5 micrometers. In some embodiments the separation media has a separation SSA of 1.5 m²/mL bed volume to 20 m²/mL bed volume, 1.5 m²/mL bed volume to 15 m²/mL, 1.5 m²/mL bed volume to 10 m²/mL, 2 m²/mL bed volume to 20 m²/mL, 2 m²/mL bed volume to 15 m²/mL, 2 m²/mL bed volume to 10 m²/mL, 2 m²/mL bed volume to 9 m²/mL, 2 m²/mL bed volume to 8 m²/mL, 2 m²/mL bed volume to 7 m²/mL, 2 m²/mL bed volume to 6 m²/mL, 2 m²/mL bed volume to 5 m²/mL, 3 m²/mL bed volume to 20 m²/mL, 3 m²/mL bed volume to 15 m²/mL, 3 m²/mL bed volume to 10 m²/mL, 4 m²/mL bed volume to 20 m²/mL, 4 m²/mL bed volume to 15 m²/mL, 4 m²/mL bed volume to 10 m²/mL, 5 m²/mL bed volume to 20 m²/mL, 5 m²/mL bed volume to 15 m²/mL, or 5 m²/mL bed volume to 10 m²/mL when the support substrate has an average pore size of 0.1 micrometers to 10.0 micrometers, such as 0.2 micrometers to 0.5 micrometers.

In some embodiments, the separation media and/or separation devices containing the same are able to purify a target molecule at a fast flow rate. For example, separation media and/or separation devices containing the same may be used to purify a target at residence times of 5 minutes or less, 2 minutes or less, 1 minute or less, 30 seconds or less, 10 seconds or less, or 6 seconds or less. The residence time is somewhat dependent on the volume of the separation media and/or on the size of the device. For example, in separation media that have low volumes and/or separation devices that are small, the residence times may be as low as 1 second or less. Although there is no desired lower limit for the residence time, in practice residence times are 0.1 seconds or greater.

In some embodiments, the separation media and/or separation device containing the same may be used to purify or concentrate a target from an isolation solution with a high recovery of the target molecule. The recovery of a target molecule is amount of the target molecule recovered after passing it through the separation media divided by the amount of target molecule in the isolation solution. In some embodiments, the target molecule recovery is 50% or greater, 60% or greater, 80% or greater, 90% or greater, 95% or greater, or 99% or greater. In some embodiments, the target molecule recovery is 100% or less, 95% or less, 90% or less, 80% or less, 70% or less, or 60% or less. In some embodiments, the target molecule recovery is 80% to 100%, 90% to 100%, or 95% to 100%.

In some embodiments, the separation media and/or separation device containing the same may be used to purify or concentrate target models from an isolation solution with a high recovery of active target. An active target is a target that possesses at least some of the function as the target prior to exposure to the separation media of the present disclosure. For example, an active target is a target that has undergone purification using the separation media of the present disclosure and retains at least some binding affinity to a binding partner. The recovery of active target is the amount of active target molecule recovered after passing them through the separation media divided by the amount of target molecules in the isolation solution. In some embodiments, the active target recovery is 50% or greater, 60% or greater, 80% or greater, 90% or greater, 95% or greater, or 99% or greater. In some embodiments, the active target recovery is 100% or less, 95% or less, 90% or less, 80% or less, 70% or less, or 60% or less. In some embodiments, the active target recovery is 80% to 100%, 90% to 100%, or 95% to 100%.

In some embodiments, the separation media and/or separation device containing the same may be used to remove impurities from an isolation solution. An impurity is any molecule that is not the target molecule, or a buffering agent, a salt, or an additive that has been added to the isolation solution. In some embodiments, the separation media is able to remove 50% or greater, 60% or greater, 70% or greater, 80% or greater, 90% or greater, or 99% or greater of the impurities initially present in the isolation solution. In some embodiments, the separation media is able to remove 100% or less, 99% or less, 90% or less, 80% or less, 70% or less, or 60% or less. In some embodiments, the separation media is able to remove 50% to 100%, 60% to 100%, 70% to 100%, 80% to 100% 90% to 100%, 90% to 99%, or 90% to 95% of the impurities initially present in the isolation solution.

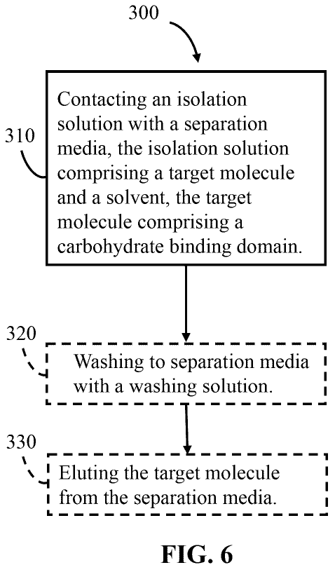

The present disclosure describes a method for using the separation media and/or the separation devices of the present disclosure. FIG. 6 is a flow diagram outlining a method 200 for using the separation media of the present disclosure. The method 200 may be used to isolate a target molecule from an isolation solution. Isolation of a target molecule from an isolation solution may allow for purification of the target molecule, concentration of a target molecule, and/or solvent exchange (i.e., the target molecule is exchanged from the isolation solution to a desired solvent or buffer). Method 300 includes contacting an isolation solution with a separation media (step 310).

The isolation solution includes a carrier and a target molecule (e.g., a plurality of targets). In some embodiments, the isolation solution includes a plurality of target molecules that have already been purified from a mixture that included unwanted impurities. In some such embodiments the plurality of target molecules may be already pure but not concentrated to the desired concentration in a given isolation solution. In such embodiments, the separation media may be used to concentrate the plurality of target molecules by decreasing the volume of solution in which they are located.

In some embodiments, the isolation solution includes a plurality of target molecules that have already been purified from a mixture that included unwanted impurities. In such embodiments the plurality of target molecules may be already pure but not located in a desired solvent. In such embodiments, the separation media may be used conduct a solvent exchange where the target molecules are exchange from being in the isolation solution to an elution solution that has the desired agents and/or properties for storage or further use of the target molecule. In some such embodiments, the isolation solution may include any suitable carrier, a buffering agent, a salt, other additive, or any combination thereof.

In other embodiments, the separation media or separation device may be used to purify the target from a mixture that includes contaminant molecules or undesired molecules. In some such embodiments, the isolation solution includes a mixture of target molecules and undesired molecules. For example, in some such embodiments, the isolation solution includes biomolecules and/or cellular debris. In other such embodiments, the isolation solution may include the byproducts of a reaction.

The carrier of the isolation solution may be any carrier that does not degrade or react with the target molecule. In some embodiments, the carrier includes water, an organic solvent, or both. In some embodiments, the carrier includes an organic solvent such as, for example, methanol, ethanol, isopropanol, and acetonitrile, DMSO, DMF, or any combination thereof. In some embodiments, the majority of the carrier is water. Alternatively, in some embodiments, the majority of the carrier may be made up of organic solvents. In some embodiments, the carrier is nonaqueous, e.g., consists of organic solvents. In some embodiments, the carrier includes a mixture of water and one or more organic solvents.

In some embodiments, the carrier is a biological fluid. Examples of biological fluids include blood (or fractions such as plasma), urine, saliva, and cerebrospinal fluid. In some embodiments where the carrier is a biological fluid, the isolation solution includes the components of the biological fluid. In other embodiments where the carrier is a biological fluid, the biological fluid has been filtered or at least partially purified such that the isolation solution does not include all the components of the biological fluid.

The pH of the isolation solution may be any pH that does not make the target molecule unstable or insoluble. Additionally, the pH of the isolation solution should be such that the separation ligands of the separation media are not unstable. The pH of the isolation solution is such that the boronic acid containing affinity groups can form a covalent bond to diol containing groups binding of diol containing compounds (e.g., target molecules). In some embodiments, the pH of the isolation solution is greater than the pKa of the boronic acid of the affinity group. In some embodiments, the pH of the isolation solution is at the pKa of the boronic acid of the affinity group. In some embodiments, the pH of the isolation solution is below the pKa of the boronic acid of the affinity group. Additionally, the pH of the isolation solution may be controlled to increase the binding affinity of the target molecules to the affinity groups and/or assistance group (if present).

The isolation solution may include one or more components of an expression system or synthesis system, suitable buffering agents, suitable salts, other suitable additives, or any combination thereof. For example, the isolation solution may include the lysate of an expression system used to produce the plurality of target molecules as well as any salts, buffering agents, or additives used to lyse the cells. The isolation solution may include the media (e.g., Dulbecco's modified eagle medium) of an expression system in which the target molecules have been excreted from an expression system.

Examples of suitable salts and buffering agents include sodium chloride; potassium chloride; lithium chloride; rubidium chloride; calcium chloride; magnesium chloride; cesium chloride; tris base (tris(hydroxymethyl)aminomethane); 4-(2-hydroxyethyl)-1-piperazineethanesulfonic acid (HEPES); sodium phosphate; potassium phosphate; ammonium sulfate, 2-(N-morpholino)ethanesulfonic acid (MES); 2,2′,2″-nitrilotriacetic acid (ADA); N-(2-Acetamido)-2-aminoethanesulfonic acid (ACES); 3-morpholino-2-hydroxypropanesulfonic acid (MOPSO); cholamine chloride hydrochloride; 3-(N-morpholino)propanesulfonic acid (MOPS); N,N-bis(2-hydroxyethyl)-2-aminoethanesulfonic acid (BES); 2-{[1,3-dihydroxy-2-(hydroxymethyl)propan-2-yl]amino}ethane-1-sulfonic acid (TES); 3-(N,N-bis [2-hydroxyethyl]amino)-2-hydroxypropanesulfonic acid (DIPSO); 3-[N-tris(hydroxymethyl)methylamino]-2-hydroxypropanesulfonic acid (TAPSO); acetamidoglycine; piperazine-1,4 bis(2-hydroxypropanae sulphonic acid) (POPSO); N-(hydroxyethyl)piperazine-N′-2-hydroxypropanesulfonic acid (HEPPSO); 3-[4-(2-hydroxyethyl)piperazin-1-yl]propane-1-sulfonic acid (HEPPS); N-(tri(hydroxymethyl)methyl)glycine (tricine); 2-aminoacetamide; glycylglycine; N,N-bis(2-hydroxyethyl)glycine; N-tris(hydroxymethyl)methyl-3-aminopropanesulfonic acid (TAPS); and the like. Suitable salts and/or buffering agents may be added in an amount of 1 millimolar (mM) or greater, 5 mM or greater, or 10 mM or greater, 20 mM or greater, 50 mM or greater, 100 mM or greater 200 mM or greater, or 500 mM or greater. Suitable salts may be added in an amount of 1 M or less, 500 mM or less, 100 mM or less, 50 mM or less, or 30 mM or less. The salts may be added in an amount ranging from 1 mM to 1 M, 1 mM to 500 mM, 1 mM to 200 mM, 1 mM to 100 mM, 1 mM to 50 mM, 5 mM to 30 mM, 5 mM to 20 mM, or 20 mM to 100 mM.

In some embodiments, the isolation solution includes one or more kosmotropic salts, one or more chaotropic salts, or both. Kosmotropic salts are known as salts that decrease the solubility of nonpolar substances in aqueous solutions. In contrast, while chaotropic salts increase the solubility of nonpolar substances in aqueous solutions. In some embodiments, the amount and/or identity of a kosmotropic and/or chaotropic salts may be designed to increase the binding affinity and/or binding specificity between the target molecules and the affinity groups and/or assistance groups (if present).

Examples of kosmotropic salts that may be present in the isolation solution include ammonium sulfate, ammonium phosphate, potassium phosphate, sodium sulfate, sodium chloride, and any combination thereof. Suitable kosmotropic salts may be present in the isolation solution in an amount of 0.1 M or greater, 0.5 M or greater, or 1.0 M or greater, or 2.0 M or greater. Suitable kosmotropic salts may be present in the isolation solution in an amount of 6.0 M or less, 5.0 M or less, or 4.0 M or less. The kosmotropic salts may be added in an amount ranging from 0.1 M to 6M, 0.5 M to 2.5 M, or 0.5 M to 3.0 M.

Examples of chaotropic salts that may be present in the solution include sodium chloride, calcium chloride, magnesium chloride and any combination thereof. In some embodiments, the isolation solution includes 1 M or less, 0.5 M or less, or 0.1 M or less of chaotropic salts. In some embodiments, the isolation solution is free or substantially free of chaotropic salts.

Suitable additives include glycerol and other polyols; protease inhibitors; phosphatase inhibitors; cryoprotectants; detergents; chelating agents; reducing agents; and any combination thereof Suitable additives may be present in the isolation solution in amounts of 0.01 mM or greater, 0.1 mM or greater, 1 mM or greater, 5 mM or greater, 10 mM or greater, or 20 mM or greater. Suitable salts may be added in an amount of 100 mM or less, 50 mM or less, 30 mM or less, 10 mM or less, 5 mM or less, or 1 mM or less. Suitable additives may be present in the isolation solution in amounts ranging from 0.01 mM to 100 mM, 1 mM to 50 mM, 5 mM to 30 mM, 5 mM to 20, 0.01 mM to 5 mM, or 1 mM to 5 mM.

The isolation solution is contacted with the separation media such that at least a portion of the plurality of the target molecules bind to at least a portion of the separation ligands that include an affinity group and/or an assistance group (if present). Molecules present in the solution that do not include a diol (i.e., molecules that are not the target molecules), will not bind to the affinity group or will bind to the affinity group with a lesser affinity (e.g., form a boronate ester that is less table than the target molecule) than the target molecule. Such off target molecules can be removed in a washing step as discussed herein. Through binding to the affinity group, the target molecules are temporarily immobilized on the support substrate (e.g., through the formation of a boronate ester that includes the target molecule).

In some embodiments, the method 300 includes washing the separation media with a washing solution (step 320). Washing the separation media with a washing solution includes contacting the separation media with the washing solution. Washing the separation media may allow for any molecules that are not the target molecule to be removed from the separation media. In the washing step, at least a portion of the target molecules remain bound to the affinity group and temporarily immobilized on the support substrate.

The washing solution may include a variety of components or may simply be a solvent (e.g., water). The composition and/or pH of the washing solution should be such that none of the components degrade or react with the target molecule. Additionally, the composition and/or pH should be such that the washing solution does not decrease the affinity of the target molecule to the affinity group to a point where the target molecule is able to be removed from the affinity group and washed through the separation media. The washing solution includes washing solvent. The washing solvent may be water, an organic solvent, or a mixture of both. The washing solvent may be any solvent as described herein such as those described relative to the isolation solution. In embodiments, the washing solution includes one or more buffering agents, one or more salts, one or more additives, or any combination thereof. In some embodiments, the one or more salts, one or more buffering agents, or one or more additives may be present in the washing solution in any amount as described relative to the isolation solution.

The pH of the washing solution may be any pH that does not decrease the affinity of the target molecule to the affinity group to a point where the target molecule is able to be removed from the affinity group and washed through the separation media. Additionally, the pH of the washing solution should be such that the separation ligands of the separation media are not unstable. The pH of the washing solution may be controlled to enhance the binding affinity of the target molecules to the affinity groups. and/or decrease the binding affinity of any off target molecules to the affinity groups. For example, the pH of the washing solution may be of a value that encourages boronate esters that contain an impurity to break allowing the impurity to be washed away without breaking the boronate esters that contain the target molecule. Increasing the acidity (decreasing the pH) decreases the stability of boronate esters. As such, in some embodiments, the washing solution has a higher acidity than the isolation solution (lower pH) such that the stability of the boronate esters that contain the impurity decreases allowing the boronate ester to break and the impurity to be removed from the separation media.

In some embodiments, step 320 may be repeated with additional washing solutions. The additional washing solutions may have the same composition and/or pH as the first washing solution or a different composition and/or pH than the first washing composition.

In some embodiments, method 300 further includes eluting the plurality of target molecules that were temporarily immobilized on the support substrate (step 330). The target molecules may be eluted by contacting the separation media with an elution solution. The elution solution includes an elution solvent. The elution solvent may be any solvent as described herein (e.g., the solvent included in the washing solution and/or the isolation solution). The elution solution may be of any composition and/or pH that allows for the target molecules to be separated from the affinity groups and exit the separation media. In some embodiments the elution solution has a pH that encourages the target molecules to be freed from the support substrate; includes a salt and/or a concentration of a salt that encourages the target molecules to be freed from the support substrate; includes an affinity group competitive molecule that encourages the target molecules to be freed from the support substrate; or any combination thereof.

In some embodiments, the pH of the elution solution may be such as to decrease the binding affinity between the target molecules and the affinity groups. In some embodiments, the pH of the elution solution may be such as to decrease the stability of the boronate esters that include the target molecule thereby freeing the target molecule from the support substrate. The pH of the elution solution is lower than the pH of the isolation solution (i.e., the elution solution is more acidic). In some embodiments, the difference in pH of the isolation solution and elution solution is 0.1 pH units or greater, 0.5 pH units or greater, 1 pH unit or greater, 2 pH units or greater, 3 pH units or greater, 4 pH units or greater, or 5 pH units or greater. In some embodiments, the difference in pH of the isolation solution and elution solution is 10 pH units or less, 5 pH units or less, 4 pH units or less, 3 pH units or less, 2 pH units or less, 1 pH unit or less, or 0.5 pH units or less. In some embodiments, the difference in pH of the isolation solution is 0.1 to 10 pH units, 0.5 to 2 pH units, or 1 pH unit to 5 pH units. In some embodiments, the pH of the elution solution is less than the pKa of the boronic acid of the affinity group.

In some embodiments, the elution solution may include a molecule that is bound by the affinity group and/or can compete for binding to the affinity group (e.g., a molecule that includes a diol that can form a stable boronate ester). Such a molecule may be present in an amount such as to compete off the target molecules from the affinity groups. To that end, in some embodiments, the elution solution includes an affinity group competitive molecule. Different target molecules (or target molecules and other molecules) may be eluted using a linear gradient elution or using a step isocratic elution.

An affinity group competitive molecule is a molecule that binds to the affinity group, and when present at a sufficient concentration can compete off the target molecule from the affinity group. In some embodiments, the affinity group competitive molecule has a higher affinity for the affinity group than the target molecule. In other embodiments, the affinity group competitive molecule has a lower affinity for the affinity group than the target molecule. In yet other embodiments, the affinity group competitive molecule may have the same affinity for the affinity group as the target molecule.

An affinity group competitive molecule may be any molecule that binds to a given affinity group; that is, can form a boronate ester with the boronic acid of the affinity group. As such, in some embodiments, the affinity group competitive molecule may be any molecule that includes a diol.

An affinity group competitive molecule may be present in an elution solution at a concentration sufficient to compete off the target molecules from the affinity groups. In some embodiments, the affinity group competitive molecule may be present in an elution solution the amount of 20 millimolar (mM) or greater, 50 mM or greater, 100 mM or greater, 200 mM or greater, 300 mM or greater, 400 mM or greater, or 500 mM or greater. In some embodiments, the affinity group competitive molecule may be present in an elution solution the amount of 1 M or less, 500 mM or less, 400 mM or less, 300 mM or less, 200 mM or less, 100 mM or less, or 50 mM or less. In some embodiments, the affinity group competitive molecule may be present in an elution solution the amount of 20 mM to 400 mM, 50 mM to 200 mM, or 100 mM to 500 mM.

In some embodiments, the elution solution includes high amounts of one or more salts in order to decrease the binding affinity between the target molecule and the affinity groups and/or assistance groups (if present). The salt or mixture of salts may be any salt as described herein, for example, in reference to the isolation solution. The salt or mixture of salts may be present in the elution solution in an amount of 50 millimolar (mM) or greater, 100 mM or greater, 150 mM or greater, 200 mM or greater, 300 mM or greater, 500 mM or greater, or 1 M or greater. The salt or mixture of salts may be present in the elution solution in an amount of 5 M or less, 1 M or less, 500 mM or less, 300 mM or less, 200 mM or less, or 100 mM or less.

In some embodiments, the elution solution includes a kosmotrope and/or a chaotrope. The amount and/or identity of a kosmotrope and/or chaotropic salt may be designed to decrease the binding affinity between the target molecule and the affinity group and/or assistance group (if present).

The volume of the elution solution used to elute the target may vary. For example, in embodiments where the separation media is being employed to concentrate the target, the volume of elution solution is less that the volume of isolation solution.

In some embodiments, the method includes regenerating the separation media.

Regeneration is done to prepare the separation media (or the separation media of a separation device) for subsequent uses. Regeneration may include washing the separation media with a solution designed to strip impurities from the separation media. Regeneration may also include flowing an equilibration solution through the separation media such as to prepare the separation media for future use.

### ILLUSTRATIVE EMBODIMENTS

The technology described herein is defined in the claims. However, below is provided a non-exhaustive listing of non-limiting embodiments. Any one or more of the features of these embodiments may be combined with any one or more features of another example, embodiment, or aspect described herein.

Embodiment 1 is a separation media that includes:
a support substrate; and
a plurality of separation ligands for formula SL1 or SL2

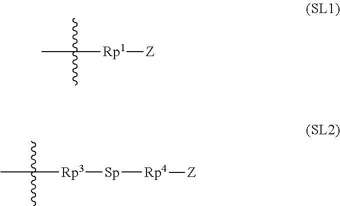

wherein:
Z is a separation group comprising an affinity group, the affinity group capable of binding a diol group; and
Rp¹, Rp³, and Rp⁴ each independently includes the reaction product of any one of Rp^{A}, Rp^{B}, Rp^{C}, Rp^{D}, Rp^{E}, Rp^{F}, Rp^{G}, Rp^{H}, Rp^{I}, Rp^{J}, Rp^{K}, Rp^{L}, Rp^{M}, or an isomer thereof,
wherein Rp^{A}, Rp^{B}, Rp^{C}, Rp^{D}, Rp^{E}, Rp^{F}, Rp^{G}, Rp^{H}, Rp^{I}, Rp^{J}, Rp^{K}, Rp^{L}, and Rp^{M}, are represented by:

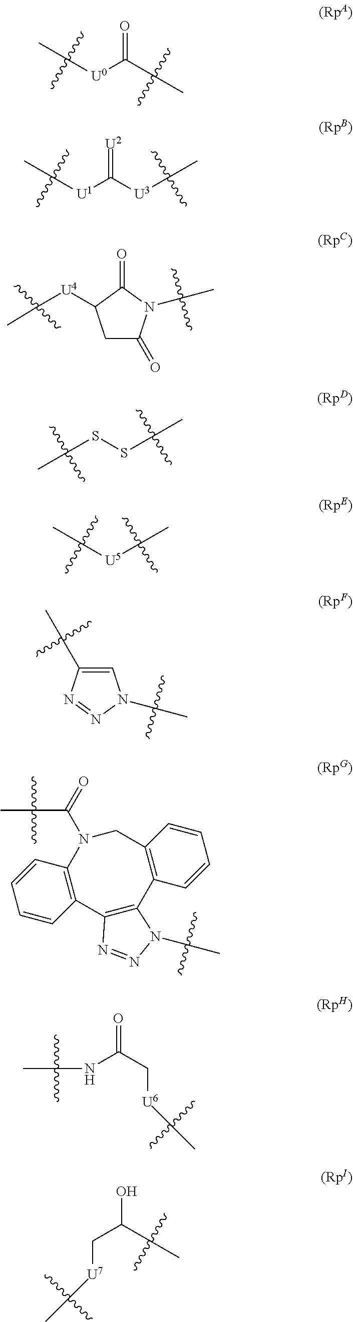

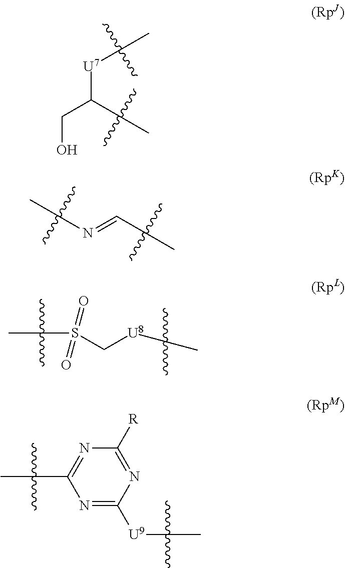

wherein:
U⁰, U¹, U², U³, U⁴, U⁵, U⁶, U⁷, U⁸ and U⁹ are each independently NH, O, or S;
R is an organic group, H, or halogen; and
Sp is a spacer comprising a divalent organic group.

Embodiment 2 is the separation media of Embodiment 1, wherein the plurality of separation ligands are of formula SL2 and Sp is an alkanediyl or alkenediyl that includes one or more catenated functional groups.

Embodiment 3 is the separation media of embodiment 2, wherein the alkanediyl or alkenediyl includes a backbone chain of length C1 to C18.

Embodiment 4 is the separation media of embodiment 3, wherein the alkanediyl or alkenediyl includes a backbone chain of length C1 to C3.

Embodiment 5 is the separation media of any of Embodiments 1 to 4, wherein Sp includes or is —C(O)—.

Embodiment 6 is the separation media of any of Embodiments 1 to 5, wherein Rp³, Rp⁴, or both are or include Rp^{E}.

Embodiment 7 is the separation media of Embodiment 6, wherein Rp³ and Rp⁴ include or are Rp^{E}.

Embodiment 8 is the separation media of Embodiment 7, wherein each U⁵ is O.

Embodiment 9 is the separation media of Embodiment 7, wherein each U⁵ is NH.

Embodiment 10 is the separation media of Embodiment 7, wherein one U⁵ is NH and the other U⁵ is O.

Embodiment 11 is the separation media of any of Embodiments 1 to 5, wherein SL2 includes or is

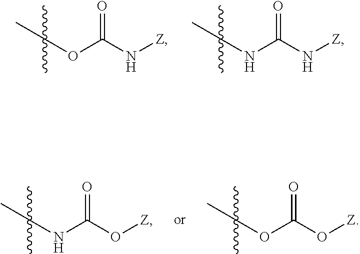

Embodiment 12 is the separation media of any of Embodiments 1 to 4, wherein SL2 includes or is

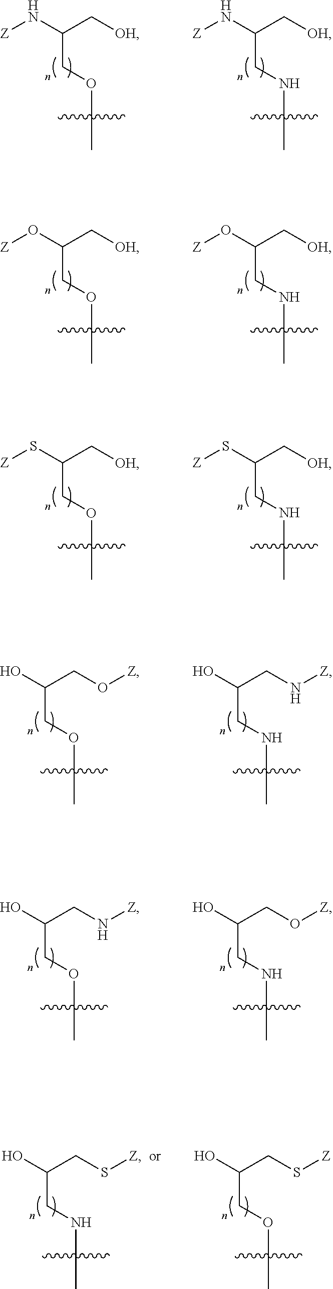

wherein n is 0, 1, 2, 3, 4, 5, 6, 7, 8, 9, or 10.

Embodiment 13 is the separation media of Embodiment 12, wherein n is 1.

Embodiment 14 is the separation media of any of Embodiment 1 to 13, wherein the support substrate includes or is a polyolefin membrane, a polyethersulfone membrane, a poly(tetrafluoroethylene) membrane, a nylon membrane, a fiberglass membrane, a hydrogel membrane, a hydrogel monolith, a polyvinyl alcohol membrane, a cellulose membrane, a cellulose ester membrane, a cellulose acetate membrane, a regenerated cellulose membrane, a cellulosic nanofiber membrane, a cellulosic monolith, a filter paper, or any combination thereof.

Embodiment 15 is the separation media of any of Embodiments 1 to 14, wherein the separation media is configured for use with an organic solvent.

Embodiment 16 is the separation media of any of Embodiments 1 to 14, wherein the separation media is configured for use with an aqueous solvent.

Embodiment 17 is the separation media of any of Embodiments 1 to 16, wherein the affinity group is capable of forming a reversible covalent bond with the diol group.

Embodiment 18 is the separation media any of Embodiments 1 through 17, wherein the diol is a 1,2-diol; a 1,3-diol, a cis 1,2-diol, or a cis 1,3-diol.

Embodiment 19 is the separation media of any Embodiments 1 through 18, wherein a monosaccharide or a small molecule includes the diol.

Embodiment 20 is the separation media of Embodiment 19, wherein an oligosaccharide, a protein, a nucleoside, a nucleotide, or an oligonucleotide includes the monosaccharide.

Embodiment 21 is the separation media of Embodiment 19 or 20, wherein the monosaccharide includes sialic acid or a ribose.

Embodiment 22 is the separation media of Embodiment 20, wherein the nucleoside includes 5-carbamethyluridine or 6-hydroxyl-1,6-dihydropurine ribonucleoside.

Embodiment 23 is the separation media of any of Embodiments 1 through 22, wherein the affinity group includes or is of Formula B(i) or B(ii):

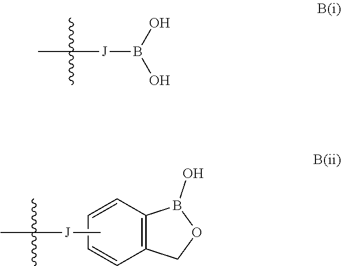

wherein J is an intermediate group comprising an alkyl, an aromatic group, or both.

Embodiment 24 is the separation media of Embodiment 23, wherein the J includes a C1 to C10 alkyl.

Embodiment 25 is the separation media of Embodiment 24, wherein the J is butyl.

Embodiment 26 is the separation media of Embodiment 25, wherein J is or includes J(i), J(ii), or J(iii):

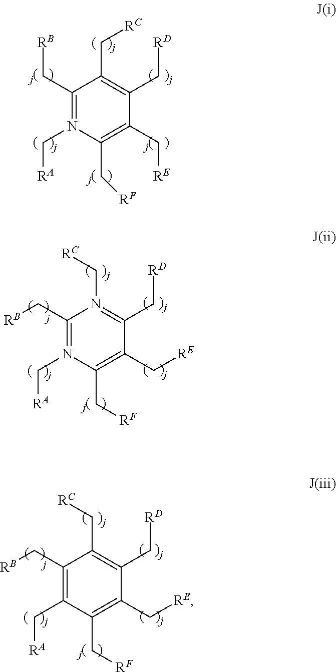

wherein each j is independently 0, 1, 2, 3, 4, or 5;
wherein at least one of R^{A}, R^{B}, R^{C}, R^{D}, R^{E}, and R^{F} is the boronic acid;
wherein at least one R^{A}, R^{B}, R^{C}, R^{D}, R^{E}, and R^{F} is a connection point shown in B(i) or B(ii); and
wherein the remaining R^{A}, R^{B}, R^{C}, R^{D}, R^{E}, and R^{F} are each independently H, a halogen, an amine, a thiol, an aldehyde, a vinyl group, an ester, an ether, an alcohol, a urea, a guanidine, a carbonate, a carbamate, or a sulfone.

Embodiment 27 is the separation media of Embodiment 26, wherein J is J(iii); each j is 0; R^{A}, R^{B}, R^{E}, or R^{F} are the boronic acid and the remaining R groups are H.

Embodiment 28 is the separation media of Embodiment 27, wherein J is J(iv), J(v), or J(vi)

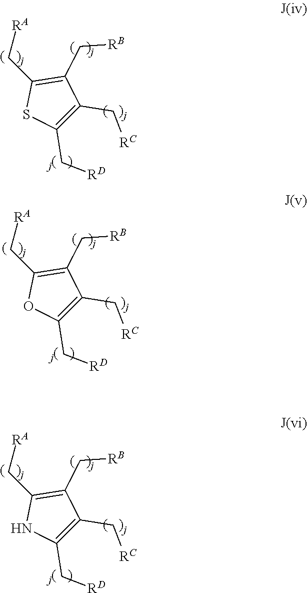

wherein j is independently 0, 1, 2, 3, 4, or 5;
wherein at least one of R^{A}, R^{B}, R^{C}, and R^{D} is the boronic acid;
wherein at least one R^{A}, R^{B}, R^{C}, and R^{D} is the connection point shown in B(i) or B(ii); and
all remaining R^{A}, R^{B}, R^{C}, and R^{D} (the R groups that are not the bornic acid or the connection point) are each independently H, a halogen, an amine, an aldehyde, a vinyl group, an ester, an ether, an alcohol, a urea, a guanidine, a carbonate, a carbamate, or a sulfone.

Embodiment 29 is the separation media of Embodiment 28, wherein J is J(iv), each j is 0 and all remaining R^{A}, R^{B}, R^{C}, and R^{D} (the R groups that are not the bornic acid or the connection point) groups are each H.

Embodiment 30 is the separation media of any of Embodiments 1 through 30, wherein the separation media is configured for use with an aqueous solvent.

Embodiment 31 is the separation media of any of Embodiments 1 through 30, wherein the separation media is configured for use with an aqueous solvent.

Embodiment 32 is the separation media of any of Embodiments 1 through 31, wherein the support membrane includes or is a polyolefin membrane, a polyethersulfone membrane, a poly(tetrafluoroethylene) membrane, a nylon membrane, a fiberglass membrane, a hydrogel membrane, a hydrogel monolith, a polyvinyl alcohol membrane, a cellulose membrane, a cellulose ester membrane, a cellulose acetate membrane, a regenerated cellulose membrane, a cellulosic nanofiber membrane, a cellulosic monolith, a filter paper, or combinations thereof.

Embodiment 33 is a separation media that includes two or more of the separation media of any one of Embodiments 1 through 32 arranged in a stacked configuration.

Embodiment 34 is a separation device comprising a housing and the separation media of any of Embodiments 1 through 33 disposed within the housing.

Embodiment 35 is a method of isolating a target molecule from an isolation solution:
the isolation solution including:
a carrier; and
the target molecule that has a cis diol;
the isolation solution having a first pH,
the method including:
contacting the isolation solution with the separation media of any of Embodiments 1 through 32.

Embodiment 36 is the method of Embodiment 35, wherein the method further includes washing the separation media with a washing solution.

Embodiment 37 is the method of Embodiment 35 or 36, wherein the method further includes contacting the separation media with an elution solution, the elution solution having a pH that is less than the pH of the isolation solution.

### EXAMPLES

The present disclosure is illustrated by the following examples. It is to be understood that the particular examples, materials, amounts, and procedures are to be interpreted broadly in accordance with the scope and spirit of the disclosure as set forth herein.

### Example 1: Example Synthetic Methods to Prepare the Separation Media of the Present Disclosure

Several synthetic strategies may be employed to construct the separation media of the present disclosure. The synthetic strategies include direct or indirect immobilization of separation ligands. The synthetic strategies also include amine assisted coupling or organic solvent assisted coupling.

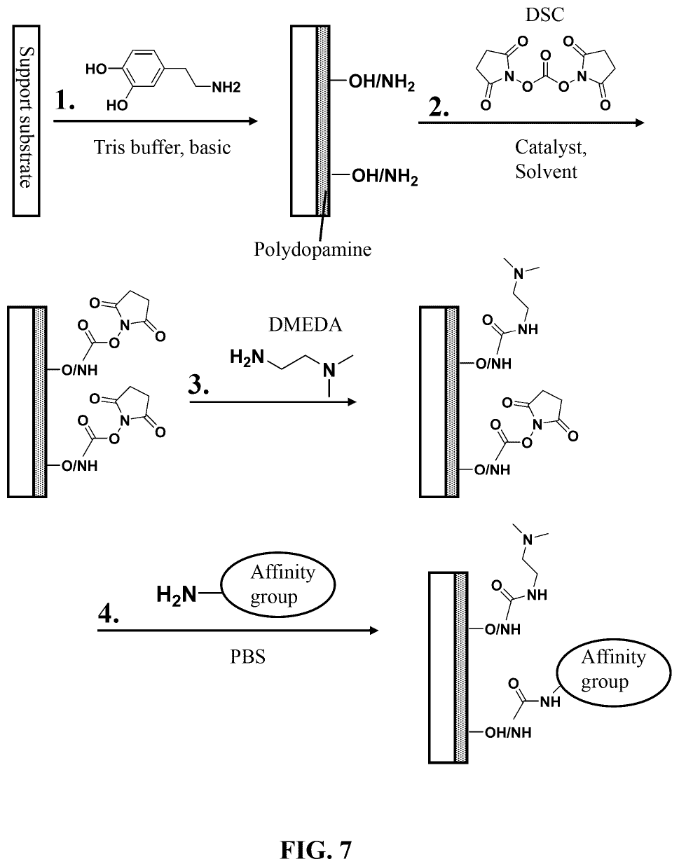

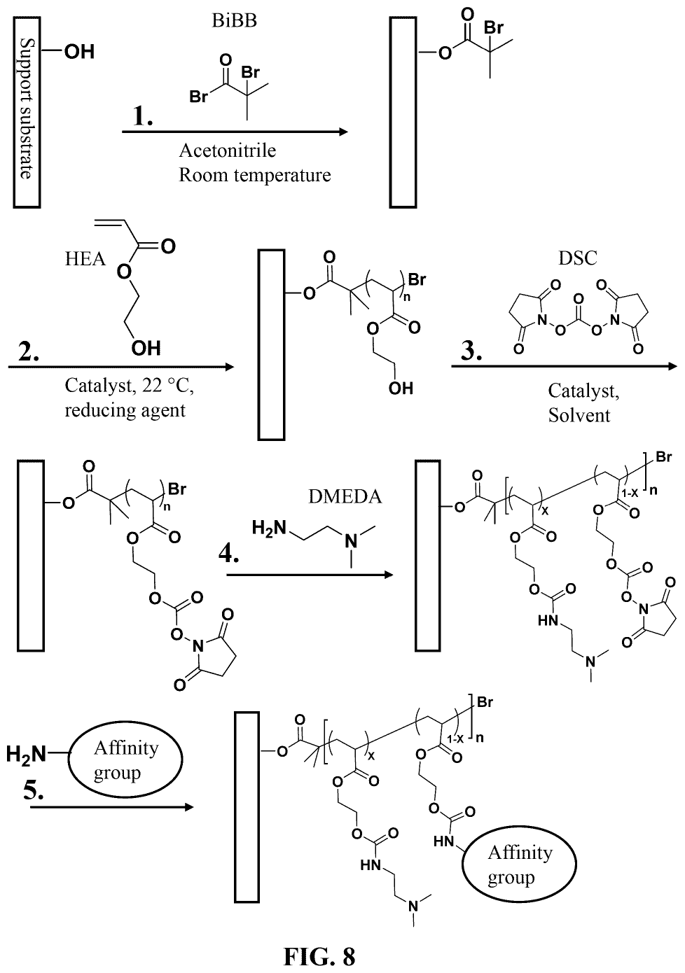

FIG. 7 and FIG. 8 show schematics of synthetic schemes that include the indirect immobilization of the separation ligands to the support substrate. The strategies of FIG. 7 and FIG. 8 also include the amine assisted coupling method.

In Step 1, of the scheme in FIG. 7, polydopamine (PDA) is incorporated onto a support membrane through oxidative polymerization of dopamine in basic aqueous buffer in the presence of air. Deposition of PDA may function to hydrophilize the support substrate and introduce support substrate reactive handles (e.g., hydroxyl, amine, and quinone). In step 2, the PDA reactive handles may be reacted with the bifunctional (has two NHS ester reactive handles) of linker precursor disuccinimidyl carbonate (DSC). Although FIG. 7 shows DSC as the bifunctional linker precursor, other bifunctional linker precursors may be used such as epichlorohydrin. The PDA reactive handles (OH and NH₂) may react with the first N-hydroxy succinimidyl (NHS) ester of the linker precursor to form a first amide or carbamate reaction product. In step 3, a portion of the second NHS ester groups may be reacted with the amine reactive handle of N,N-dimethylethylenediamine (DMEDA; a first separation group precursor) to form a second amide reaction product. The DMEDA groups (e.g., the tertiary amine of DMEDA) may act as cationic assistance affinity groups to increase the local concentration of negatively charged affinity groups (e.g., the negatively charge conjugate base of a boronic acid) at the membrane surface through coulombic interaction. In step 4, the second portion of the second NHS ester groups may be reacted with a second separation group (including an affinity group) precursor reactive handle (an amine as shown in this scheme) to form an amide reaction product. The conjugation reaction of step 4 may be done in an aqueous buffer (not organic solvent assisted).

In the first step of the scheme depicted in FIG. 8, an initiator (alpha-bromoisobutyryl bromide, BiBB) may be coupled to the OH groups of a support substrate. In the second step, hydroxyethyl acrylate monomers may be polymerized from the immobilized initiator to from poly(HEA). In step 3, the poly(HEA) reactive handles (OH groups) may be reacted with the bifunctional (has two NHS ester reactive handles) linker precursor disuccinimidyl carbonate (DSC). Although FIG. 7 shows DSC as the bifunctional linker precursor, other bifunctional linker precursors may be used such as epichlorohydrin. The poly(HEA) reactive handles (OH) may react with the first NHS ester of the linker precursor to form a first carbamate reaction product. In step 4, a portion of the second NHS ester groups may be reacted with the amine reactive handle of N,N-dimethylethylenediamine (DMEDA; a first separation group precursor) to form an amide reaction product and install the separation ligands containing the amine assistance groups. The DMEDA groups (e.g., the tertiary amine of DMEDA) may act as cationic assistance groups which may allow for a higher density of negatively charged affinity groups (e.g., the negatively charge conjugate base of a boronic acid) at the support substrate surface through coulombic interaction. In step 5, the second portion of the second NHS ester groups may be reacted with a second separation group (including the affinity group) precursor reactive handle to form an amide reaction product and install the separation ligands containing the affinity group on the support substrate. The conjugation reaction of step 5 may be completed in an aqueous buffer reaction mixture. In some embodiments, the support substrate may be exposed to a tris base solution as a final step to quench unreacted NHS intermediates and to install separation ligands containing a capping group.

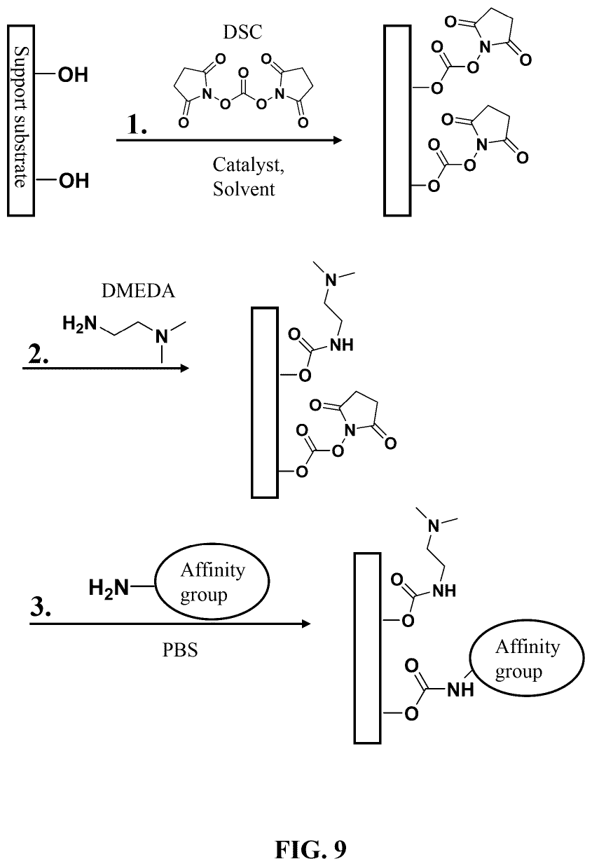

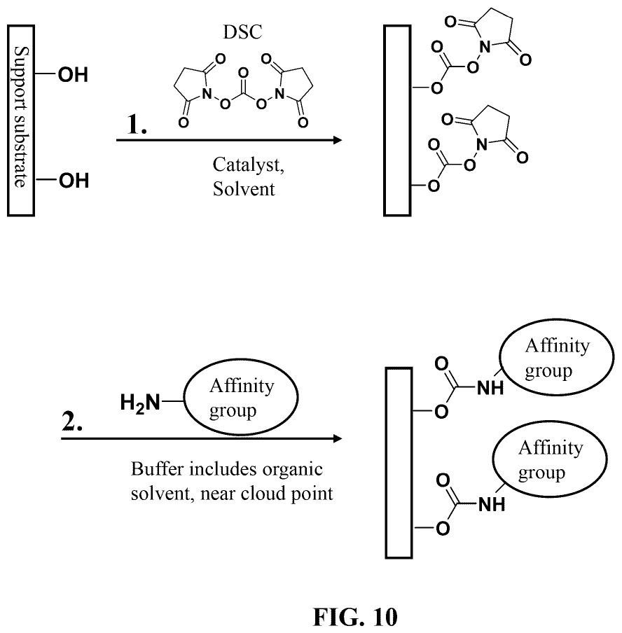

FIG. 9 and FIG. 10 show schematics of synthetic schemes that include the direct immobilization of the separation ligands on the support substrate. The strategy of FIG. 9 includes the amine assisted coupling method. The strategy of FIG. 10 includes the organic solvent assistance method.

FIG. 9 shows a synthetic strategy where the separation ligands can be directly immobilized on the support substrate and the amine assisted method may be used to achieve a high density of separation ligands. This synthetic strategy is similar to the strategy in FIG. 7 except that the membrane was not functionalized with a polymer. Instead, the hydroxyl reactive handles of the support substrate can be directly reacted with one of the NHS ester reactive handles of DSC to form a carbamate reaction product (step 1). Separation ligands having an amine assistance group can be installed (step 2). The amine assistance group may facilitate the installation of the separation groups that include an affinity group (step 3). In some embodiments, the conjugation reaction of step 3 may be done in an aqueous buffer reaction mixture (e.g., not organic solvent assisted).

FIG. 10 shows a synthetic strategy where the separation ligands can be directly immobilized on the support substrate and the organic solvent assisted method may be used to achieve a high density of separation ligands. Residual tertiary amine moieties in the final separation media may have the potential for nonspecific binding when the solution conductivity is very low. As affinity chromatography typically is performed at conductivity levels above that which tertiary amines retain significant binding capacity, the residual amine groups may be expected to have negligible effect on chromatographic performance. In an effort to circumvent this potential issue completely, an organic solvent assisted coupling method may be employed to install the separation ligands containing the affinity group. The organic assisted coupling method utilizes water-miscible organic solvents as a constituent of the coupling solution to increase separation group precursor coupling efficiency, which enables use of low separation group precursor concentrations in the coupling solution. Additions of organic solvents to the aqueous buffered reaction mixture (10%-80% by volume depending on the organic solvent used) may be used to bring solution near the cloud point. At the cloud point, the reaction mixture starts to appear turbid upon increasing the concentration of organic solvent. Organic solutions replace water molecules in the separation group precursor solvation shell which can facilitate greater interaction between the separation group precursor and the support substrate. Additional organic solutions added beyond the cloud point may exacerbate aggregation and flocculation dynamics of the separation group precursor, which can comparatively reduce efficiency of coupling reaction. This coupling methodology may allow for high performance separation media to be prepared with low separation group consumption.

FIG. 10 shows an example synthetic scheme that may be used to prepare separation media of the present application via direct immobilization of the separation ligands using the organic solvent assisted coupling method. In step 1, the support substrate reactive handles (OH) may be reacted with the first N-hydroxy succinimidyl (NHS) ester of the DSC linker precursor to form a carbamate reaction product. In the second step, a reaction mixture that is near the cloud point that includes the separation group precursor (includes the affinity group), water, and a water-miscible solvent may be exposed to the reaction product of step 2. The second NHS ester groups of the support substrate-linker conjugate may react with the reactive handle (NH₂) of the separation group precursor to form an amide reaction product and install the separation ligands having the affinity group on the support substrate. Although FIG. 10 shows DSC as the linker precursor, other bifunctional linker precursors may be used, for example, including epichlorohydrin.

### Example 2: Preparation of a Separation Media that Includes Affinity Groups Derived from 4-Mercaptophenyl Boronic Acid (MPBA)

A separation media having an affinity group derived from MPBA was made. Epichlorohydrin was used as the bifunctional linker. Epichlorohydrin was coupled to the support substrate (2×3×23.5 cm strips) through one of its reactive handles. For conjugation of MPBA, the support substrate was incubated at room temperature overnight with 89.4 mL of a solution that included methanol/water solution (9 by 1), 9.75 mL of 5 M NaOH, 1.13 mL of triethyl amine, and 654 milligrams of MPBA.

The complete disclosure of all patents, patent applications, and publications, and electronically available material cited herein are incorporated by reference in their entirety. Supplementary materials referenced in publications (such as supplementary tables, supplementary figures, supplementary materials and methods, and/or supplementary experimental data) are likewise incorporated by reference in their entirety. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The disclosure is not limited to the exact details shown and described, for variations obvious to one skilled in the art will be included within the disclosure defined by the claims.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present disclosure. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

What is claimed is:

1. A separation media comprising:
a support substrate; and
a plurality of separation ligands for formula SL1 or SL2 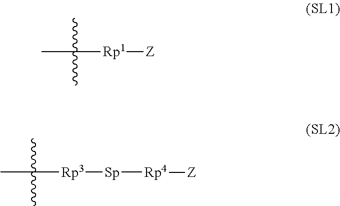
wherein:
Z is a separation group comprising an affinity group, the affinity group capable of binding a diol group; and
Rp¹, Rp³, and Rp⁴ each independently comprise the reaction product of any one of Rp^{A}, Rp^{B}, Rp^{C}, Rp^{D}, Rp^{E}, Rp^{F}, Rp^{G}, Rp^{H}, Rp^{I}, Rp^{J}, Rp^{K}, Rp^{L}, Rp^{M}, or an isomer thereof,
wherein Rp^{A}, Rp^{B}, Rp^{C}, Rp^{D}, Rp^{E}, Rp^{F}, Rp^{G}, Rp^{H}, Rp^{I}, Rp^{J}, Rp^{K}, Rp^{L}, and Rp^{M}, are represented by: 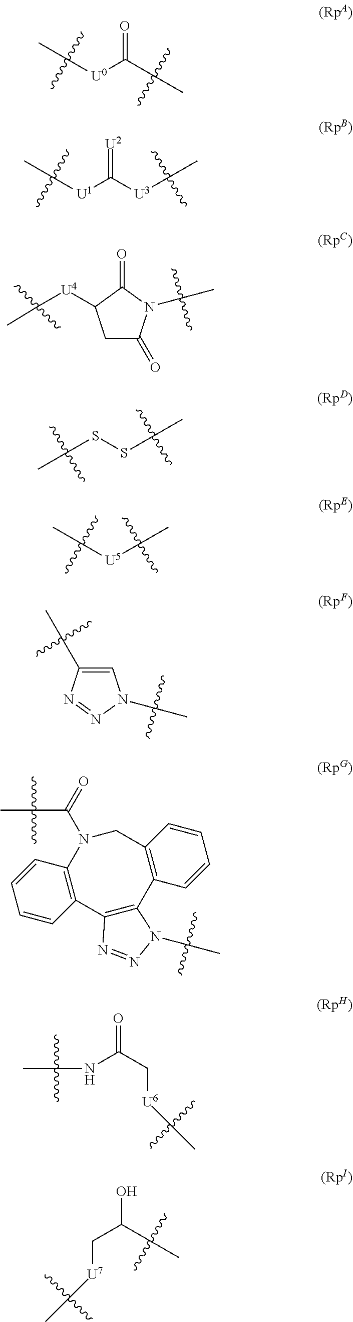 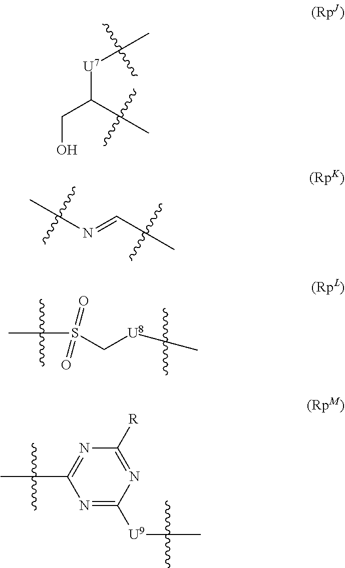
wherein:
U⁰, U¹, U², U³, U⁴, U⁵, U⁶, U⁷, U⁸ and U⁹ are each independently NH, O, or S;
R is an organic group, H, or halogen; and
Sp is a spacer comprising a divalent organic group.

2. The separation media of claim 1, wherein the plurality of separation ligands are of formula SL2 and Sp is an alkanediyl or alkenediyl comprising one or more catenated functional groups.

3. The separation media of claim 1, wherein Sp comprises —C(O)—.

4. The separation media of claim 1, wherein Rp³ and Rp⁴ comprise Rp^{E} and one U⁵ is NH and the other U⁵ is O.

5. The separation media of claim 1, wherein SL2 comprises

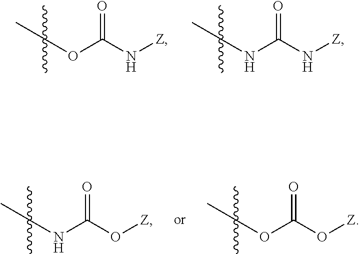

6. The separation media of claim 1, wherein SL2 comprises 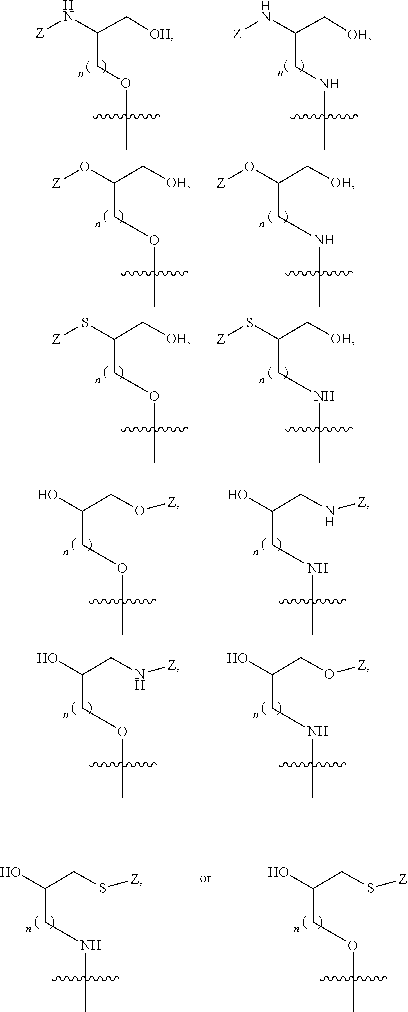
wherein n is 0, 1, 2, 3, 4, 5, 6, 7, 8, 9, or 10.

7. The separation media of claim 1, wherein the support substrate comprises a polyolefin membrane, a polyethersulfone membrane, a poly(tetrafluoroethylene) membrane, a nylon membrane, a fiberglass membrane, a hydrogel membrane, a hydrogel monolith, a polyvinyl alcohol membrane, a cellulose membrane, a cellulose ester membrane, a cellulose acetate membrane, a regenerated cellulose membrane, a cellulosic nanofiber membrane, a cellulosic monolith, a filter paper, or any combination thereof.

8. The separation media of claim 1, wherein the affinity group is capable of forming a reversible covalent bond with the diol group.

9. The separation media of claim 1, wherein an oligosaccharide, a protein, a nucleoside, a nucleotide, or an oligonucleotide comprises the monosaccharide.

10. The separation media of claim 1, wherein the affinity group comprises B(i) or B(ii): 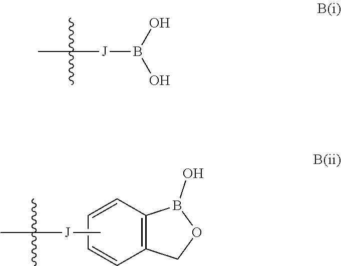
wherein J is an intermediate group comprising an alkyl, an aromatic group, or both.

11. The separation media of claim 10, wherein the J comprises a C1 to C10 alkyl.

12. The separation media of claim 10, wherein the J is butyl.

13. The separation media of claim 10, wherein J is J(i), J(ii), or J(iii): 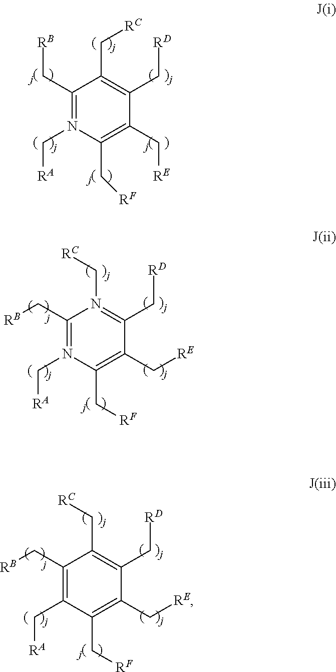
wherein each j is independently 0, 1, 2, 3, 4, or 5;
wherein at least one of R^{A}, R^{B}, R^{C}, R^{D}, R^{E}, and R^{F} is the boronic acid;
wherein at least one R^{A}, R^{B}, R^{C}, R^{D}, R^{E}, and R^{F} is a connection point shown in B(i) or B(ii); and
wherein the remaining R^{A}, R^{B}, R^{C}, R^{D}, R^{E}, and R^{F} are each independently H, a halogen, an amine, a thiol, an aldehyde, a vinyl group, an ester, an ether, an alcohol, a urea, a guanidine, a carbonate, a carbamate, or a sulfone.

14. The separation media of claim 10, wherein J is J(iv), J(v), or J(vi): 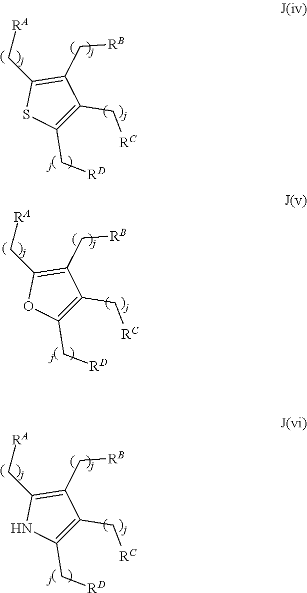
wherein j is independently 0, 1, 2, 3, 4, or 5;
wherein at least one of R^{A}, R^{B}, R^{C}, and R^{D} is the boronic acid;
wherein at least one R^{A}, R^{B}, R^{C}, and R^{D} is the connection point shown in B(i) or B(ii); and
all remaining R^{A}, R^{B}, R^{C}, and R^{D} are each independently H, a halogen, an amine, an aldehyde, a vinyl group, an ester, an ether, an alcohol, a urea, a guanidine, a carbonate, a carbamate, or a sulfone.

15. The separation media of claim 1, wherein the support membrane comprises a polyolefin membrane, a polyethersulfone membrane, a poly(tetrafluoroethylene) membrane, a nylon membrane, a fiberglass membrane, a hydrogel membrane, a hydrogel monolith, a polyvinyl alcohol membrane, a cellulose membrane, a cellulose ester membrane, a cellulose acetate membrane, a regenerated cellulose membrane, a cellulosic nanofiber membrane, a cellulosic monolith, a filter paper, or combinations thereof.

16. A separation device comprising a housing and the separation media of claim 1 disposed within the housing.

17. A separation media comprising:
two or more separation medias arranged in a stacked configuration, each separation media comprising:
a support substrate; and
a plurality of separation ligands for formula SL1 or SL2 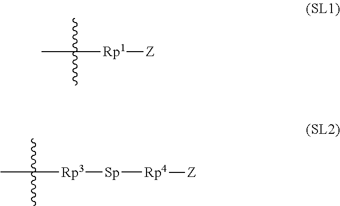
wherein:
Z is a separation group comprising an affinity group, the affinity group capable of binding a diol group; and
Rp¹, Rp³, and Rp⁴ each independently comprise the reaction product of any one of Rp^{A}, Rp^{B}, Rp^{C}, Rp^{D}, Rp^{E}, Rp^{F}, Rp^{G}, Rp^{H}, Rp^{I}, Rp^{J}, Rp^{K}, Rp^{L}, Rp^{M}, or an isomer thereof,
wherein Rp^{A}, Rp^{B}, Rp^{C}, Rp^{D}, Rp^{E}, Rp^{F}, Rp^{G}, Rp^{H}, Rp^{I}, Rp^{J}, Rp^{K}, Rp^{L}, and Rp^{M}, are represented by: 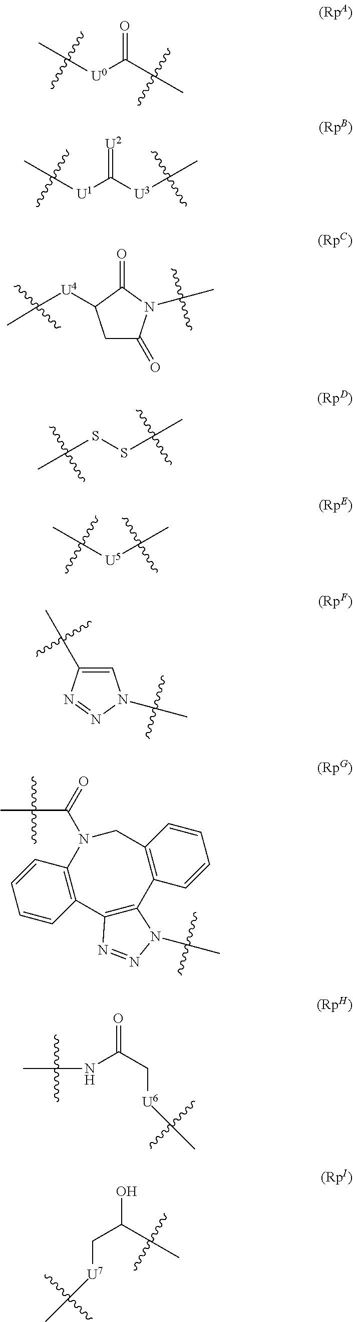 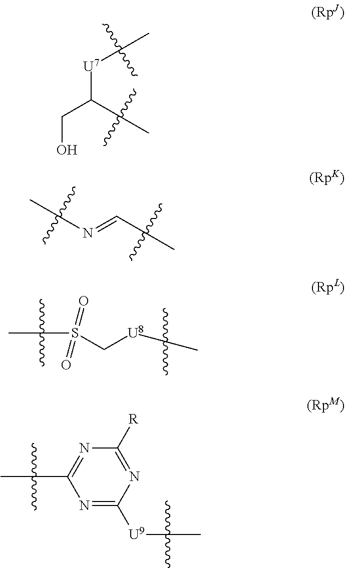
wherein:
U⁰, U¹, U², U³, U⁴, U⁵, U⁶, U⁷, U⁸ and U⁹ are each independently NH, O, or S;
R is an organic group, H, or halogen; and
Sp is a spacer comprising a divalent organic group.

18. A method of isolating a target molecule from an isolation solution:
the isolation solution comprising:
a carrier; and
the target molecule comprising a cis diol;
the isolation solution,
the method comprising:
contacting the isolation solution with a separation media, the separation media comprising:
a support substrate; and
a plurality of separation ligands for formula SL1 or SL2 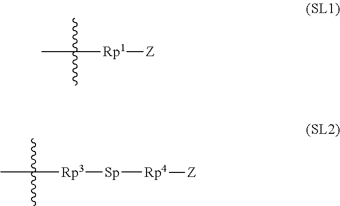
wherein:
Z is a separation group comprising an affinity group, the affinity group capable of binding a diol group; and
Rp¹, Rp³, and Rp⁴ each independently comprise the reaction product of any one of Rp^{A}, Rp^{B}, Rp^{C}, Rp^{D}, Rp^{E}, Rp^{F}, Rp^{G}, Rp^{H}, Rp^{I}, Rp^{J}, Rp^{K}, Rp^{L}, Rp^{M}, or an isomer thereof,
wherein Rp^{A}, Rp^{B}, Rp^{C}, Rp^{D}, Rp^{E}, Rp^{F}, Rp^{G}, Rp^{H}, Rp^{I}, Rp^{J}, Rp^{K}, Rp^{L}, and Rp^{M}, are represented by: 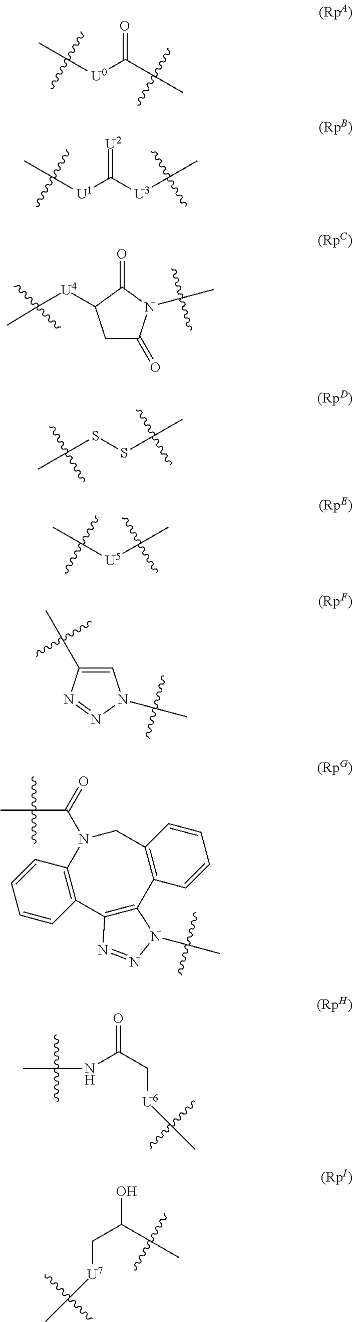 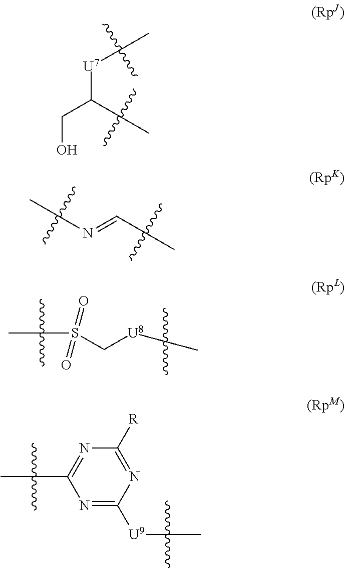
wherein:
U⁰, U¹, U², U³, U⁴, U⁵, U⁶, U⁷, U⁸ and U⁹ are each independently NH, O, or S;
R is an organic group, H, or halogen; and
Sp is a spacer comprising a divalent organic group.

19. The method of claim 18, wherein the method further comprises washing the separation media with a washing solution.

20. The method of claim 18, wherein the method further comprises contacting the separation media with an elution solution, the elution solution having a pH that is less than the pH of the isolation solution.
